(19) United States
(12) Patent Application Publication
(10) Pub. No.: US 2024/0266594 A1
(43) Pub. Date: Aug. 8, 2024

(54) SECONDARY BATTERY, ELECTRONIC DEVICE, AND FLYING OBJECT

(71) Applicant: SEMICONDUCTOR ENERGY LABORATORY CO., LTD., Atsugi-shi, Kanagawa-ken (JP)

(72) Inventors: Shuhei YOSHITOMI, Ayase, Kanagawa (JP); Kaori OGITA, Isehara, Kanagawa (JP); Shotaro MURATSUBAKI, Hachioji, Tokyo (JP); Atsushi KAWATSUKI, Yokohama, Kanagawa (JP); Mayumi MIKAMI, Atsugi, Kanagawa (JP); Yohei MOMMA, Isehara, Kanagawa (JP); Tetsuya KAKEHATA, Isehara, Kanagawa (JP); Shunpei YAMAZAKI, Setagaya, Tokyo (JP)

(21) Appl. No.: 18/562,562

(22) PCT Filed: May 24, 2022
(86) PCT No.: PCT/IB2022/054820

§ 371 Date: Nov. 20, 2023

(30) Foreign Application Priority Data
Jun. 2, 2021 (JP) 2021-093253

(51) Int. Cl. H01M 10/0562; H01M 4/02; H01M 4/505; H01M 4/525; H01M 4/583; H01M 10/0525

(52) U.S. Cl. CPC H01M 10/0562; H01M 4/505; H01M 4/525; H01M 4/583; H01M 10/0525; H01M 2004/027; H01M 2004/028; H01M 2220/30

(57) ABSTRACT

Provided is a secondary battery having a favorable interface contact between an active material and an electrolyte. The secondary battery includes a positive electrode layer, a negative electrode layer, and an electrolyte layer positioned between the positive electrode layer and the negative electrode layer. The positive electrode layer contains a positive electrode active material and a first solid electrolyte, the negative electrode layer contains a negative electrode active material and a second solid electrolyte, the electrolyte layer contains a third solid electrolyte and an ionic liquid, and a space in the third solid electrolyte is impregnated with the ionic liquid. The secondary battery is bendable.

### TECHNICAL FIELD

One embodiment of the present invention relates to a secondary battery, an electronic device, and a flying object.

One embodiment of the present invention relates to an object, a method, or a manufacturing method. The present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that electronic devices in this specification mean all devices including secondary batteries, and electro-optical devices including secondary batteries, information terminal devices including secondary batteries, and the like are electronic devices.

### BACKGROUND ART

In recent years, a variety of power storage devices such as lithium-ion secondary batteries, lithium-ion capacitors, and air batteries have been actively developed. In particular, demand for lithium-ion secondary batteries with high output and high capacity has rapidly grown with the development of the semiconductor industry, and lithium-ion secondary batteries are essential as rechargeable energy supply sources for today's information society.

In most of the lithium-ion batteries that are used at present, an electrolyte solution in which a lithium salt is dissolved in an organic solvent with polarity (also referred to as an organic electrolyte solution) is used. However, the organic solvent is flammable, so a secondary battery with this involves risks of firing or ignition.

Large secondary batteries used in automobiles and the like have a great demand for reliability, and in particular, for safety. Thus, solid-state batteries having a solid electrolyte instead of an electrolyte solution between a positive electrode and a negative electrode have been explored. Solid electrolytes are roughly classified into organic solid electrolytes and inorganic solid electrolytes.

Patent Document 1 discloses a secondary battery including a sulfide-based solid electrolyte or an oxide-based solid electrolyte as an inorganic solid electrolyte, for example. Non-Patent Document 1 to Non-Patent Document 3 disclose a change in the crystal structure of lithium cobalt oxide.

### REFERENCES

### Patent Document

[Patent Document 1] Japanese Published Patent Application No. 2012-14892

### Non-Patent Documents

[Non-Patent Document 1] Motohashi, T. et al., “Electronic phase diagram of the layered cobalt oxide system LiₓCoO₂ (0.0≤x≤1.0)”, Physical Review B, 80 (16); 165114.
[Non-Patent Document 2] Zhaohui Chen et al., “Staging Phase Transitions in LiₓCoO₂”, Journal of The Electrochemical Society, 2002, 149 (12), A1604-A1609.
[Non-Patent Document 3] Belsky, A. et al., “New developments in the Inorganic Crystal Structure Database (ICSD): accessibility in support of materials research and design”, Acta Cryst., (2002) B58, 364-369.

### SUMMARY OF THE INVENTION

### Problems to be Solved by the Invention

Patent Document 1 proposes a nonaqueous electrolyte battery in which an intervening layer is provided between a negative electrode active material layer and a solid electrolyte layer considering that lithium ion transfer resistance at the interface between the negative electrode active material layer and the solid electrolyte layer is increased because of weakened bonding between the layers due to a large volume change (expansion and contraction) of the negative electrode active material layer. Patent Document 1 states that the intervening layer is formed of a polymer containing a lithium salt or an ionic liquid.

However, the provision of the intervening layer brings a problem of an interface contact between the negative electrode active material layer and the intervening layer or between the solid electrolyte layer and the intervening layer. An interface contact is sometimes referred to as interface resistance.

In view of the above, an object of one embodiment of the present invention is to improve a contact at an interface in a secondary battery, for example, an interface between an active material and an electrolyte. Alternatively, an object of one embodiment of the present invention is to provide a secondary battery with improved safety. Alternatively, an object of one embodiment of the present invention is to provide a bendable secondary battery.

Note that the description of these objects does not preclude the existence of other objects. These objects should be construed as being independent of one another and one embodiment of the present invention does not need to achieve all the objects. Moreover, other objects can be derived from the description of the specification, the drawings, and the claims, which are the present specification and the like.

### Means for Solving the Problems

In order to achieve the above objects, one embodiment of the present invention is a secondary battery including a positive electrode layer, a negative electrode layer, and an electrolyte layer positioned between the positive electrode layer and the negative electrode layer. The positive electrode layer contains a positive electrode active material and a first solid electrolyte, the negative electrode layer contains a negative electrode active material and a second solid electrolyte, the electrolyte layer contains a third solid electrolyte and an ionic liquid, and a space in the electrolyte layer, specifically, a space in the third solid electrolyte is impregnated with the ionic liquid.

Another embodiment of the present invention is a secondary battery including a positive electrode layer, a negative electrode layer, and an electrolyte layer positioned between the positive electrode layer and the negative electrode layer. The positive electrode layer contains a positive electrode active material and a first solid electrolyte; the negative electrode layer contains a negative electrode active material and a second solid electrolyte; the electrolyte layer contains a third solid electrolyte; the positive electrode layer, the negative electrode layer, and the electrolyte layer contain an ionic liquid; and a space in the electrolyte layer, specifically, a space in the third solid electrolyte is impregnated with the ionic liquid.

Another embodiment of the present invention is a secondary battery including a positive electrode layer, a negative electrode layer, and an electrolyte layer positioned between the positive electrode layer and the negative electrode layer. The positive electrode layer contains a positive electrode active material and a first solid electrolyte, the negative electrode layer contains a negative electrode active material and a second solid electrolyte, the electrolyte layer includes a first electrolyte layer to a third electrolyte layer, the first electrolyte layer to the third electrolyte layer contain an ionic liquid, and a space in the second electrolyte layer, specifically, a space in a third solid electrolyte contained in the second electrolyte layer is impregnated with the ionic liquid.

Another embodiment of the present invention is a secondary battery including a positive electrode layer, a negative electrode layer, and an electrolyte layer positioned between the positive electrode layer and the negative electrode layer. The positive electrode layer contains a positive electrode active material and a first solid electrolyte, the negative electrode layer contains a negative electrode active material and a second solid electrolyte, the electrolyte layer includes a first electrolyte layer and a second electrolyte layer, the first electrolyte layer and the second electrolyte layer contain an ionic liquid, and a space in the second electrolyte layer, specifically, a space in a third solid electrolyte contained in the second electrolyte layer is impregnated with the ionic liquid.

In any one of the embodiments of the present invention, the positive electrode active material preferably contains a composite oxide having a layered rock-salt crystal structure, a spinel crystal structure, or an olivine crystal structure.

In any one of the embodiments of the present invention, the positive electrode active material having a layered rock-salt crystal structure preferably contains lithium cobalt oxide or lithium nickel-manganese-cobalt oxide.

In any one of the embodiments of the present invention, the negative electrode active material preferably contains silicon, tin, gallium, aluminum, germanium, lead, antimony, bismuth, silver, zinc, cadmium, or indium.

In any one of the embodiments of the present invention, the negative electrode active material preferably contains a carbon material.

Another embodiment of the present invention is an electronic device, a watch-type electronic device, or a flying object including the secondary battery of one embodiment of the present invention.

### Effect of the Invention

According to one embodiment of the present invention, a secondary battery with favorable interface resistance can be provided. Alternatively, according to one embodiment of the present invention, a secondary battery with improved safety can be provided. Alternatively, according to one embodiment of the present invention, a bendable secondary battery can be provided.

Note that the description of these effects does not preclude the existence of other effects. These effects should be construed as being independent of one another and one embodiment of the present invention does not need to have all the effects. Moreover, other effects can be derived from the description of this specification and the like.

### BRIEF DESCRIPTION OF THE DRAWINGS

FIG. TA and FIG. 1B are diagrams illustrating secondary batteries of one embodiment of the present invention.

FIG. 2A and FIG. 2B are diagrams illustrating a secondary battery of one embodiment of the present invention.

FIG. 3 is a diagram illustrating a secondary battery of one embodiment of the present invention.

FIG. 4A and FIG. 4B are diagrams illustrating secondary batteries of one embodiment of the present invention.

FIG. 5A to FIG. 5C are diagrams illustrating a fabrication method of a secondary battery of one embodiment of the present invention.

FIG. 6A to FIG. 6D are diagrams illustrating a fabrication method of a secondary battery of one embodiment of the present invention.

FIG. 7A to FIG. 7D are diagrams illustrating a fabrication method of a secondary battery of one embodiment of the present invention.

FIG. 8A and FIG. 8B are diagrams illustrating a fabrication method of a secondary battery of one embodiment of the present invention.

FIG. 9A and FIG. 9B are diagrams illustrating a fabrication method of a secondary battery of one embodiment of the present invention.

FIG. 10 is a diagram illustrating a fabrication apparatus for a secondary battery of one embodiment of the present invention.

FIG. 11 is a flow chart showing a formation method of an electrolyte layer in a secondary battery of one embodiment of the present invention.

FIG. 12A and FIG. 12B are diagrams illustrating a heating step for an electrolyte layer in a secondary battery of one embodiment of the present invention.

FIG. 13A and FIG. 13B are cross-sectional views of a positive electrode active material, and FIG. 13C to FIG. 13F illustrate parts of the cross-sectional view of the positive electrode active material.

FIG. 14 is an example of a TEM image showing crystal orientations substantially aligned with each other.

FIG. 15A is an example of a STEM image showing crystal orientations substantially aligned with each other. FIG. 15B is an FFT pattern of a region of a rock-salt crystal structure RS. FIG. 15C is an FFT pattern of a region of a layered rock-salt crystal structure LRS.

FIG. 16 is a diagram illustrating crystal structures of a positive electrode active material.

FIG. 17 is a diagram illustrating crystal structures of a conventional positive electrode active material.

FIG. 18A and FIG. 18B are cross-sectional views of a positive electrode active material, and FIG. 18C1 and FIG. 18C2 are parts of the cross-sectional view of the positive electrode active material.

FIG. 19 is a diagram showing XRD patterns calculated from crystal structures.

FIG. 20 is a diagram showing XRD patterns calculated from crystal structures.

FIG. 21 is a cross-sectional view of a positive electrode active material.

FIG. 22A to FIG. 22C are diagrams showing formation methods of a positive electrode active material.

FIG. 23A and FIG. 23B are diagrams illustrating laminated secondary batteries of one embodiment of the present invention.

FIG. 24A to FIG. 24C are diagrams illustrating a fabrication method of a laminated secondary battery of one embodiment of the present invention.

FIG. 25A and FIG. 25B are diagrams illustrating a bent secondary battery of one embodiment of the present invention.

FIG. 26A and FIG. 26B are diagrams illustrating secondary batteries of one embodiment of the present invention.

FIG. 27A and FIG. 27B are diagrams illustrating a bent secondary battery of one embodiment of the present invention.

FIG. 28A to FIG. 28C are diagrams illustrating a watch-type electronic device of one embodiment of the present invention.

FIG. 29A to FIG. 29G are diagrams illustrating a watch-type electronic device of one embodiment of the present invention.

FIG. 30A to FIG. 30C are diagrams illustrating a watch-type electronic device of one embodiment of the present invention.

FIG. 31 is a diagram illustrating a watch-type electronic device of one embodiment of the present invention.

FIG. 32A and FIG. 32B are perspective views illustrating an example of a flying object of one embodiment of the present invention. FIG. 32C is across-sectional view illustrating the example of the flying object of one embodiment of the present invention.

FIG. 33A and FIG. 33B are perspective views illustrating an example of a flying object of one embodiment of the present invention.

FIG. 34A to FIG. 34C are diagrams illustrating a coin-type secondary battery of one embodiment of the present invention.

FIG. 35A to FIG. 35D are diagrams illustrating cylindrical secondary batteries of one embodiment of the present invention.

FIG. 36A to FIG. 36C are external views of secondary battery packs of one embodiment of the present invention.

FIG. 37A to FIG. 37C are external views of a secondary battery pack of one embodiment of the present invention.

FIG. 38A to FIG. 38C are diagrams illustrating an example of application to an electric vehicle (EV).

FIG. 39A to FIG. 39D are diagrams illustrating examples of vehicles.

FIG. 40A to FIG. 40C are diagrams illustrating examples of vehicles.

FIG. 41A to FIG. 41E are diagrams illustrating examples of electronic devices.

FIG. 42 is a diagram illustrating an example of an electronic device.

FIG. 43A and FIG. 43B are plane SEM images of a first sheet-like electrolyte layer.

FIG. 44A and FIG. 44B are plane SEM images of a second sheet-like electrolyte layer.

FIG. 45A and FIG. 45B are plane SEM images of a second sheet-like electrolyte layer in a state where a space is impregnated with an ionic liquid.

### MODE FOR CARRYING OUT THE INVENTION

Embodiments will be described in detail with reference to the drawings. However, the present invention is not limited to the following description, and it is readily appreciated by those skilled in the art that modes and details can be modified in various ways without departing from the spirit and the scope of the present invention. Thus, the present invention should not be construed as being limited to the description in the following embodiments. Note that in the structures of the invention described below, the same portions or portions having similar functions are denoted by the same reference numerals in different drawings, and description thereof is not repeated in some cases.

The position, size, range, and the like of each component illustrated in the drawings and the like do not represent the actual position, size, range, and the like in some cases for easy understanding of the invention. Therefore, the invention disclosed in this specification and the like is not necessarily limited to the position, size, range, and the like disclosed in the drawings and the like.

The term “over” or “under” in this specification and the like does not necessarily mean that a component is placed directly over or directly under another component. Furthermore, the term “over” or “under” does not necessarily mean that a component is in contact with another component. For example, the expression “active material layer B over current collector A” does not necessarily mean that the active material layer B is formed on and in contact with the current collector A, and another component may be provided between the current collector A and the active material B.

Ordinal numbers such as “first” and “second” in this specification and the like are used in order to avoid confusion among components and do not denote the priority or the sequence such as the sequence of steps or the stacking sequence. A term without an ordinal number in this specification and the like might be provided with an ordinal number in the scope of claims in order to avoid confusion among components. Furthermore, a term with an ordinal number in this specification and the like might be provided with a different ordinal number in the scope of claims. Furthermore, even when a term is provided with an ordinal number in this specification and the like, the ordinal number might be omitted in the scope of claims and the like.

In this specification and the like, an example in which a lithium metal is used for a negative electrode in a secondary battery including a positive electrode and a positive electrode active material is described in some cases; however, the secondary battery of one embodiment of the present invention is not limited to this example. A different material such as graphite or lithium titanate may be used for a negative electrode, for example. The material of a negative electrode is not limited when one embodiment of the present invention is a positive electrode, a positive electrode active material, and the like.

In this specification and the like, an electrolyte layer refers to a region that electrically insulate a positive electrode from a negative electrode and that has lithium ion conductivity. An electrolyte layer interposed between a positive electrode and a negative electrode is observed as a layer in some cases.

In this specification and the like, a semi-solid battery refers to a battery in which at least one of an electrolyte layer, a positive electrode, and a negative electrode contains a semi-solid material, and it is particularly preferable that an electrolyte layer using a semi-solid material be included. The semi-solid means having properties of a solid, such as a small volume change, and also having some of properties and the like close to those of a liquid having flexibility, and does not mean that the proportion of the contained solid material is 50%. A material is referred to as a semi-solid material either in the case where the above properties are exhibited by using a single material or in the case where the above properties are exhibited by a plurality of materials. For example, since a gel-like material can exhibit the above properties by itself, the material is a semi-solid material. When a plurality of materials, e.g., a porous solid material impregnated (or infiltrated) with a liquid material, exhibit the above properties, the materials can be referred to as semi-solid materials.

In this specification and the like, a positive electrode and a negative electrode are collectively referred to as electrodes in some cases.

In this specification and the like, a space group is represented using the short symbol of the international notation (or the Hermann-Mauguin notation). In addition, the Miller index is used for the expression of crystal planes and crystal orientations. An individual plane that shows a crystal plane is denoted by “( )”. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with { }. A trigonal system represented by the space group R-3m is generally represented by a composite hexagonal lattice for easy understanding of the structure and, in some cases, not only (hkl) but also (hkil) is used as the Miller index. Here, i is −(h+k).

In this specification and the like, particles are not necessarily spherical with a circular cross section and include particles with cross-sectional shapes such as an ellipse, a rectangle, a trapezoid, a triangle, a quadrilateral with rounded corners, and an asymmetrical shape. The shapes of a plurality of particles do not necessarily the same and the particles may have indefinite shapes.

In this specification and the like, the theoretical capacity of a positive electrode active material refers to the amount of electricity for the case where all the lithium that can be inserted and extracted is extracted from the positive electrode active material. For example, the theoretical capacity of LiCoO₂ is 274 mAh/g, the theoretical capacity of LiNiO₂ is 275 mAh/g, and the theoretical capacity of LiMn₂O₄ is 148 mAh/g.

In this specification and the like, the remaining amount of lithium that can be inserted into and extracted in a positive electrode active material is represented by x in a compositional formula of the positive electrode active material, e.g., x in LiₓCoO₂ or x in LiₓMO₂. The value of x represents the lithium occupancy in LiₓCoO₂ or LiₓMO₂. Note that in this specification and the like, Co in LiₓCoO₂ is an example of a transition metal and can be replaced with LiₓMO₂ (M represents a transition metal) as appropriate. In the case of a positive electrode active material in a secondary battery, x=(theoretical capacity−charge capacity)/theoretical capacity can be satisfied. For example, when a secondary battery using LiCoO₂ as a positive electrode active material is charged to 219.2 mAh/g, the positive electrode active material can be represented by Li_{0.2}CoO₂ or x=0.2. Small x in LiₓCoO₂ means, for example, 0.1<x 0.24.

In the case where synthesized lithium cobalt oxide almost satisfies the stoichiometric proportion, the lithium cobalt oxide is LiCoO₂, which means that x=1. In the case where discharging of a secondary battery using LiCoO₂ for a positive electrode ends, it can be said that lithium cobalt oxide is LiCoO₂ or x=1. Here, “discharging ends” means that a voltage becomes lower than or equal to 3.0 V or lower than or equal to 2.5 V at a current of 100 mA/g or lower, for example.

Charge capacity and/or discharge capacity used for calculation of x in LiₓCoO₂ is preferably measured under the condition where there is no influence or small influence of a short circuit and/or decomposition of an electrolyte. For example, charge capacity and/or discharge capacity at the time when a sudden capacity change that seems to result from a short circuit occurs should not be used for calculation of x.

In this specification and the like, the space group of a crystal structure is identified by X-ray diffraction (XRD), electron diffraction, neutron diffraction, or the like. Thus, in this specification and the like, being derived from a space group, belonging to a space group, or being a space group can be rephrased as being identified as a space group.

In this specification and the like, a structure where three layers of anions are shifted and stacked like “ABCABC” is referred to as a cubic close-packed structure. Accordingly, anions do not necessarily form an exact cubic lattice. At the same time, actual crystals always have a defect; thus, analysis results are not necessarily consistent with the theory. For example, in an electron diffraction pattern or fast Fourier transform (FFT) of a transmission electron microscope (TEM) image or the like, a spot may appear in a position slightly different from a theoretical position.

In this specification and the like, uniformity refers to a phenomenon in which, in a solid made of a plurality of elements (e.g., A, B, and C), a certain element (e.g., A) is distributed with similar features in specific regions. Note that “uniformity” can be used when specific regions have substantially the same concentration of an element (e.g., A). For example, “uniformity” can be used when a difference in the concentration of an element (e.g., A) between specific regions is 10% or less. Examples of the specific regions in an active material include a surface portion, a surface, a projection, a depression, and an inner portion.

In this specification and the like, a positive electrode active material is sometimes referred to as a composite oxide, a positive electrode member, a positive electrode material, a secondary battery positive electrode member, or the like. In this specification and the like, the positive electrode active material of one embodiment of the present invention preferably contains an additive element; a positive electrode active material containing an additive element can be referred to as a compound, a composition, or a composite.

The voltage of a positive electrode generally increases with increasing charge voltage of a secondary battery. The positive electrode active material of one embodiment of the present invention has a stable crystal structure even at a high voltage. The stable crystal structure of the positive electrode active material in a charged state can suppress a decrease in discharge capacity due to repeated charging and discharging.

A short circuit of a secondary battery might cause not only malfunction in charge operation and/or discharge operation of the secondary battery but also heat generation and firing. In order to obtain a safe secondary battery, a short circuit is preferably inhibited even at a high charge voltage. In the positive electrode active material of one embodiment of the present invention, a short-circuit current is inhibited even at a high charge voltage. Thus, a secondary battery having a high discharge capacity and a high level of safety can be obtained.

### Embodiment 1

In one embodiment of the present invention, an electrolyte layer contains a solid material and a liquid material. In this embodiment, examples of an electrolyte layer of one embodiment of the present invention and a secondary battery and the like including the electrolyte layer will be described.

FIG. 1A is a schematic cross-sectional view of a secondary battery 100 of one embodiment of the present invention. The secondary battery 100 includes a positive electrode layer 106, an electrolyte layer 103, and a negative electrode layer 107. The positive electrode layer 106 includes a positive electrode current collector 101 and a positive electrode active material layer 102. The negative electrode layer 107 includes a negative electrode current collector 105 and a negative electrode active material layer 104.

FIG. 1B is a schematic cross-sectional view of the secondary battery 100 of one embodiment of the present invention, which is different from FIG. 1A, illustrating a structure in which the negative electrode active material layer 104 is unnecessary. The negative electrode active material layer 104 can be unnecessary in the case where metal foil containing lithium is used for the negative electrode current collector 105, for example. The electrolyte layer 103 may be placed a certain distance away from the negative electrode current collector 105. This is to ensure a region where lithium is deposited in the negative electrode current collector 105.

In FIG. 1A and FIG. 1B, the electrolyte layer 103 contains a solid material and a liquid material.

The electrolyte layer 103 has a function of transferring carrier ions. As the carrier ions, lithium ions, sodium ions, or the like can be used. The electrolyte layer 103 has carrier ion conductivity and thus has a function of transferring carrier ions. Specifically, the electrolyte layer 103 preferably contains a solid material having high carrier ion conductivity. For example, the lithium ion conductivity of the solid material used for the electrolyte layer 103 is preferably higher than or equal to 0.1 mS/cm and lower than or equal to 20 mS/cm at room temperature. The electrolyte layer 103 preferably contains a liquid material having high carrier ion conductivity as well as the solid material. For example, the lithium ion conductivity of the liquid material used for the electrolyte layer 103 is preferably higher than or equal to 0.1 mS/cm and lower than or equal to 20 mS/cm at room temperature. Note that in the case where the lithium ion conductivity of the solid material is higher than the lithium ion conductivity of the liquid material, the electrolyte layer 103 preferably contains a larger amount of the solid material than the liquid material.

A solid electrolyte is preferably used as the solid material so as to have the above lithium ion conductivity. Specific examples of the solid electrolyte will be described later.

An ionic liquid is preferably used as the liquid material so as to have the above lithium ion conductivity. Specific examples of the ionic liquid will be described later.

Furthermore, the electrolyte layer 103 preferably contains a lithium salt. In the case where the electrolyte layer 103 contains an ionic liquid as a solvent, for example, the lithium salt is preferably contained as a solute.

In the electrolyte layer 103 containing the solid material and the liquid material, the solid material can hold the liquid material, which is preferable. Although a space is sometimes generated in the solid material after baking, for example, the space is easily impregnated with the liquid material, and it can be said that the liquid material is easily held in the space.

Moreover, adjusting viscosity of the liquid material facilitates impregnation of and liquid-material-holding in the solid material. For example, the liquid material preferably has low viscosity at the time of impregnation into the solid material. The liquid material preferably has high viscosity after being held in the solid material. A state with high viscosity is referred to as a gel state in some cases. A gel state can also be referred to as an intermediate state of matter between a solid and a liquid.

The above structure in which the solid material holds the liquid material, that is, the structure in which the solid material is impregnated with the liquid material can inhibit leakage of the liquid material from the electrolyte layer 103 more than a structure in which the solid material and the liquid material are simply mixed.

Owing to such a structure, a secondary battery in which a liquid material in an electrolyte layer or the like is less likely to leak can be provided and the safety is improved.

The proportions of the solid material and the liquid material in the electrolyte layer 103 are not particularly limited as long as the above liquid-material-holding structure is maintained; however, the proportion of the solid material is preferably higher than the proportion of the liquid material, in which case the liquid material is easily held. The proportions of the solid material and the liquid material can be determined by volume %. For example, the solid material preferably occupies 70 volume % or more and 95 volume % or less, further preferably 80 volume % or more and 93 volume % or less, of the electrolyte layer 103. Since the liquid material occupies the rest in the electrolyte layer 103, the liquid material preferably occupies 5 volume % or more and 30 volume % or less, further preferably 7 volume % or more and 20 volume % or less. In the case where a lithium salt is dissolved in the liquid material, the above proportions are satisfied in a state where the lithium salt is dissolved in the liquid material.

The electrolyte layer 103 having the above proportions can be regarded to contain a semi-solid material. The electrolyte layer 103 containing a semi-solid material is referred to as a semi-solid electrolyte layer in some cases. A secondary battery including such a semi-solid electrolyte layer is preferable because it can be bent easily.

In the case where a solid electrolyte is used as the solid material and an ionic liquid is used as the liquid material, the solid electrolyte has higher lithium ion transference number than the ionic liquid in many cases. Thus, the proportion of the solid electrolyte is preferably higher than that of the ionic liquid, in which case stagnation of lithium ion transfer in the electrolyte layer 103 is inhibited. The lithium ion transference number is an indicator of the ease of lithium ion transfer, like lithium ion conductivity.

In the structure in which the solid material is impregnated with the liquid material, carrier ions such as lithium ions can transfer in the solid material and the liquid material. In the structure in which the solid material is impregnated with the liquid material, lithium ions can transfer only in the solid material. In the structure in which the solid material is impregnated with the liquid material, lithium ions can transfer only in the liquid material.

Although the case where the solid material and the liquid material exist in the electrolyte layer is described here, one or both of the solid material and the liquid material may exist also in the positive electrode layer. When one or both of the solid material and the liquid material exist in the electrolyte layer and the positive electrode layer, the interface resistance between the electrolyte layer and the positive electrode layer can be low as compared with the case of including an intervening layer. One or both of the solid material and the liquid material may also exist in the negative electrode layer. When one or both of the solid material and the liquid material exist in the electrolyte layer and the negative electrode layer, the interface resistance between the electrolyte layer and the negative electrode layer can be low as compared with the case of including an intervening layer. In the case where one or both of the solid material and the liquid material exist in the positive electrode layer or the negative electrode layer, one or both of the solid material and the liquid material may be mixed into a positive electrode slurry or a negative electrode slurry. When one or both of the solid material and the liquid material can hold an active material, a binder in the positive electrode layer or the negative electrode layer can be omitted or reduced. Moreover, when the solid material can ensure the conductivity, a conductive additive in the positive electrode layer or the negative electrode layer can be omitted or reduced.

The solid material contained in the positive electrode layer or the negative electrode layer may be in a form different from that of the solid material in the electrolyte layer. The electrolyte layer preferably contains a solid material having a space, whereas the positive electrode layer or the negative electrode layer may contain a particulate solid material. A particulate solid material is particularly preferable when the positive electrode layer or the negative electrode layer does not contain a liquid material. The solid material contained in the positive electrode layer or the negative electrode layer can be a material different from the solid material in the electrolyte layer but is preferably the same material in consideration of inhibiting interface resistance.

The liquid material contained in the positive electrode layer or the negative electrode layer may in a state different from that of the liquid material in the electrolyte layer. The electrolyte layer is preferably in a gel state, whereas the positive electrode layer or the negative electrode layer may contain a liquid material. The liquid material contained in the positive electrode layer or the negative electrode layer can be a material different from the liquid material in the electrolyte layer but is preferably the same material in a different state in consideration of inhibiting interface resistance.

In the case where the liquid material contained in the positive electrode layer or the negative electrode layer is the same material as the liquid material in the electrolyte layer and in a liquid state, a secondary battery can be completed by using a method in which a liquid material is injected after the assembly of the secondary battery.

The solid material and the liquid material in the electrolyte layer might transfer to the positive electrode layer or the negative electrode layer because of a press step or the like in the assembly of the secondary battery. Such a case leads to a structure in which the solid material and the liquid material leak from the electrolyte layer, and the solid material and the liquid material in the positive electrode layer or the negative electrode layer are the same as the solid material and the liquid material in the electrolyte layer. The solid material and the liquid material used for the electrolyte layer of one embodiment of the present invention can be prevented from leaking from a secondary battery because the solid material holds the liquid material.

The condition where the proportion of the solid electrolyte is higher than that of the ionic liquid is met only in the case of the electrolyte layer and is not necessarily met in the case where one or both of the solid electrolyte and the ionic liquid exist in the positive electrode layer or the negative electrode layer. For example, the proportion of the ionic liquid may be higher than that of the solid electrolyte in the positive electrode layer or the negative electrode layer while the proportion of the solid electrolyte is higher than that of the ionic liquid in the electrolyte layer. The positive electrode layer or the negative electrode layer may contain the ionic liquid and contain no solid electrolyte. The positive electrode layer or the negative electrode layer may contain the solid electrolyte and contain no ionic liquid.

In the case where the positive electrode layer or the negative electrode layer contains the solid material and the liquid material, the solid material may hold the liquid material, and such a state is referred to as a semi-solid state in some cases.

In any of the electrolyte layer, the positive electrode layer, and the negative electrode layer, the solid material is preferably an inorganic material so as to hold the liquid material; however, an organic material may be used as the solid material. The use of a gel-like material having no fluidity as an organic material enables the liquid material to be held, leading to a semi-solid state.

The liquid material preferably has viscosity with which the liquid material is held by the solid material, and a gel-like liquid material having high viscosity can be used, for example. In the case of using an ionic liquid as the liquid material, a gel-like ionic liquid can be used.

The liquid material preferably has the required viscosity when at least the electrolyte layer 103 is completed because the liquid material is less likely to leak from the electrolyte layer 103 or the like, and a starting material does not need to have the required viscosity. In other words, the viscosity of the liquid material may be changed. For example, a liquid material whose starting material has low viscosity is used, in which case a space is easily impregnated with the liquid material. After that, the viscosity of the liquid material is preferably increased when at least the electrolyte layer 103 is formed or when a secondary battery is completed to keep a state in which the liquid material is held by the solid material. Specifically, the liquid material is subjected to gelation treatment by utilizing a heating step in a fabrication process of the electrolyte layer or the like to increase the viscosity of the liquid material after the heating step. The viscosity of the liquid material may be decreased by utilizing a heating step at the time of mixing the solid material and the liquid material.

Another material may be added to a starting material to adjust the viscosity of the liquid material. For example, an organic solvent can be mixed into anionic liquid to adjust the viscosity of the liquid material. As the organic solvent, one or more selected from ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used.

The viscosity of the liquid material can be adjusted by adjusting the amount of a lithium salt added to an ionic liquid. As the lithium salt, one or more selected from LiPF₆, LiClO₄, LiBF₄, Li(C₂F₅SO₂)₂N, Li(CF₃SO₂)₂N, Li(SO₂F)₂N, lithium bis(oxalate)borate (Li(C₂O₄)₂ or LiBOB), and the like can be used.

In the case of using a solid electrolyte as the solid material, the starting material of the solid electrolyte is in a particle shape in many cases. A particle shape includes a shape whose one cross section is a circle or a perfect circle. However, the shape of the solid electrolyte is changed because of a baking step, i.e., a heating step, for the starting material or a mixing step. This means that the solid electrolyte may have a shape different from a particle shape. The different shape includes a shape whose one cross section has unevenness or is an ellipse. That is, the solid material in the electrolyte layer 103 of the secondary battery 100 is not limited to have a particle shape and can exert an effect of the present application even with a variety of shapes.

The above change in shape might occur in an active material. For example, the starting material of the active material is in a particle shape in many cases. However, the shape is changed because of a baking step, i.e., a heating step, for the starting material or a mixing step. This means that the active material may have a shape different from a particle shape. In other words, an active material in the positive electrode active material layer 102 is not limited to have a particle shape. Furthermore, an active material in the negative electrode active material layer 104 is not limited to have a particle shape. The active material can exert an effect of the present application even with a variety of shapes.

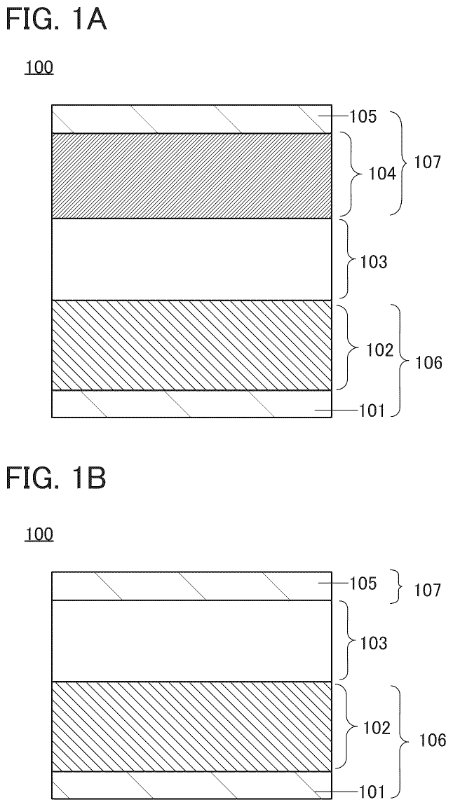

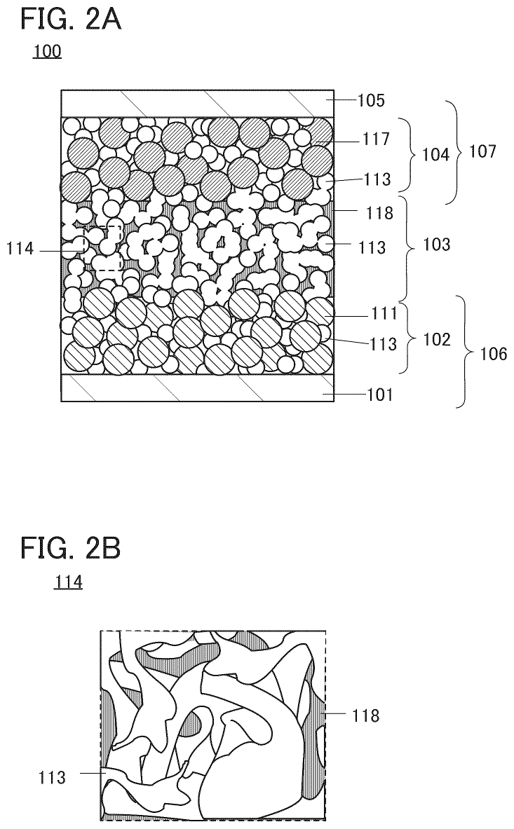

FIG. 2A illustrates a schematic cross-sectional view of the secondary battery 100 of one embodiment of the present invention. FIG. 2A illustrates a structure including the negative electrode active material layer 104 as in FIG. TA. It is needless to say that the negative electrode active material layer 104 in FIG. 2A can be unnecessary as illustrated in FIG. 1B.

In FIG. 2A, the positive electrode active material layer 102 contains at least a positive electrode active material 111 and a solid electrolyte 113. Although FIG. 2A illustrates the positive electrode active material 111 and the solid electrolyte 113 having particle shapes, the shapes are not limited to particle shapes. Since the positive electrode active material layer 102 contains the solid electrolyte 113, the secondary battery 100 can operate even when the positive electrode active material layer 102 does not contain an ionic liquid. Furthermore, the solid electrolytes 113 exist continuously from the electrolyte layer 103 to the positive electrode active material layer 102 as illustrated in FIG. 2A; thus, the interface resistance between the layers can be inhibited. Note that the solid electrolyte 113 contained in the positive electrode active material layer 102 and the solid electrolyte 113 contained in the electrolyte layer 103 are preferably formed using the same material, in which case one of them preferably has a particle shape and the other preferably has a sintered body shape. A sintered body includes a state in which particles are bonded to each other, and a space might be generated between the particles.

The positive electrode active material layer 102 may contain a conductive additive; the conductive additive is not illustrated in FIG. 2A. Since the positive electrode active material layer 102 contains the solid electrolyte 113, the conductive additive can be unnecessary. The positive electrode active material layer 102 may contain a binder; the binder is not illustrated in FIG. 2A. Since the positive electrode active material layer 102 contains the solid electrolyte 113, the binder can be unnecessary.

The positive electrode active material layer 102 may contain an ionic liquid instead of the solid electrolyte 113 or may contain an ionic liquid in addition to the solid electrolyte 113. Note that the ionic liquid contained in the positive electrode active material layer 102 and the ionic liquid contained in the electrolyte layer 103 are preferably formed using the same material, in which case one of them may be in a gel state and the other may be in a liquid state.

In FIG. 2A, the negative electrode active material layer 104 contains at least a negative electrode active material 117 and the solid electrolyte 113. Although FIG. 2A illustrates the negative electrode active material 117 and the solid electrolyte 113 having particle shapes, the shapes are not limited to particle shapes. Since the negative electrode active material layer 104 contains the solid electrolyte 113, the secondary battery 100 can operate even when the negative electrode active material layer 104 does not contain an ionic liquid. Furthermore, the solid electrolytes 113 exist continuously from the electrolyte layer 103 to the negative electrode active material layer 104 as illustrated in FIG. 2A; thus, the interface resistance between the layers can be inhibited. Note that the solid electrolyte 113 contained in the negative electrode active material layer 104 and the solid electrolyte 113 contained in the electrolyte layer 103 are preferably formed using the same material, in which case one of them preferably has a particle shape and the other preferably has a sintered body shape. A sintered body includes a state in which particles are bonded to each other, and a space might be generated between the particles.

The negative electrode active material layer 104 may contain a conductive additive; the conductive additive is not illustrated in FIG. 2A. Since the negative electrode active material layer 104 contains the solid electrolyte 113, the conductive additive can be unnecessary. The negative electrode active material layer 104 may contain a binder; the binder is not illustrated in FIG. 2A. Since the negative electrode active material layer 104 contains the solid electrolyte 113, the binder can be unnecessary.

The negative electrode active material layer 104 may contain an ionic liquid instead of the solid electrolyte 113 or in addition to the solid electrolyte 113. Note that the ionic liquid contained in the negative electrode active material layer 104 and the ionic liquid contained in the electrolyte layer 103 are preferably formed using the same material, in which case one of them may be in a gel state and the other may be in a liquid state.

In FIG. 2A, the electrolyte layer 103 contains the solid electrolyte 113 as a solid material and contains an ionic liquid 118 as a liquid material. FIG. 2B illustrates an enlarged schematic diagram of a region 114, which is part of the electrolyte layer 103. As illustrated in FIG. 2B, the solid electrolyte 113 preferably forms a sintered body. In the electrolyte layer 103, some of the solid electrolytes 113 may have particle shapes.

As illustrated in FIG. 2B, the solid electrolyte 113, which forms a sintered body, has a space. The space can be formed in accordance with baking conditions or the like of the solid electrolyte. The baking conditions can be set such that a space in the electrolyte layer 103 is reduced to inhibit a short circuit between the positive electrode and the negative electrode, for example. Note that a space is not necessarily reduced in the present invention because the space is filled with the ionic liquid 118. To inhibit a short circuit in the space, the viscosity or the like of the ionic liquid 118 is adjusted, for example.

In the case where the proportion of the ionic liquid 118 in the electrolyte layer 103 is increased, the space is increased. To increase the space, a baking step may be performed in a state where an organic material whose melting point is lower than or equal to baking temperature is mixed. In the baking step, a space corresponding to an organic material which has disappeared by melting can be formed. One embodiment of the present invention involves increasing a space while controlling the space as described above, not reducing the space.

A region where the ionic liquid 118 exists in FIG. 2B corresponds to the space. Note that the ionic liquid 118 filling the space is preferably gelled to inhibit a short circuit between the positive electrode and the negative electrode.

The electrolyte layer 103 may be processed into a sheet-like shape in a step such as pressing. The electrolyte layer 103 may contain a plurality of solid electrolytes having particle shapes. This means that the electrolyte layer 103 can have a space between particles even when the electrolyte layer 103 contains a plurality of solid electrolytes having particle shapes, not sintered bodies.

The thickness of the electrolyte layer 103 having a sheet-like shape is preferably greater than or equal to 1 μm and less than or equal to 100 μm, further preferably greater than or equal to 1 μm and less than or equal to 50 μm, still further preferably greater than or equal to 1 μm and less than or equal to 20 μm.

The positions of spaces in the electrolyte layer 103 may be controlled. When spaces are connected to one another from the positive electrode layer toward the negative electrode layer to form a hole, the possibility of a short circuit of the secondary battery is increased because of a dendritic protrusion (dendrite) or the like generated in the negative electrode layer, for example. Thus, the positions of the spaces are preferably controlled so as not to overlap with each other so that such a hole is not generated in the electrolyte layer 103.

Since a liquid material fills the space as described above, a short circuit of the secondary battery due to a dendrite or the like can be inhibited by increasing the viscosity or the like of the liquid material.

The proportion of the space in the electrolyte layer 103 may be controlled. For example, the proportion of a space in the middle of the electrolyte layer 103 is preferably set higher than that of a space in the electrolyte layer 103 on the side closer to the positive electrode layer or the negative electrode layer. In the case of inhibiting a dendrite from being generated in the negative electrode layer, the proportion of the space in the electrolyte layer 103 is preferably set lower on the side closer to the negative electrode layer.

The electrolyte layer 103 may have a stacked-layer structure, and two or more, preferably three or more electrolyte layers are preferably stacked. In the case of three-layer structure, the proportion of a space in the electrolyte layer positioned in the middle can be different from the proportions of spaces in the electrolyte layers positioned above and below the electrolyte layer in the middle. Such an electrolyte layer 103 can inhibit the above-described short circuit of the secondary battery. Instead of the electrolyte layer positioned in the middle, a separator may be provided.

As already described above, the electrolyte layer 103 having a sheet-like shape is preferably prepared. The sheet-like electrolyte layer is suitable for the above stacked-layer structure. An ionic liquid in a gel state is preferable to a liquid material for the electrolyte layer 103 having a sheet-like shape to maintain its shape.

A separator may be provided in addition to the electrolyte layer 103 to inhibit the above-described short circuit of the secondary battery.

As illustrated in FIG. 2A and FIG. 2B, the solid electrolyte 113 holds the ionic liquid 118 in the electrolyte layer 103. In other words, the solid electrolyte 113 is impregnated with the ionic liquid 118 in the electrolyte layer 103. Such an electrolyte layer 103 is preferable because the ionic liquid 118 does not leak. The electrolyte layer 103 is referred to as a semi-solid electrolyte layer in some cases. Note that the solid electrolyte 113 can be any solid material and the ionic liquid 118 can be any liquid material as described above.

The electrolyte layer 103 may contain a binder. In that case, the solid electrolyte 113 can easily hold the ionic liquid 118. Note that the binder is not illustrated in FIG. 2A and FIG. 2B.

Although FIG. 2A illustrates as if there were boundaries between layers, a clear boundary cannot be observed in the secondary battery 100 in some cases. For example, when the electrolyte layer 103 having a sheet-like shape is bonded to the positive electrode layer 106 by pressing, the boundary between the electrolyte layer 103 and the positive electrode layer 106 becomes unclear. This is because part of the positive electrode active material 111 enters the electrolyte layer 103 and part of the solid electrolyte 113 enters the positive electrode layer 106. Similarly, in some cases, part of the negative electrode active material 117 enters the electrolyte layer 103 and part of the solid electrolyte 113 enters the negative electrode layer 107, in which case the boundary between the electrolyte layer 103 and the negative electrode layer 107 becomes unclear.

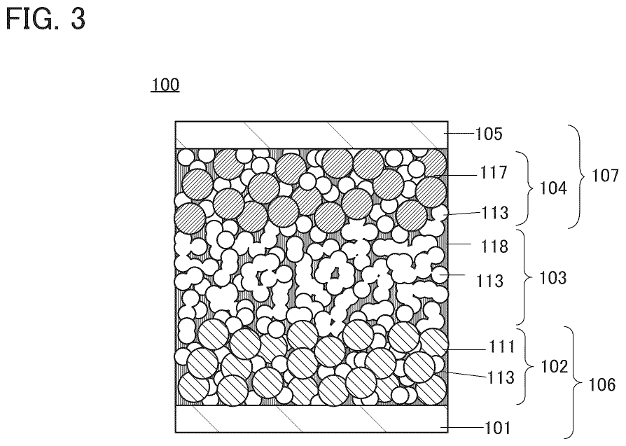

FIG. 3 illustrates a schematic cross-sectional view of the secondary battery 100 of one embodiment of the present invention. FIG. 3 illustrates a structure including the negative electrode active material layer 104 as in FIG. 1A. It is needless to say that the negative electrode active material layer 104 in FIG. 3 can be omitted as illustrated in FIG. 1B.

Unlike in FIG. 2A, the ionic liquid 118 in the secondary battery 100 illustrated in FIG. 3 exists in the secondary battery 100 entirely. When the secondary battery 100 is fabricated by stacking the positive electrode layer 106, the electrolyte layer 103, and the negative electrode layer 107 followed by a step such as injection of the ionic liquid 118, the ionic liquid 118 can exist in the secondary battery 100 entirely as illustrated in FIG. 3. In that case, the ionic liquid is not gelled or is subjected to gelation treatment after being injected.

The other structures are similar to those in FIG. 2A and FIG. 2B.

As in common in FIG. 2A and FIG. 3, the solid electrolyte 113 holds the ionic liquid 118 at least in the electrolyte layer 103. In other words, the solid electrolyte 113 is impregnated with the ionic liquid 118 at least in the electrolyte layer 103. Such an electrolyte layer 103 is preferable because the ionic liquid 118 does not leak. The electrolyte layer 103 is referred to as a semi-solid electrolyte layer in some cases. Note that the solid electrolyte 113 can be any solid material and the ionic liquid 118 can be any liquid material as described above.

As in FIG. 2A and the like, a clear boundary cannot be observed in the secondary battery 100 in FIG. 3 in some cases.

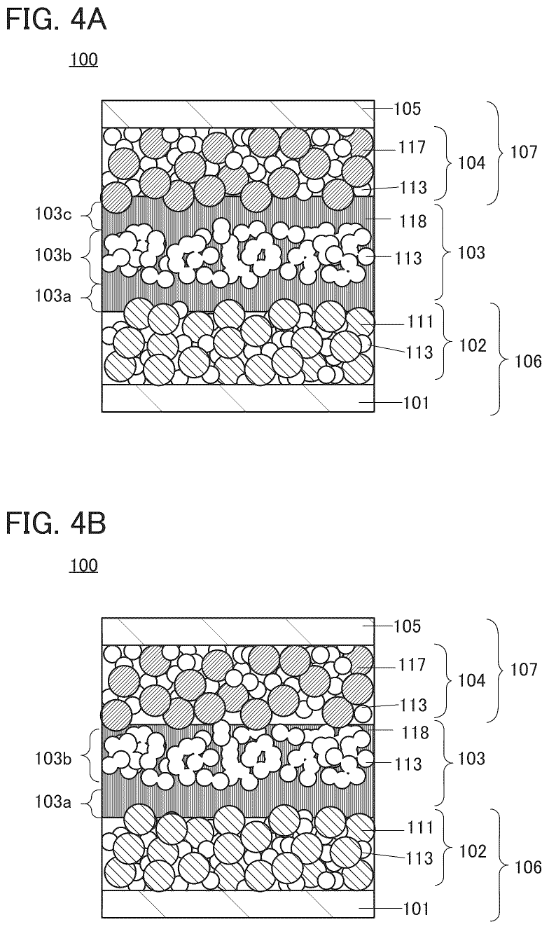

FIG. 4A illustrates a schematic cross-sectional view of the secondary battery 100 of one embodiment of the present invention. FIG. 4 illustrates a structure including the negative electrode active material layer 104 as in FIG. 1A. It is needless to say that the negative electrode active material layer 104 in FIG. 4 can be omitted as illustrated in FIG. 1B.

Unlike in FIG. 2A and the like, in the secondary battery 100 illustrated in FIG. 4A, the solid electrolyte 113 is positioned only in the middle of the electrolyte layer 103 and a region including no solid electrolyte 113 exists on the positive electrode layer side and the negative electrode layer side. The electrolyte layer 103 having such a structure can be divided into a first electrolyte layer 103a, a second electrolyte layer 103b, and a third electrolyte layer 103c in accordance with the proportion of the contained solid electrolyte 113. Such a structure is referred to as a stacked-layer structure in some cases; FIG. 4A illustrates an example in which the electrolyte layer 103 has a stacked-layer structure of three layers.

The electrolyte layer 103 can have a stacked-layer structure of two or more layers. FIG. 4B illustrates the secondary battery 100 including the electrolyte layer 103 having a stacked-layer structure of two layers.

In FIG. 4A, the first electrolyte layer 103a positioned in a region including no solid electrolyte 113 and the third electrolyte layer 103c positioned in a region including no solid electrolyte 113 preferably contain a gel-like ionic liquid or the like. In FIG. 4B, the first electrolyte layer 103a containing no solid electrolyte 113 preferably contains a gel-like ionic liquid or the like.

The other structures are similar to those in FIG. 2A, FIG. 2B, and FIG. 3.

As in common in FIG. 2A, FIG. 3, FIG. 4A, and FIG. 4B, the solid electrolyte 113 holds the ionic liquid 118 at least in the electrolyte layer 103. In other words, the solid electrolyte 113 is impregnated with the ionic liquid 118 at least in the electrolyte layer 103. Such an electrolyte layer 103 is preferable because the ionic liquid 118 does not leak. The electrolyte layer 103 is referred to as a semi-solid electrolyte layer in some cases. Note that the solid electrolyte 113 can be any solid material and the ionic liquid 118 can be any liquid material as described above.

Although FIG. 4A and FIG. 4B illustrate as if there were boundaries between layers, a clear boundary cannot be observed in the secondary battery 100 in some cases, as in FIG. 2A or the like.

Next, components of the secondary battery 100 illustrated in FIG. 1 to FIG. 4 will be described.

### <Current Collector>

For each of the positive electrode current collector 101 and the negative electrode current collector 105, a material having high conductivity such as a metal like stainless steel, gold, platinum, aluminum, copper, or titanium, or an alloy thereof can be used. It is preferable that a material used for the positive electrode current collector not dissolve at the potential of the positive electrode. Alternatively, it is possible to use an aluminum alloy to which an element that improves heat resistance, such as silicon, titanium, neodymium, scandium, or molybdenum, is added. Still alternatively, a metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. A layer of carbon black or graphene may also be included as an undercoating. The current collector preferably has a thickness greater than or equal to 5 μm and less than or equal to m. Note that a foil-like shape refers to a shape with a thickness greater than or equal to 1 μm and less than or equal to 100 μm, preferably greater than or equal to 5 μm and less than or equal to 30 μm.

In the case where LiFSI (FSI is an abbreviation for a bis(fluorosulfonyl)imide anion) is used as a lithium salt, in particular, the positive electrode current collector 101 and the negative electrode current collector 105 are preferably formed using a material that is not easily corroded by LiFSI. For example, titanium and a titanium compound are not easily corroded and thus are preferable. Similarly, titanium, a titanium compound, or aluminum that is coated with carbon is also preferable.

### <Active Material>

As the positive electrode active material 111 contained in the positive electrode layer 106, for example, a composite oxide having a layered rock-salt crystal structure, a spinel crystal structure, or an olivine crystal structure can be used. For example, a composite oxide containing lithium and a transition metal, such as lithium cobalt oxide, lithium nickel oxide, lithium cobalt oxide in which manganese is substituted for part of cobalt, lithium cobalt oxide in which nickel is substituted for part of cobalt, lithium nickel-manganese-cobalt oxide, lithium iron phosphate, lithium ferrate, or lithium manganese oxide can be used. Lithium does not have to be contained as long as the material functions as a positive electrode active material, and V₂O₅, Cr₂O₅, MnO₂, or the like may be used.

Other positive electrode active materials will be described later.

As the negative electrode active material 117 contained in the negative electrode layer 107, an element that enables charge and discharge reactions by an alloying and a dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used as the negative electrode active material. Alternatively, a compound containing any of these elements may be used. For example, SiO (which is silicon monoxide and is expressed as SiO_{X} in some cases; x is preferably greater than or equal to 0.2 and less than or equal to 1.5), Mg₂Si, Mg₂Ge, SnO, SnO₂, Mg₂Sn, SnS₂, V₂Sn₃, FeSn₂, CoSn₂, Ni₃Sn₂, Cu₆Sns, Ag₃Sn, Ag₃Sb, Ni₂MnSb, CeSb₃, LaSn₃, La₃Co₂Sn₇, CoSb₃, InSb, and SbSn are given. Here, an element that enables charge and discharge reactions by an alloying and a dealloying reaction with lithium and a compound containing the element, for example, are referred to as alloy-based materials in some cases.

Silicon nanoparticles can be used as the negative electrode active material containing silicon. The median diameter (D50) of silicon nanoparticles is greater than or equal to 5 nm and less than 1 μm, preferably greater than or equal to 10 nm and less than or equal to 300 nm, further preferably greater than or equal to 10 nm and less than or equal to 100 nm. The silicon nanoparticles may have crystallinity. The silicon nanoparticles may include a region with crystallinity and an amorphous region.

The negative electrode active material containing silicon may be in the form of a silicon monoxide particle including one or more silicon crystal grains. The silicon monoxide may be amorphous. The silicon monoxide particle may be coated with carbon. This particle can be mixed with graphite to be used as the negative electrode active material.

As the carbon material, graphite, graphitizing carbon (soft carbon), non-graphitizing carbon (hard carbon), carbon nanotube, graphene, carbon black, or the like is used. Such a carbon material preferably contains fluorine. A carbon material containing fluorine can also be referred to as a particulate or fibrous fluorinated carbon material. In the case where the carbon material is subjected to measurement by X-ray photoelectron spectroscopy, the concentration of fluorine is preferably higher than or equal to 1 atomic % (also expressed as at % in some cases) with respect to the total concentration of fluorine, oxygen, lithium, and carbon.

Although the volume of the negative electrode active material sometimes changes in charging and discharging, an organic compound containing fluorine, such as fluorinated carbonate ester, placed between negative electrode active materials maintains smoothness and inhibits a crack even when the volume changes in charging and discharging, so that an effect of increasing cycle performance is obtained. It is important that an organic compound containing fluorine exists between a plurality of negative electrode active materials.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li-MN (M is Co, Ni, or Cu) with a Li₃N structure, which is a composite nitride of lithium and a transition metal, can be used. For example, Li_{2.6}Co_{0.4}N₃ is preferable because of high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that in the case of using a material containing lithium ions as a positive electrode active material, the nitride containing lithium and a transition metal can be used as the negative electrode active material by extracting the lithium ions contained in the positive electrode active material in advance.

Alternatively, a material that causes a conversion reaction can be used for the negative electrode active material; for example, a transition metal oxide that does not form an alloy with lithium, such as cobalt oxide (CoO), nickel oxide (NiO), or iron oxide (FeO), may be used. A conversion reaction also occurs in oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

Lithium can also be used as the negative electrode active material. In the case of using lithium as the negative electrode active material, lithium foil can be provided over the negative electrode current collector. Lithium may also be provided over the negative electrode current collector by a gas phase method such as an evaporation method or a sputtering method. In a solution containing lithium ions, lithium may be deposited on the negative electrode current collector by an electrochemical method.

For the conductive additive and the binder that can be contained in the negative electrode active material layer, materials similar to those of the conductive additive and the binder that can be contained in the positive electrode active material layer can be used.

For the current collector, copper or the like can be used in addition to a material similar to that for the positive electrode current collector. Note that a material that is not alloyed with carrier ions of lithium or the like is preferably used for the negative electrode current collector.

As another form of the negative electrode, a negative electrode that does not contain a negative electrode active material can be used. In a secondary battery including the negative electrode that does not contain a negative electrode active material, lithium can be deposited on a negative electrode current collector at the time of charging, and lithium on the negative electrode current collector can be dissolved at the time of discharging. Thus, lithium is on the negative electrode current collector in the states except for the completely discharged state.

In the case where the negative electrode that does not include a negative electrode active material is used, a film for making lithium deposition uniform may be provided over the negative electrode current collector. For the film for making lithium deposition uniform, for example, a solid electrolyte having lithium ion conductivity can be used, and the electrolyte layer can be positioned over the negative electrode current collector.

As the solid electrolyte, a sulfide-based solid electrolyte, an oxide-based solid electrolyte, halide-based solid electrolyte, a polymer-based solid electrolyte, or the like can be used. In particular, the polymer-based solid electrolyte can be uniformly formed as a film over the negative electrode current collector relatively easily, and thus is suitable for the film for making lithium deposition uniform. The sulfide-based solid electrolyte, the oxide-based solid electrolyte, the halide-based solid electrolyte, and the polymer-based solid electrolyte will be described later.

In the case where the negative electrode that does not include a negative electrode active material is used, a negative electrode current collector having unevenness can be used. When the negative electrode current collector having unevenness is used, a depression of the negative electrode current collector becomes a cavity in which lithium contained in the negative electrode current collector is easily deposited, so that the lithium can be prevented from having a dendrite-like shape when being deposited.

### <Solid Electrolyte>

As the solid material used for the electrolyte layer or the like of one embodiment of the present invention, a solid electrolyte is given. There are an oxide-based solid electrolyte, a sulfide-based solid electrolyte, and a halide-based solid electrolyte, and a solid electrolyte obtained by mixing them may be used for the electrolyte layer or the like.

As the oxide-based solid electrolyte, materials such as a material with a perovskite crystal structure (e.g., La_{2/3-x}Li₃ₓTiO₃), a material with a NASICON crystal structure (e.g., Li_{1+X}Al_{X}Ti_{2-X}(PO₄)₃), a material with a garnet crystal structure (e.g., Li₇La₃Zr₂O₁₂ (LLZO) or Li_{6.25}La₃Zr₂Al_{0.25}O₁₂ (LLZAO)), a material with a LISICON crystal structure (e.g., Li₁₄ZnGe₄O₁₆), oxide glass (e.g., Li₃PO₄−Li₄SiO₄ or 50Li₄SiO₄·50Li₃BO₃), and oxide-based crystallized glass (e.g., Li_{1.07}Al_{0.69}Ti_{1.46}(PO₄)₃ or Li_{1.5}Al_{0.5}Ge_{1.5}(PO₄)₃) can be given. The oxide-based solid electrolyte is resistant to heat, and has an advantage such as higher stability in the air than the later-described sulfide-based solid electrolyte.

As the sulfide-based solid electrolyte, materials such as a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), and sulfide-based crystallized glass (e.g., Li₇P₃S₁₁ or Li_{3.25}P_{0.95}S₄) can be given. The sulfide-based solid electrolyte has advantages such as high conductivity of some materials, low-temperature synthesis, and ease of maintaining a path for electrical conduction after charging and discharging because of its relative softness.

As the halide-based solid electrolyte, LiAlCl₄, Li₃InBr₆, LiF, LiCl, LiBr, LiI, and the like can be given.

As the solid material used for the electrolyte layer or the like of one embodiment of the present invention, a mixed material in which pores of porous aluminum oxide or porous silica are filled with a solid electrolyte can be used. In other words, a material obtained by mixing a ceramics material into a solid electrolyte may be used for the electrolyte layer or the like.

Although the electrolyte layer is described as a solid using the case of a solid electrolyte, a material with no fluidity can be used as long as it can hold an ionic liquid, and a polymer material may be used to hold an ionic liquid. A structure in which a polymer material holds an ionic liquid is also referred to as a semi-solid in some cases. The electrolyte layer 103 of the secondary battery 100 with such a structure is referred to as a semi-solid electrolyte layer in some cases.

As the polymer material used for the electrolyte layer or the like of one embodiment of the present invention, a lithium ion conductive polymer can be given. The lithium ion conductive polymer is referred to as a polymer-based solid electrolyte in some cases. As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

In the electrolyte layer or the like of one embodiment of the present invention, a graphene compound or graphene may be mixed into the above-described solid electrolyte. Since a graphene compound has excellent physical properties of high flexibility and high mechanical strength, the solid electrolyte can have high flexibility and high mechanical strength.

A graphene compound includes multilayer graphene, graphene oxide, multilayer graphene oxide, multi graphene oxide, and the like. A graphene compound contains carbon, has a plate-like shape, a sheet-like shape, or the like, and has a two-dimensional structure formed of a six-membered ring of carbon. The two-dimensional structure formed of the six-membered ring of carbon is referred to as a carbon sheet in some cases. A graphene compound may include a functional group. The graphene compound preferably has a bent shape. The graphene compound may be rounded like a carbon nanofiber.

Graphene oxide contains carbon and oxygen, has a sheet-like shape, and includes a functional group, in particular, an epoxy group, a carboxy group, or a hydroxy group.

### <Ionic Liquid>

An ionic liquid can be used as a liquid material used for the electrolyte layer or the like of one embodiment of the present invention. The ionic liquid will be described.

The ionic liquid, which is sometimes referred to as a room temperature molten salt, contains a cation and an anion. The cation includes an imidazolium-based skeleton, an ammonium-based skeleton, a pyrrolidinium-based skeleton, a piperidinium-based skeleton, a pyridinium-based skeleton, or a phosphonium-based skeleton. A cation including an imidazolium-based skeleton can provide an ionic liquid having low viscosity as compared with a cation including an ammonium-based skeleton. Low viscosity tends to increase carrier ion conductivity. In addition, the viscosity or the like of the ionic liquid can be controlled with an alkyl group of a side chain of the cation or the like.

### <General Formula of Cation>

The cation in the ionic liquid of one embodiment of the present invention is described.

The ionic liquid of one embodiment of the present invention contains an imidazolium-based cation represented by General Formula (G1).

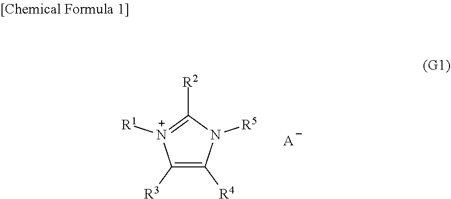

In General Formula (G1) above, R¹ represents an alkyl group having 1 to 10 carbon atoms, R² to R⁴ each independently represent a hydrogen atom or an alkyl group having 1 to 4 carbon atoms, and R⁵ represents an alkyl group having 1 to 6 carbon atoms or an ether group, a thioether group, or a siloxane having a main chain composed of two or more selected from C, O, Si, N, S, and P atoms. In General Formula (G1) above, A⁻ represents an anion and is preferably FSI or TFSI described later.

The ionic liquid of one embodiment of the present invention contains a pyridinium-based cation represented by General Formula (G2).

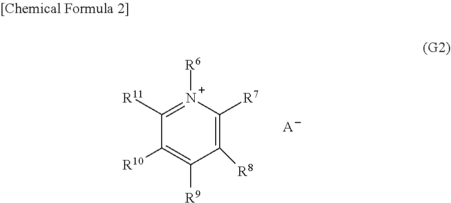

In General Formula (G2) above, R⁶ has an alkyl group having 1 to 6 carbon atoms, or a main chain composed of two or more selected from C, O, Si, N, S, and P atoms. R⁷ to R¹¹ each independently represent a hydrogen atom or an alkyl group having 1 to 4 carbon atoms. Furthermore, R⁸ or R⁹ represents a hydroxyl group in some cases. In General Formula (G2) above, A⁻ represents an anion and is preferably FSI or TFSI described later.

The ionic liquid of one embodiment of the present invention may contain a quaternary ammonium cation, and contains a quaternary ammonium cation represented by General Formula (G3), for example.

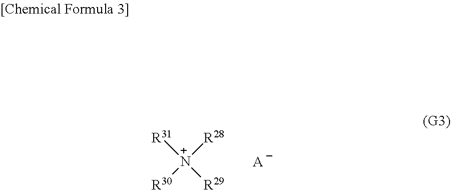

In General Formula (G3) above, R²⁸ to R³¹ each independently represent any of a hydrogen atom and an alkyl group having 1 to 20 carbon atoms, a methoxy group, a methoxymethyl group, and a methoxyethyl group. In General Formula (G3) above, A represents an anion and is preferably FSI or TFSI described later.

The ionic liquid of one embodiment of the present invention contains a cation represented by General Formula (G4).

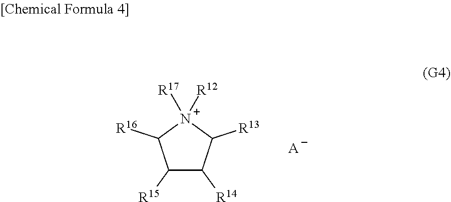

In General Formula (G4) above, R¹² and R¹⁷ each independently represent an alkyl group having 1 to 3 carbon atoms. R¹³ to R¹⁶ each independently represent any of a hydrogen atom and an alkyl group having 1 to 3 carbon atoms. In General Formula (G4) above, A⁻ represents an anion and is preferably FSI or TFSI described later.

The ionic liquid of one embodiment of the present invention contains a cation represented by General Formula (G5).

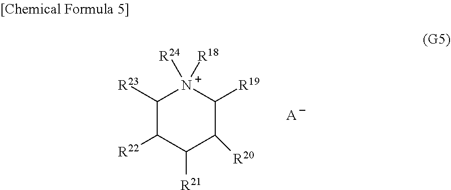

In General Formula (G5) above, R¹⁸ and R²⁴ each independently represent an alkyl group having 1 to 3 carbon atoms. R¹⁹ to R²³ each independently represent a hydrogen atom or an alkyl group having 1 to 3 carbon atoms. In General Formula (G5) above, A⁻ represents an anion and is preferably FSI or TFSI described later.

The ionic liquid of one embodiment of the present invention contains a cation represented by General Formula (G6).

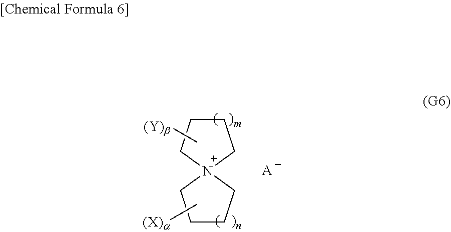

In General Formula (G6) above, n and m are each greater than or equal to 1 and less than or equal to 3, α is greater than or equal to 0 and less than or equal to 6, β is greater than or equal to 0 and less than or equal to 6, and X or Y represents, as a substituent, a linear or side-chain alkyl group having 1 to 4 carbon atoms, a linear or side-chain alkoxy group having 1 to 4 carbon atoms, or a linear or side-chain alkoxyalkyl group having 1 to 4 carbon atoms. In General Formula (G6) above, A⁻ represents an anion and is preferably FSI or TFSI described later.

The ionic liquid of one embodiment of the present invention contains a tertiary sulfonium cation represented by General Formula (G7).

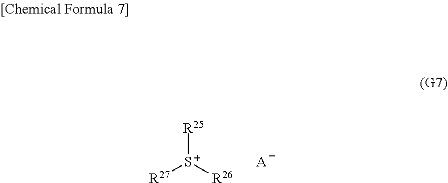

In General Formula (G7) above, R²⁵ to R²⁷ each independently represent a hydrogen atom, an alkyl group having 1 to 4 carbon atoms, or a phenyl group. R²⁵ to R²⁷ each independently has a main chain composed of two or more selected from C, O, Si, N, S, and P atoms. In General Formula (G7), A⁻ represents an anion and is preferably FSI or TFSI described later.

The ionic liquid of one embodiment of the present invention contains a quaternary phosphonium cation represented by General Formula (G8) below.

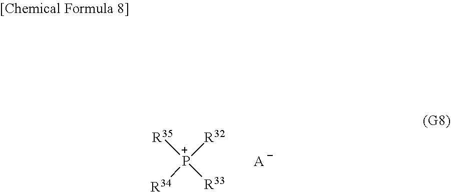

In General Formula (G8) above, R³² to R³⁵ each independently represent a hydrogen atom, an alkyl group having 1 to 4 carbon atoms, or a phenyl group. R³² to R³⁵ each independently has a main chain composed of two or more selected from C, O, Si, N, S, and P atoms. In General Formula (G8), A⁻ represents an anion and is preferably FSI or TFSI described later.

### <Cation>

Specific examples of the cation represented by General Formula (G1) above include Structural Formula (111) to Structural Formula (174). Structural Formula (111) represents a 1-ethyl-3methyl imidazolium cation, which is abbreviated as EMI. Structural Formula (113) represents a 1-butyl-3methyl imidazolium cation, which is abbreviated as BMI.

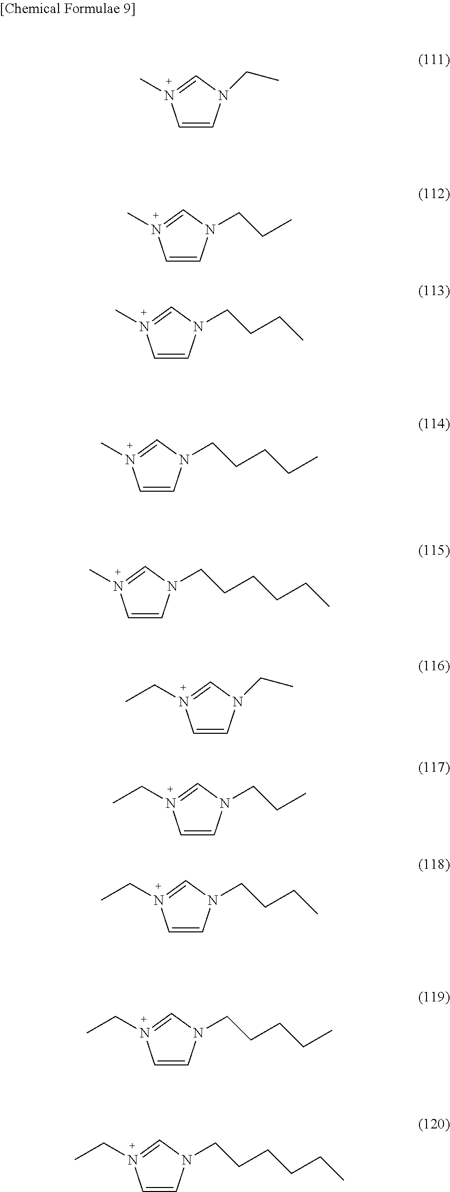

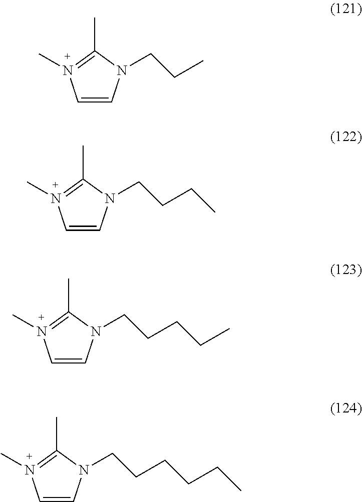

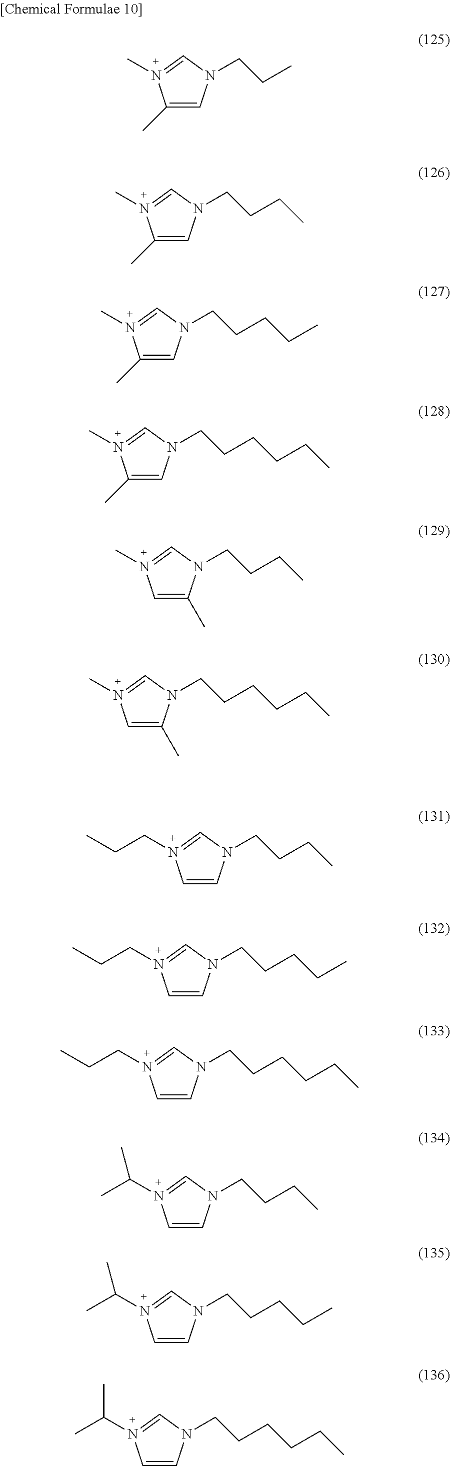

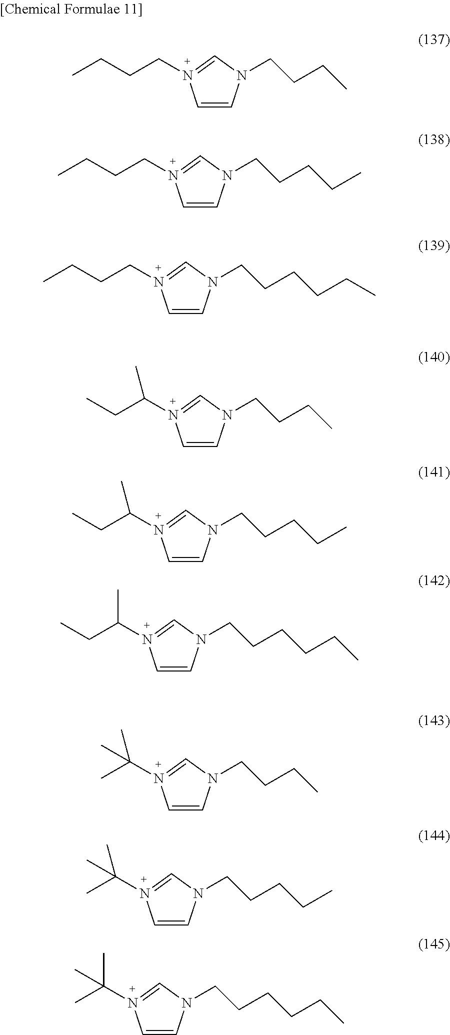

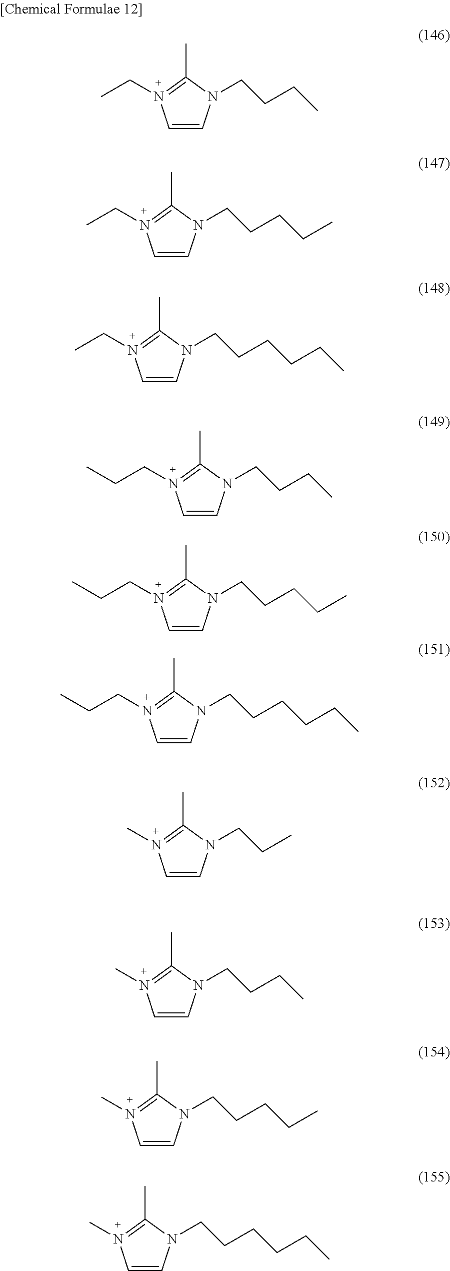

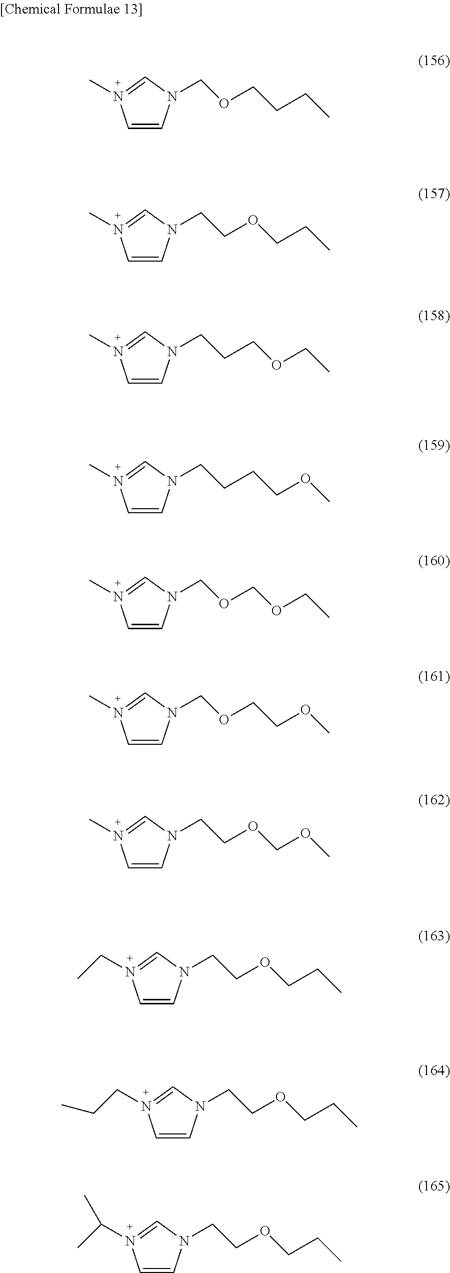

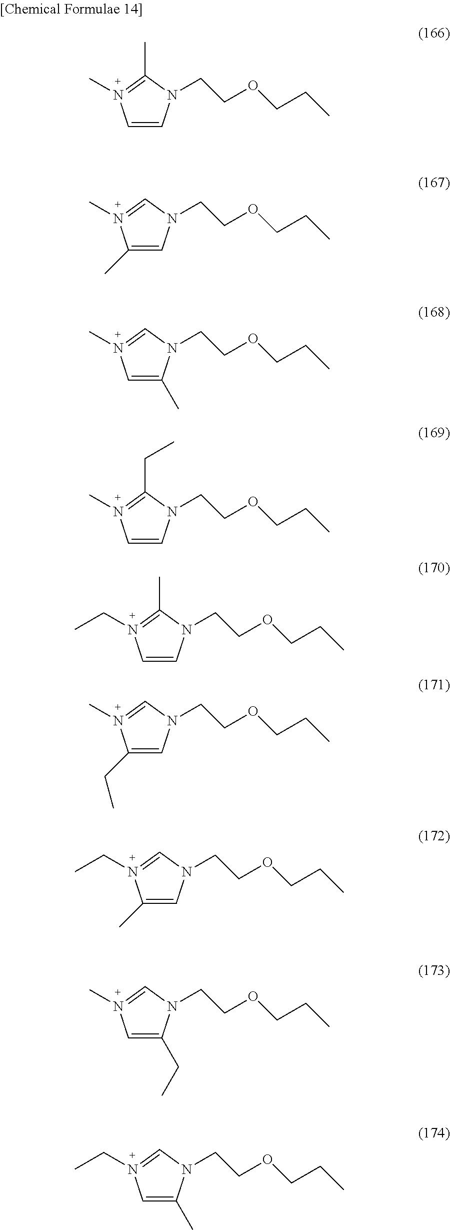

Specific examples of the cation represented by General Formula (G2) above include Structural Formula (701) to Structural Formula (719).

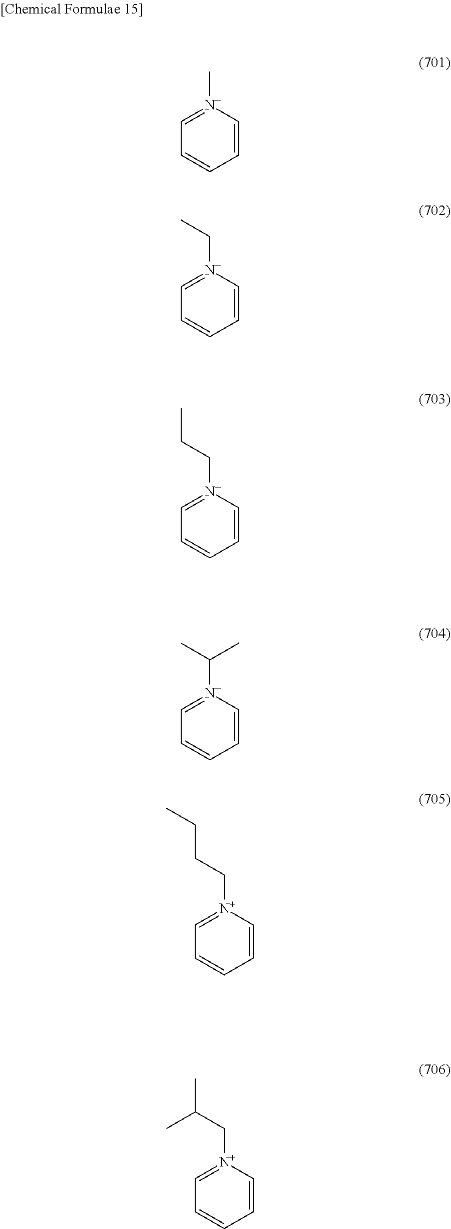

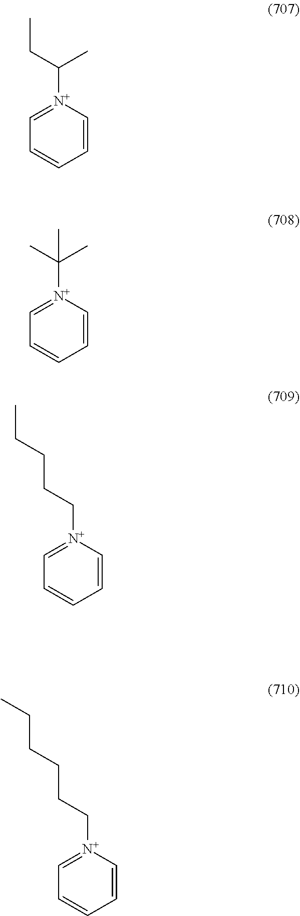

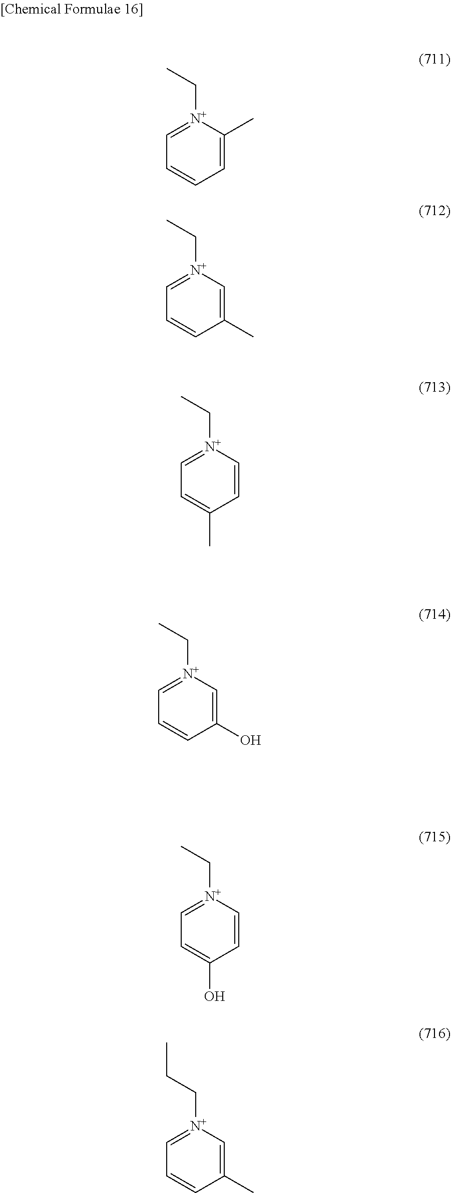

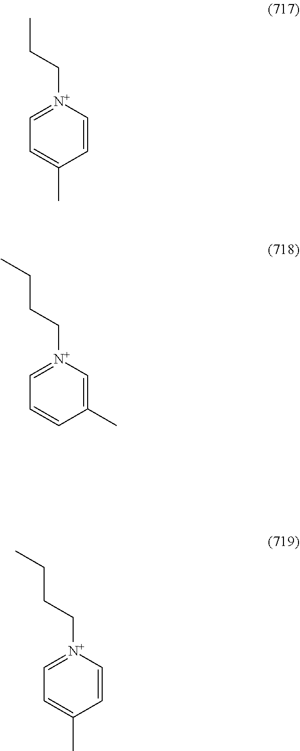

Specific examples of the cation represented by General Formula (G4) above include Structural Formula (501) to Structural Formula (520).

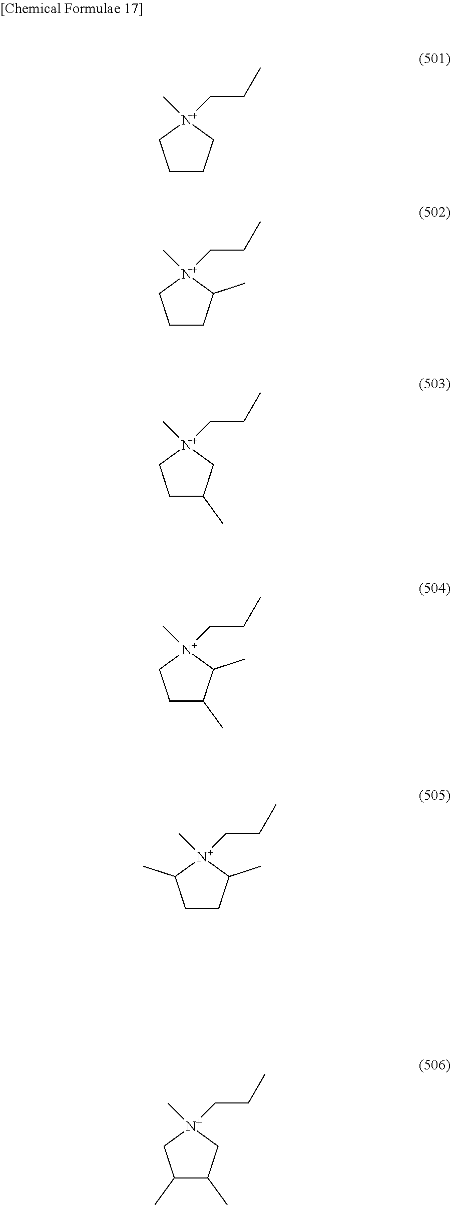

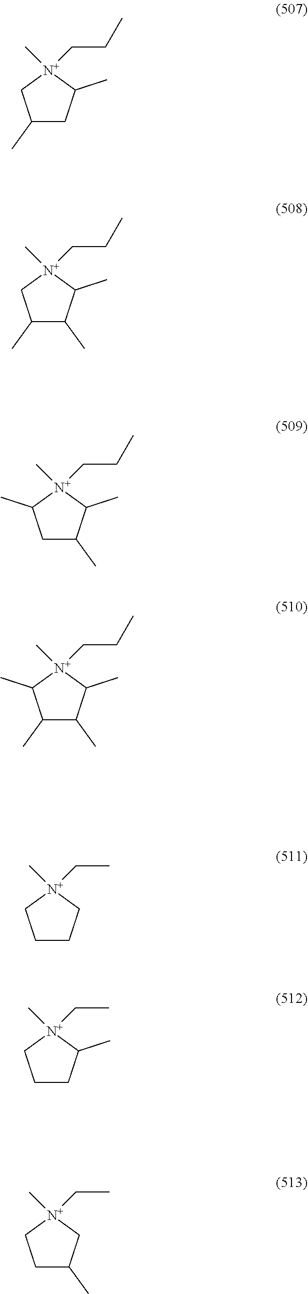

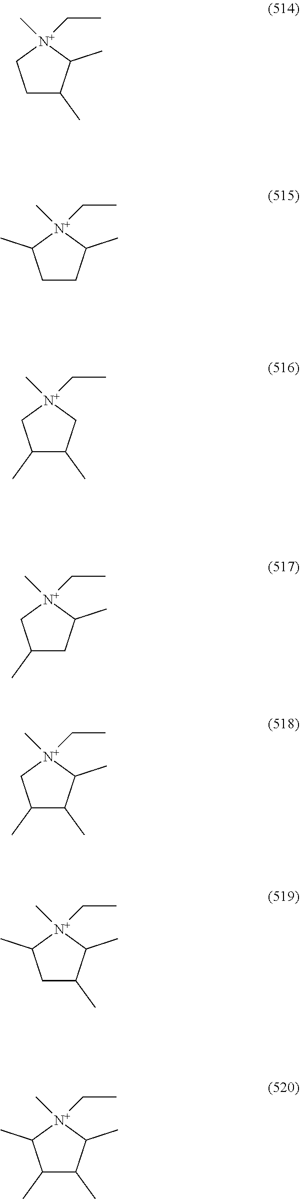

Specific examples of the cation represented by General Formula (G5) above include Structural Formula (601) to Structural Formula (630).

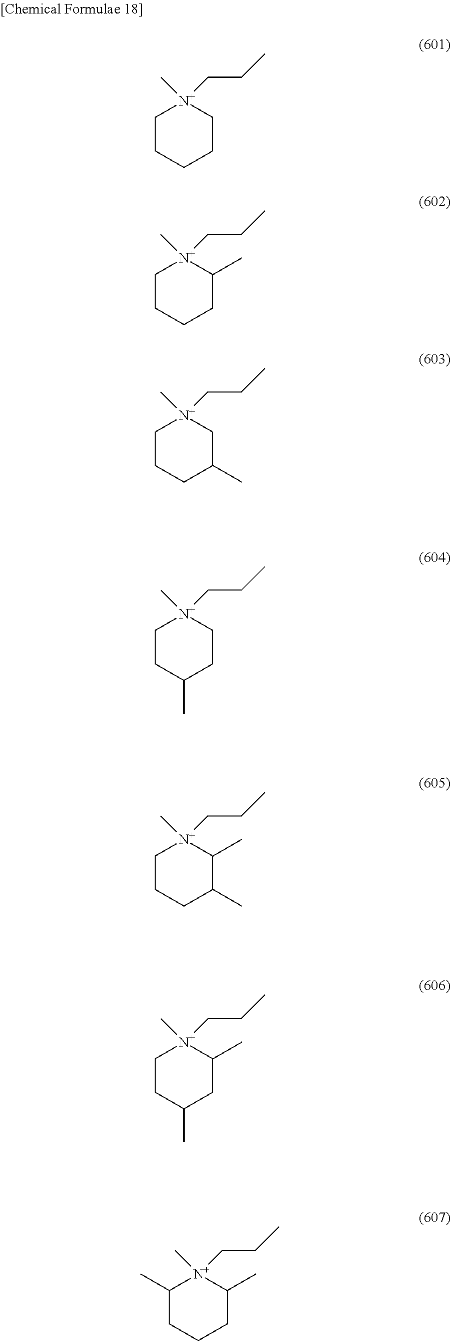

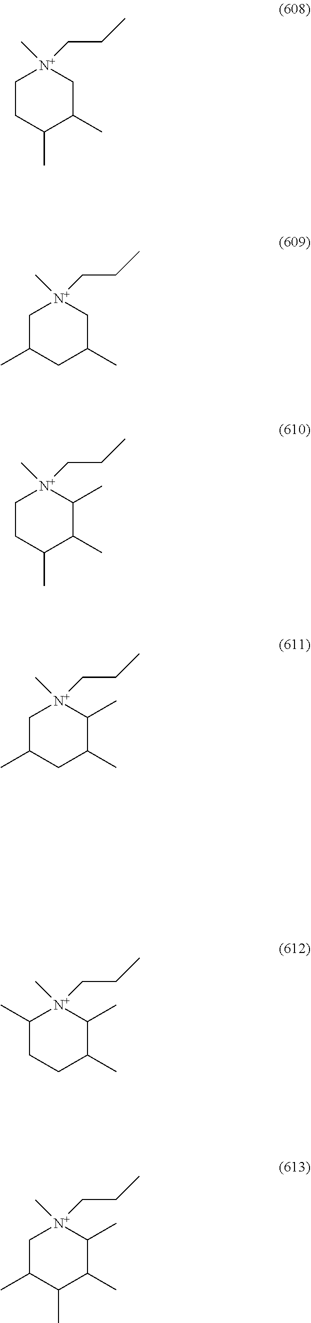

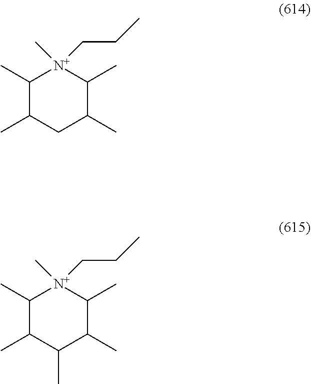

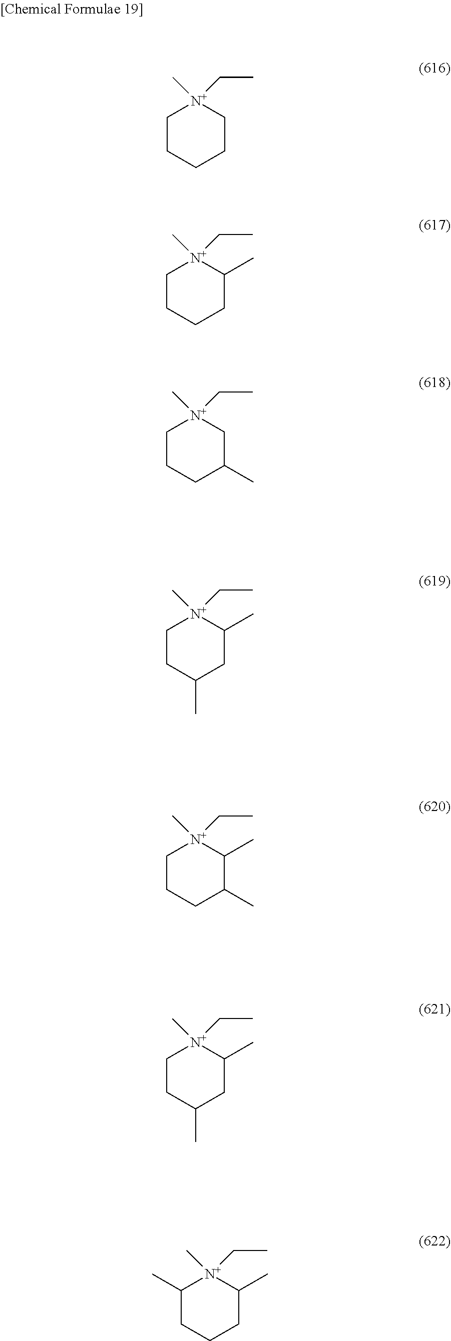

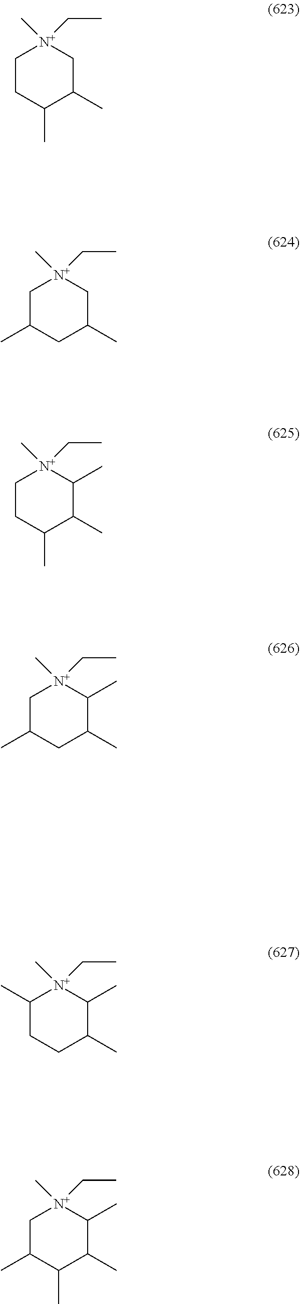

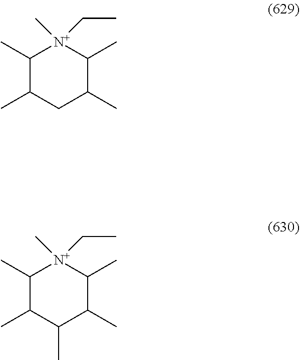

Specific examples of the cation represented by General Formula (G6) above include Structural Formula (301) to Structural Formula (309) and Structural Formula (401) to Structural Formula (419).

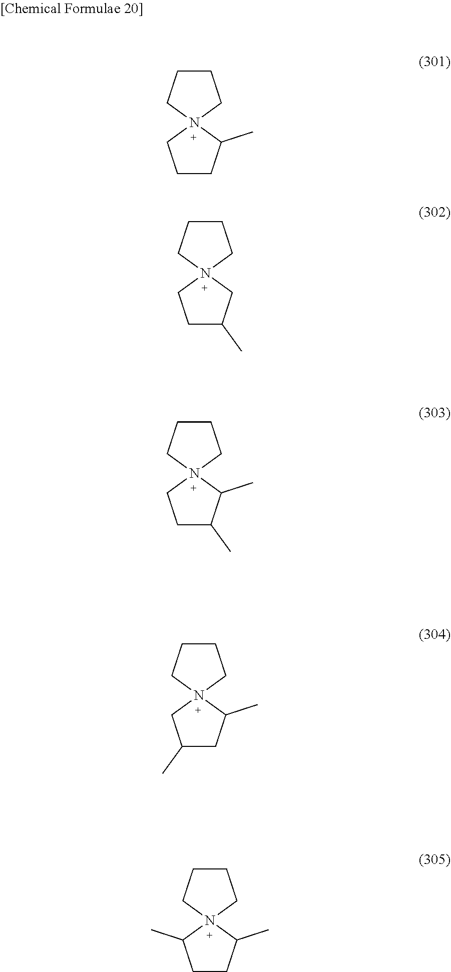

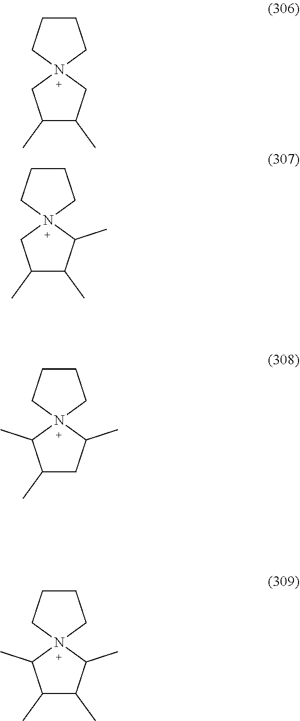

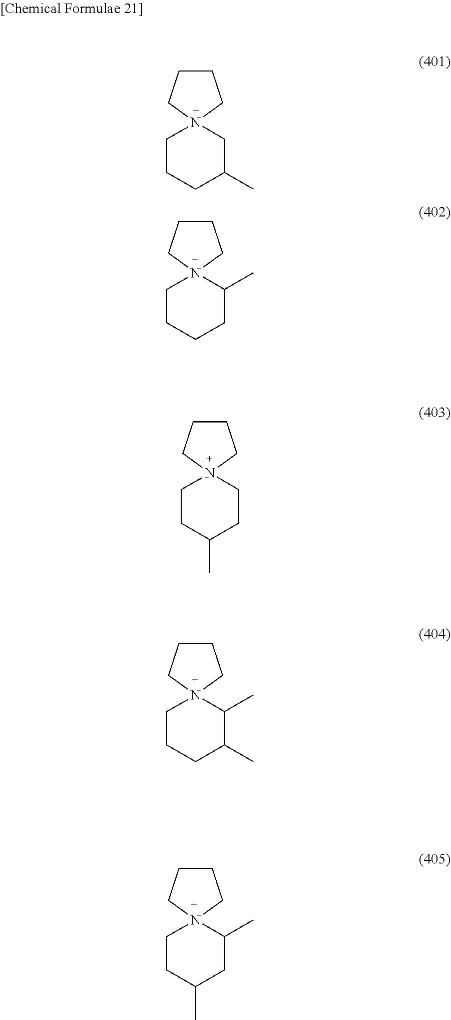

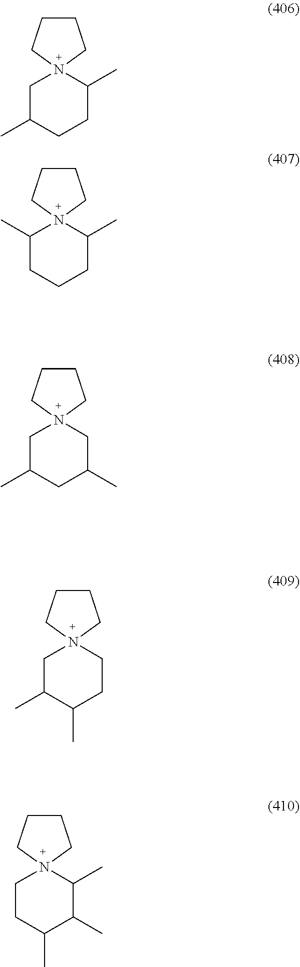

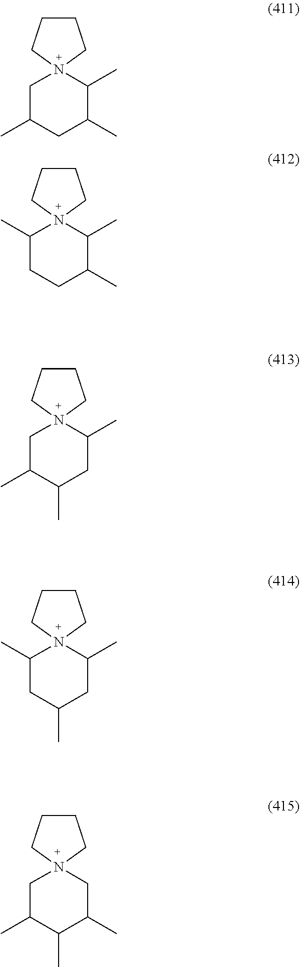

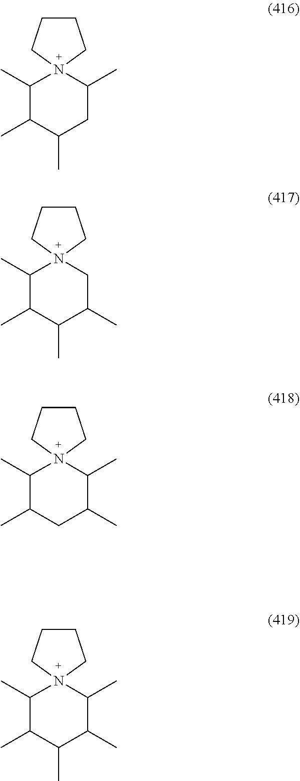

Although Structural Formula (301) to Structural Formula (309) and Structural Formula (401) to Structural Formula (419) each show an example in which m is 1 in General Formula (G6), m may be changed into 2 or 3 in Structural Formula (301) to Structural Formula (309) and Structural Formula (401) to Structural Formula (419).

Specific examples of the cation represented by General Formula (G7) above include Structural Formula (201) to Structural Formula (215).

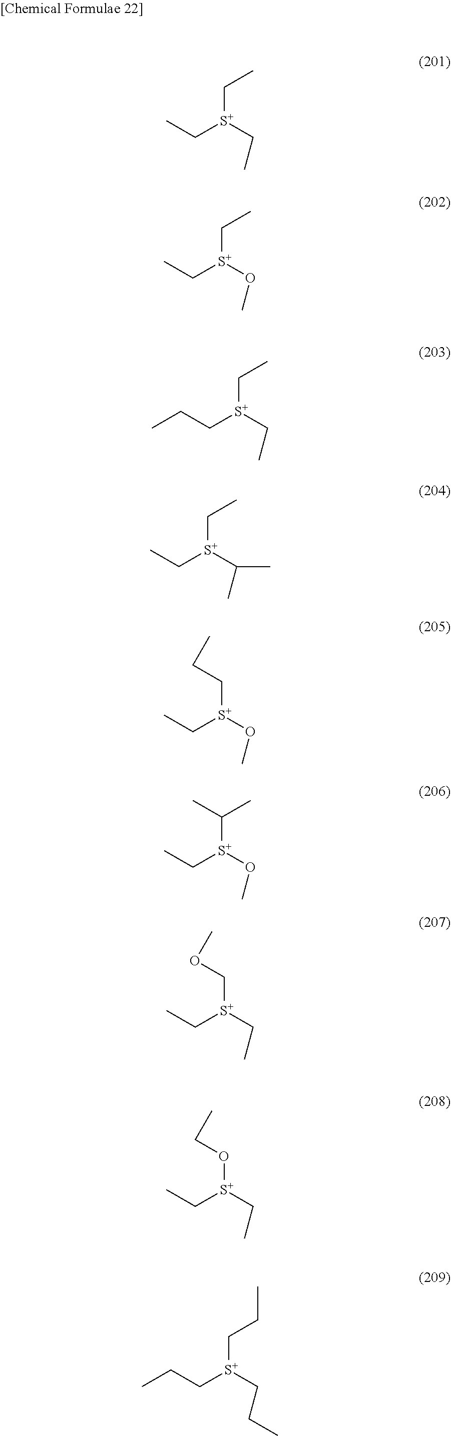

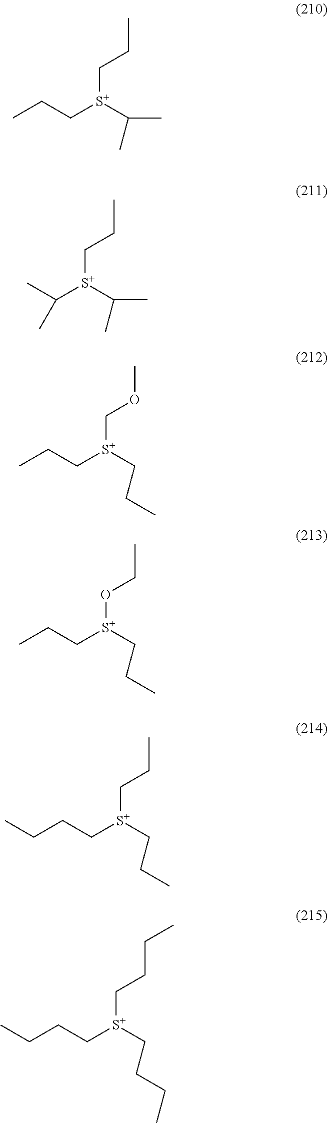

### <Anion>

The anion in the ionic liquid of one embodiment of the present invention is described. As examples of the anion, a halide ion, tetrafluoroborate, hexafluorophosphate, bis(trifluoromethylsulfonyl)amide, and bis(fluorosulfonyl)imide can be given.

Specifically, as the anion, one or more selected from a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, a perfluoroalkylphosphate anion, a tetrafluoroborate anion, and the like can be used.

A monovalent amide-based anion is represented by a general formula (CₙF₂ₙ₊₁SO₂)₂N⁻ (n is greater than or equal to 0 and less than or equal to 3).

When n is 0, the above general formula is a bis(fluorosulfonyl)imide anion, which is represented by Structural Formula (H11) below. A bis(fluorosulfonyl)imide anion is abbreviated as FSI or FSA.

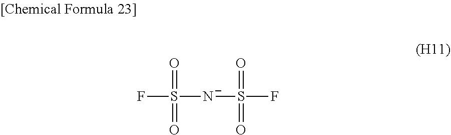

When n is 1, the above general formula is a bis(trifluoromethanesulfonyl)imide anion, which is represented by Structural Formula (H12) below. A bis(trifluoromethanesulfonyl)imide anion is abbreviated as TFSI or TFSA.

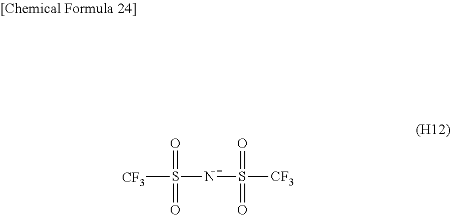

An example of a monovalent cyclic amide-based anion is a 4,4,5,5-tetrafluoro-1,3,2-dithiazolidine tetraoxide anion, which is represented by Structural Formula (H13) below.

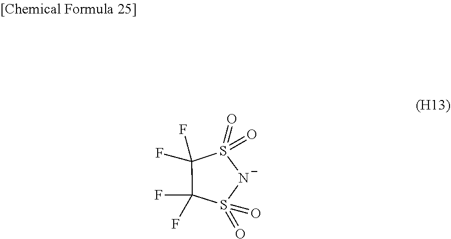 [SMILES: O=S1(=O)[N-]S(=O)(=O)C(F)(F)C1(F)F]

A monovalent methide-based anion is represented by a general formula (CₙF₂ₙ₊₁SO₂)₃C⁻ (n is greater than or equal to 0 and less than or equal to 3).

An example of a monovalent cyclic methide-based anion is a 4,4,5,5-tetrafluoro-2-[(trifluoromethyl)sulfonyl]-1,3-dithiolane tetraoxide anion, which is represented by Structural Formula (H14) below.

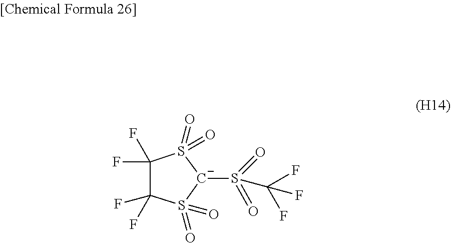 [SMILES: O=S(=O)([C-]1S(=O)(=O)C(F)(F)C(F)(F)S1(=O)=O)C(F)(F)F]

A fluoroalkylsulfonate anion is represented by a general formula (CₘF₂ₘ₊₀SO₃)⁻ (m is greater than or equal to 0 and less than or equal to 4).

When m is 0, the above general formula represents a fluorosulfonate anion; when m is 1, 2, 3, or 4, the above general formula represents a perfluoroalkylsulfonate anion.

A fluoroalkylborate anion is represented by a general formula {BFₙ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m).

A fluoroalkylphosphate anion is represented by a general formula {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m).

The ionic liquid of one embodiment of the present invention can contain one or more selected from the above-described anions.

Such an ionic liquid is a liquid consisting only of ions, thereby having strong electrostatic interaction, nonvolatility, thermal stability, and high heat resistance. A secondary battery including the ionic liquid does not catch fire in its usable temperature range and is highly safe.

### <Organic Solvent>

An organic solvent can be used as a liquid material used for the electrolyte layer or the like of one embodiment of the present invention. A mixed material of an organic solvent and an ionic liquid is preferably used as a liquid material used for the electrolyte layer or the like of one embodiment of the present invention. The organic solvent will be described.

As the organic solvent of one embodiment of the present invention, an aprotic organic solvent may be used. As already described above, for example, one or more selected from ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, sultone, and the like can be used.

Furthermore, the organic solvent may contain a fluorinated carbonate ester, a cyclic carbonate, or the like. Examples of a fluorinated carbonate ester include a fluorinated cyclic carbonate. A fluorinated cyclic carbonate has a high flash point and can enhance the safety of a secondary battery.

As a fluorinated cyclic carbonate, a fluorinated ethylene carbonate such as monofluoroethylene carbonate (fluoroethylene carbonate, FEC, or FlEC), difluoroethylene carbonate (DFEC or F2EC), trifluoroethylene carbonate (F3EC), or tetrafluoroethylene carbonate (F4EC) or the like can be used. Note that DFEC has isomers such as a cis-4,5 isomer and a trans-4,5 isomer.

One of fluorinated cyclic carbonates of embodiments of the present invention is monofluoroethylene carbonate, which is abbreviated as FEC.

One of fluorinated cyclic carbonates of embodiments of the present invention is tetrafluoroethylene carbonate, which is abbreviated as F4EC.

One of fluorinated cyclic carbonates of embodiments of the present invention is difluoroethylene carbonate, which is abbreviated as F2EC.

Although fluorinated cyclic carbonates are described, a cyclic carbonate having a cyano group can also be used for the organic solvent of one embodiment of the present invention.

### <Gelling Agent>

The above-described ionic liquid or organic solvent may be gelled. A gelled ionic liquid or organic solvent can be inhibited from leaking from the electrolyte layer 103. A gelling agent can be selected in accordance with a method of chemical gelation treatment, physical gelation treatment, or the like. A gelling agent used for chemical gelation treatment preferably contains a polymer and a cross-linking agent.

A gelling agent is added to the above-described ionic liquid or organic solvent and mixing is performed. In that case, heating is performed at higher than or equal to 75° C. and lower than or equal to 100° C., preferably higher than or equal to 85° C. and lower than or equal to 95° C. Accordingly, a gelled ionic liquid or a gelled organic solvent can be obtained.

In a specific gelling agent, poly(dimethylamino ethyl methacrylate) can be used as a polymer and N,N,N′,N′-tetra(trifluoromethanesulfonyl)-dodecane-1,12-diamine can be used as a cross-linking agent. The polymer has a cross-linking structure owing to the cross-linking agent and the cross-linking structure holds the ionic liquid or the organic solvent, which leads to a gel state.

### <Lithium Salt>

A lithium salt used for the electrolyte layer or the like of one embodiment of the present invention is preferably a lithium salt containing a halogen. It is further preferable that a fluorine-containing imide lithium salt be used. As the fluorine-containing imide lithium salt, Li(CF₃SO₂)₂N (hereinafter sometimes referred to as “LiTFSI” or “LiTFSA”), Li(C₂F₅SO₂)₂N (hereinafter sometimes referred to as “LiBETI”), LiN(SO₂F)₂N (hereinafter sometimes referred to as “LiFSI” or “LiFSA”), or the like can be used.

As another lithium salt containing a halogen, LiPF₆, LiBF₄, LiClO₄, or the like can be used.

As a lithium salt containing no halogen, LiBOB may be used.

The above-described lithium salts may be used alone or mixed to be used.

### <Exterior Body>

An exterior body included in the secondary battery of one embodiment of the present invention is described. For the exterior body included in the secondary battery, a metal material such as aluminum or a resin material can be used, for example. Examples of a resin material include a rubber material. Rubber is classified into natural rubber and synthetic rubber. Examples of synthetic rubber include a rubber material such as styrene-butadiene rubber (SBR), styrene-isoprene-styrene rubber, acrylonitrile-butadiene rubber, butadiene rubber, and an ethylene-propylene-diene copolymer.

The exterior body included in the secondary battery preferably has a film shape. An exterior body that can have a film shape preferably contains a material such as polyethylene, polypropylene, polycarbonate, ionomer, or polyamide, for example. As the exterior body that can have a film shape, a highly flexible thin metal film of aluminum, stainless steel, copper, nickel, or the like is preferably used.

The exterior body that can have a film shape may have a stacked-layer structure. A first layer preferably contains a material such as polyethylene, polypropylene, polycarbonate, ionomer, or polyamide, and a second layer preferably includes a highly flexible thin metal film of aluminum, stainless steel, copper, nickel, or the like.

In addition, an insulating synthetic resin film of a polyamide-based resin, a polyester-based resin, or the like is preferably provided on the outer surface of the exterior body. The use of the structure of the outer surface on the stacked-layer structure of the first layer and the second layer can provide a film having three-layer structure.

The secondary battery including the electrolyte layer of one embodiment of the present invention is preferable because it can be bent easily. An exterior body including the above-described insulating synthetic resin film is suitable for a curved secondary battery or a secondary battery whose state is changed between a bending state and a stretched state. The ionic liquid is held by the solid electrolyte and thus is inhibited from leaking even in a state where the secondary battery is bent, for example. Furthermore, even when the ionic liquid leaks, the above-described exterior body, especially the exterior body having a stacked-layer structure, can inhibit the ionic liquid from leaking from the secondary battery.

### <Binder>

Although not illustrated in FIG. 1 to FIG. 4, the positive electrode layer 106 and the negative electrode layer 107 may contain a binder. The electrolyte layer 103 may also contain a binder. As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

As the binder, one or more selected from polystyrene, polyvinyl butyral (PVB), poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, and nitrocellulose are preferably used.

Two or more of the above materials may be used in combination for the binder.

### <Conductive Material (Conductive Additive)>

Although not illustrated in FIG. 1 to FIG. 4, the positive electrode layer 106 and the negative electrode layer 107 may contain a conductive additive. As the conductive additive, a carbon material such as acetylene black (AB), carbon nanotubes, or fullerene can be used.

Graphene is flaky and has an excellent electrical characteristic of high conductivity and excellent physical properties of high mechanical strength. Thus, the use of graphene as the conductive additive can increase contact points or the contact area of active materials.

Graphene includes single-layer graphene or multilayer graphene including two to hundred layers. Single-layer graphene refers to a one-atomic-layer thick sheet of carbon molecules having π bonds.

### <Fabrication Process 1>

An example of a fabrication process of the secondary battery 100 illustrated in FIG. 1 to FIG. 4 and the like is described. An ionic liquid containing a lithium salt may be used in the description of the example of the fabrication process. An ionic liquid containing a lithium salt is referred to as a lithium liquid electrolyte solution or a lithium ion electrolyte in some cases.

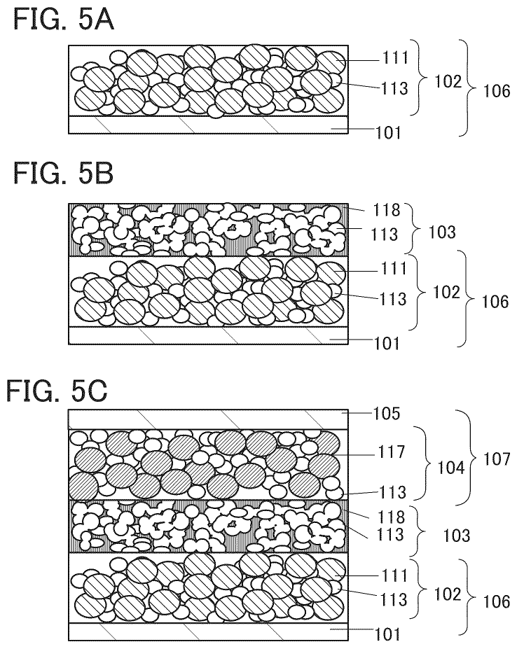

As illustrated in FIG. 5A, the positive electrode layer 106 is prepared. The positive electrode layer 106 is obtained by coating a slurry containing a disperse medium, the positive electrode active material 111, the solid electrolyte 113, and the like onto the positive electrode current collector 101. The disperse medium and the like are removed from the slurry, whereby the positive electrode active material layer 102 is formed. The solid electrolyte 113 becomes particulate when no baking step is performed, and the solid electrolyte 113 forms a sintered body when a baking step is performed, in some cases. In FIG. 5A, the positive electrode layer 106 contains the particulate solid electrolyte 113.

As illustrated in FIG. 5B, the electrolyte layer 103 is prepared. The electrolyte layer 103 contains the solid electrolyte 113 and the ionic liquid 118. The solid electrolyte 113 preferably forms a sintered body through a baking step, in which case the ionic liquid 118 is easily held. Furthermore, the electrolyte layer 103 processed into a sheet-like shape is preferably used. Such an electrolyte layer is referred to as a sheet-like electrolyte layer in some cases. The sheet-like electrolyte layer is positioned over the positive electrode layer 106, and a press step is performed. Note that the press step may be performed after the negative electrode layer 107 described later is positioned over the electrolyte layer 103. In the press step, heat may be applied. Although FIG. 5B illustrates boundaries between layers, a clear boundary cannot be observed in some cases because of the press step.

As illustrated in FIG. 5C, the negative electrode layer 107 is prepared. The negative electrode layer 107 is obtained by coating a slurry containing a disperse medium, the negative electrode active material 117, the solid electrolyte 113, and the like onto the negative electrode current collector 105. The disperse medium and the like are removed from the slurry, whereby the negative electrode active material layer 104 is formed. In FIG. 5C, the negative electrode layer 107 contains the particulate solid electrolyte 113.

The negative electrode layer 107 is positioned over the electrolyte layer 103, and a press step is performed. In the press step, heat may be applied. Although FIG. 5C illustrates boundaries between layers, a clear boundary cannot be observed in some cases because of the press step.

Since the press step described with reference to FIG. 5C can also serve as the press step described with reference to FIG. 5B, the press step described with reference to FIG. 5B can be omitted.

In a secondary battery obtained through this fabrication process, the solid electrolyte 113 holds the ionic liquid 118 in the electrolyte layer 103. In other words, the solid electrolyte 113 is impregnated with the ionic liquid 118 at least in the electrolyte layer 103. Such an electrolyte layer 103 is preferable because the ionic liquid 118 does not leak. The electrolyte layer 103 is referred to as a semi-solid electrolyte layer in some cases. Note that the solid electrolyte 113 can be any solid material and the ionic liquid 118 can be any liquid material as described above.

### <Fabrication Process 2>

An example of the fabrication process of the secondary battery 100 different from Fabrication process 1 will be described.

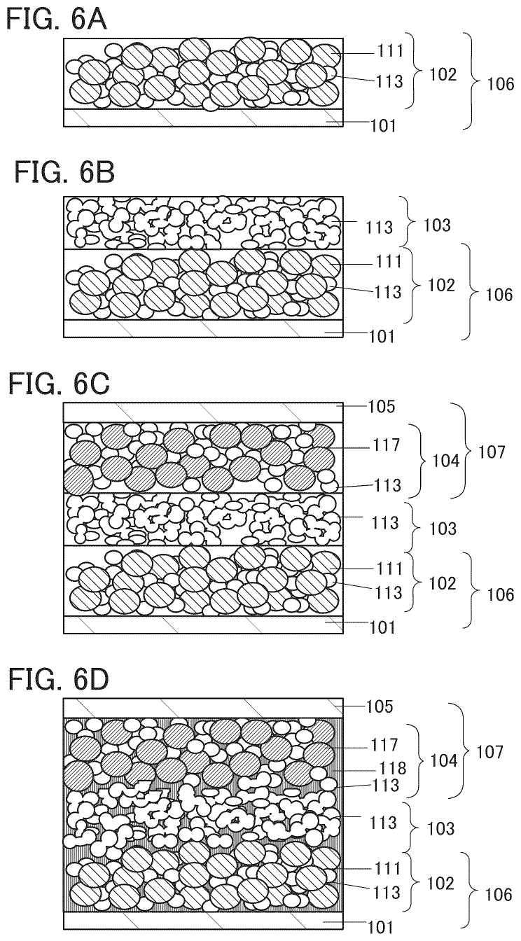

As illustrated in FIG. 6A, the positive electrode layer 106 is prepared. The positive electrode layer 106 is obtained by coating a slurry containing a disperse medium, the positive electrode active material 111, the solid electrolyte 113, and the like onto the positive electrode current collector 101. The disperse medium and the like are removed from the slurry, whereby the positive electrode active material layer 102 is formed. The solid electrolyte 113 becomes particulate when no baking step is performed, and the solid electrolyte 113 forms a sintered body when a baking step is performed, in some cases. In FIG. 6A, the positive electrode layer 106 contains the particulate solid electrolyte 113.

As illustrated in FIG. 6B, the electrolyte layer 103 is prepared. The electrolyte layer 103 at this stage contains the solid electrolyte 113 and is processed into sheet-like shape. The solid electrolyte 113 preferably forms a sintered body through a baking step, in which case the ionic liquid 118 described later is easily held. The sheet-like electrolyte layer is positioned over the positive electrode layer 106, and a press step is performed. Note that the press step may be performed after the negative electrode layer 107 described later is positioned over the electrolyte layer 103. In the press step, heat may be applied. Although FIG. 6B illustrates boundaries between layers, a clear boundary cannot be observed in some cases because of the press step.

As illustrated in FIG. 6C, the negative electrode layer 107 is prepared. The negative electrode layer 107 is obtained by coating a slurry containing a disperse medium, the negative electrode active material 117, the solid electrolyte 113, and the like onto the negative electrode current collector 105. The disperse medium and the like are removed from the slurry, whereby the negative electrode active material layer 104 is formed. In FIG. 6C, the negative electrode layer 107 contains the particulate solid electrolyte 113.

The negative electrode layer 107 is positioned over the electrolyte layer 103, and a press step is performed. In the press step, heat may be applied. Although FIG. 6C illustrates boundaries between layers, a clear boundary cannot be observed in some cases because of the press step.

Since the press step described with reference to FIG. 6C can also serve as the press step described with reference to FIG. 6B, the press step described with reference to FIG. 6B can be omitted.

After that, the ionic liquid 118 is injected as illustrated in FIG. 6D. The ionic liquid 118 is preferably injected in a vacuum or a reduced-pressure atmosphere.

The injected ionic liquid 118 may be subjected to gelation treatment. In the case of using heating as the gelation treatment, heating performed in the above press step is preferably used. In other words, the gelation treatment may be progressed while pressing is performed.

In a secondary battery obtained through this fabrication process, the solid electrolyte 113 holds the ionic liquid 118 in the electrolyte layer 103. In other words, the solid electrolyte 113 is impregnated with the ionic liquid 118 at least in the electrolyte layer 103. Such an electrolyte layer 103 is preferable because the ionic liquid 118 does not leak. The electrolyte layer 103 is referred to as a semi-solid electrolyte layer in some cases. Note that the solid electrolyte 113 can be any solid material and the ionic liquid 118 can be any liquid material as described above.

### <Fabrication Process 3>

An example of the fabrication process of the secondary battery 100 different from Fabrication process 1 and Fabrication process 2 will be described.

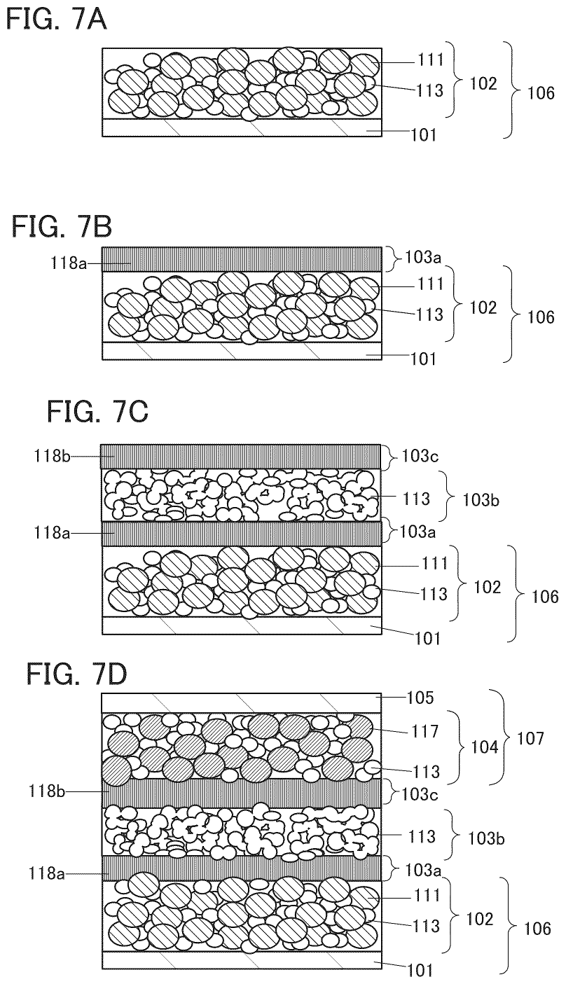

As illustrated in FIG. 7A, the positive electrode layer 106 is prepared. The positive electrode layer 106 is obtained by coating a slurry containing a disperse medium, the positive electrode active material 111, the solid electrolyte 113, and the like onto the positive electrode current collector 101. The disperse medium and the like are removed from the slurry, whereby the positive electrode active material layer 102 is formed. The solid electrolyte 113 becomes particulate when no baking step is performed, and the solid electrolyte 113 forms a sintered body when a baking step is performed, in some cases. In FIG. 7A, the positive electrode layer 106 contains the particulate solid electrolyte 113.

As illustrated in FIG. 7B, the first electrolyte layer 103a is prepared. The first electrolyte layer 103a is a layer containing a gelled ionic liquid 118a, and preferably contains no solid electrolyte. The first electrolyte layer 103a is positioned over the positive electrode layer 106. When the first electrolyte layer 103a is a layer containing a gelled ionic liquid, the first electrolyte layer 103a has adhesiveness in some cases, in which case the press step can be unnecessary. It is needless to say that the press step can be performed. Note that the press step may be performed after layers up to and including the third electrolyte layer 103c described later are stacked or after the negative electrode layer 107 is positioned over the third electrolyte layer 103c. In the press step, heat may be applied. Although FIG. 7B illustrates boundaries between layers, a clear boundary cannot be observed in some cases because of the press step.

As illustrated in FIG. 7C, the second electrolyte layer 103b is prepared. The second electrolyte layer 103b includes the solid electrolyte 113, and is preferably a sheet-like electrolyte layer. When the solid electrolyte 113 forms a sintered body through a baking step, processing into a sheet-like shape becomes easy. A sintered body may be formed by performing a baking step at the time of processing into a sheet-like shape. The sheet-like electrolyte layer is positioned over the first electrolyte layer 103a. When the first electrolyte layer 103a is a layer containing a gelled ionic liquid, the first electrolyte layer 103a has adhesiveness in some cases, in which case the press step can be unnecessary. It is needless to say that the press step can be performed, and heat may be applied in the press step. Although FIG. 7C illustrates boundaries between layers, a clear boundary cannot be observed in some cases because of the press step.

Furthermore, the third electrolyte layer 103c is prepared as illustrated in FIG. 7C. The third electrolyte layer 103c can be similar to the first electrolyte layer 103a, and a layer containing the gelled ionic liquid 118b is preferably used. The third electrolyte layer 103c is positioned over the second electrolyte layer 103b. When the third electrolyte layer 103c is a layer containing a gelled ionic liquid, the third electrolyte layer 103c has adhesiveness in some cases, in which case the press step can be unnecessary. It is needless to say that the press step can be performed, and heat may be applied in the press step. Although FIG. 7C illustrates boundaries between layers, a clear boundary cannot be observed in some cases because of the press step.

As illustrated in FIG. 7D, the negative electrode layer 107 is prepared. The negative electrode layer 107 is obtained by coating a slurry containing a disperse medium, the negative electrode active material 117, the solid electrolyte 113, and the like onto the negative electrode current collector 105. The disperse medium and the like are removed from the slurry, whereby the negative electrode active material layer 104 is formed. In FIG. 7D, the negative electrode layer 107 contains the particulate solid electrolyte 113.

The negative electrode layer 107 is positioned over the third electrolyte layer 103c, and a press step is performed. In the press step, heat may be applied. Although FIG. 7D illustrates boundaries between layers, a clear boundary cannot be observed in some cases because of the press step. In the steps illustrated in FIG. 7D and the like, a space of the solid electrolyte 113 contained in the second electrolyte layer 103b is impregnated with part of the ionic liquid 118a in some cases. Furthermore, a space of the solid electrolyte 113 contained in the second electrolyte layer 103b is impregnated with part of the ionic liquid 118b in some cases.

In a secondary battery obtained through this fabrication process, the solid electrolyte 113 holds the ionic liquid 118a or the ionic liquid 118b in the electrolyte layer 103. In other words, the solid electrolyte 113 is impregnated with the ionic liquid 118a or the ionic liquid 118b at least in the electrolyte layer 103. Such an electrolyte layer 103 is preferable because the ionic liquid 118a or the ionic liquid 118b does not leak. The electrolyte layer 103 is referred to as a semi-solid electrolyte layer in some cases. Note that the solid electrolyte 113 can be any solid material and the ionic liquid 118a or the ionic liquid 118b can be any liquid material as described above.

### <Fabrication Process 4>

An example of the fabrication process of the secondary battery 100 different from Fabrication process 1 to Fabrication process 3 will be described.

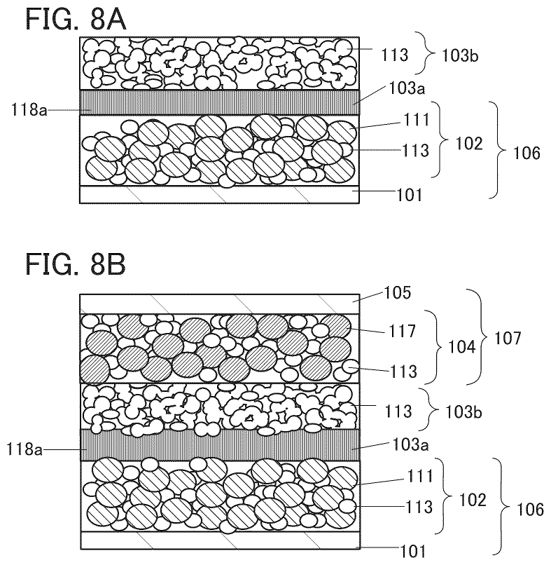

As illustrated in FIG. 8A, a stack of layers up to and including the second electrolyte layer 103b is prepared according to the above Fabrication process 3 of the secondary battery.

As illustrated in FIG. 8B, the negative electrode layer 107 is prepared. The negative electrode layer 107 is obtained by coating a slurry containing a disperse medium, the negative electrode active material 117, the solid electrolyte 113, and the like onto the negative electrode current collector 105. The disperse medium and the like are removed from the slurry, whereby the negative electrode active material layer 104 is formed. In FIG. 8B, the negative electrode layer 107 contains the particulate solid electrolyte 113.

The negative electrode layer 107 is positioned over the second electrolyte layer 103b, and a press step is performed. In the press step, heat may be applied. Although FIG. 8B illustrates boundaries between layers, a clear boundary cannot be observed in some cases because of the press step. In the steps illustrated in FIG. 8B and the like, a space of the solid electrolyte 113 contained in the second electrolyte layer 103b can be impregnated with part of the ionic liquid 118a.

In a secondary battery obtained through this fabrication process, the solid electrolyte 113 holds part of the ionic liquid 118a in the second electrolyte layer 103b. In other words, the solid electrolyte 113 is impregnated with part of the ionic liquid 118a at least in the electrolyte layer 103. Such an electrolyte layer 103 is preferable because the ionic liquid 118a does not leak. The electrolyte layer 103 is referred to as a semi-solid electrolyte layer in some cases. Note that the solid electrolyte 113 can be any solid material and the ionic liquid 118 can be any liquid material as described above.

### <Fabrication Process 5>

An example of the fabrication process of the secondary battery 100 different from Fabrication process 1 to Fabrication process 4 will be described.

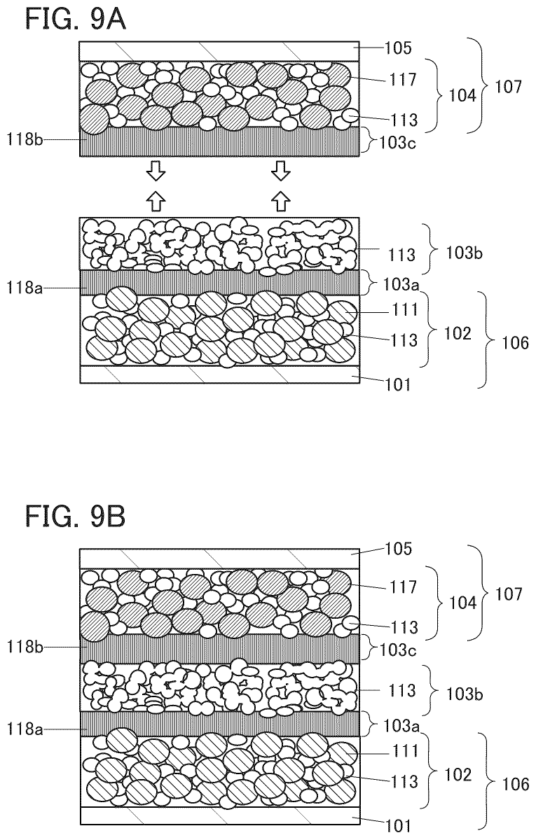

As illustrated in FIG. 9A, a structure A in which layers up to and including the second electrolyte layer 103b are stacked is prepared according to the above Fabrication process 3 of the secondary battery. Furthermore, as illustrated in FIG. 9A, a structure B in which the negative electrode layer 107 and the third electrolyte layer 103c are stacked is prepared. Then, the structure A and the structure B are bonded to each other as indicated by blank arrows.

After the bonding, a press step is performed as illustrated in FIG. 9B. In the press step, heat may be applied. Although FIG. 9B illustrates boundaries between layers, a clear boundary cannot be observed in some cases because of the press step. In the steps illustrated in FIG. 9B and the like, a space of the solid electrolyte 113 contained in the first electrolyte layer 103a can be impregnated with part of the ionic liquid 118a or part of the ionic liquid 118b in some cases.

In a secondary battery obtained through this fabrication process, the solid electrolyte 113 holds part of the ionic liquid 118a and part of the ionic liquid 118b in the electrolyte layer 103. In other words, the solid electrolyte 113 is impregnated with part of the ionic liquid 118a and part of the ionic liquid 118b at least in the electrolyte layer 103. Such an electrolyte layer 103 is preferable because the ionic liquid 118a or the ionic liquid 118b does not leak. The electrolyte layer 103 is referred to as a semi-solid electrolyte layer in some cases. Note that the solid electrolyte 113 can be any solid material and the ionic liquid 118a or the ionic liquid 118b can be any liquid material as described above.

This embodiment can be used in combination with the other embodiments.

### Embodiment 2

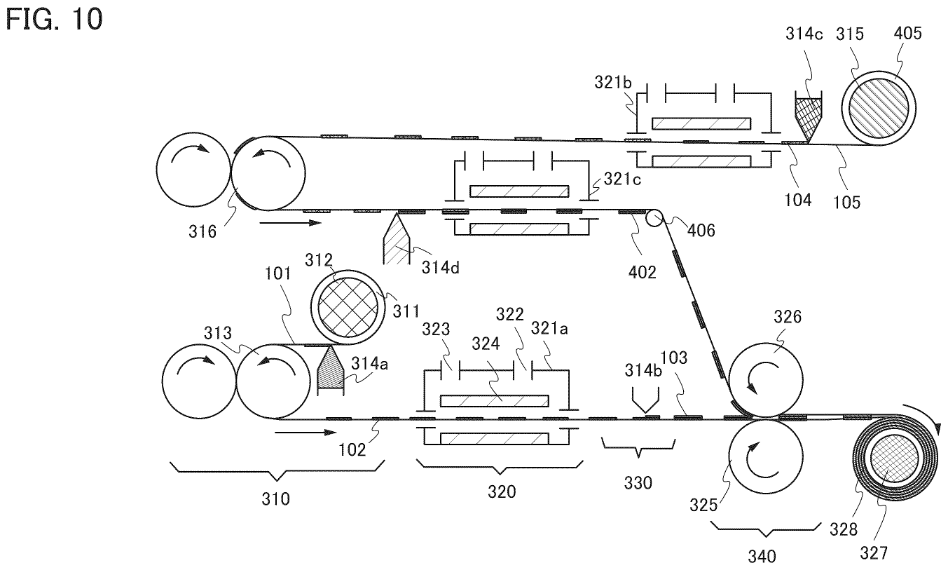

It is desirable to successively perform the above described fabrication steps by using a roll-to-roll fabrication apparatus or the like. A roll-to-roll method can be applied to the above-described Fabrication processes 1 to 5; in this embodiment, the fabrication process described in Fabrication process 5 using a fabrication apparatus illustrated in FIG. 10 will be described.

With the use of the fabrication apparatus illustrated in FIG. 10, at least a step 310 of applying a slurry to the positive electrode current collector 101, a step 320 of drying the slurry to form the positive electrode active material layer 102, a step 330 of stacking the electrolyte layer 103 over the positive electrode active material layer 102, and a step 340 of passing the positive electrode current collector 101 over which the positive electrode active material layer 102 is formed between a pair of pressure rollers (a first pressure roller 325 and a second pressure roller 326) with the electrolyte layer 103 can be performed.

The step 310 is described. As illustrated in FIG. 10, the fabrication apparatus includes a delivering mechanism 311 (also referred to as an unwinder), and the delivering mechanism 311 is provided with a first bobbin 312 around which the positive electrode current collector 101 is wound. The positive electrode current collector 101 is transferred by using rotation of rollers 313, and a slurry is applied to one surface of the positive electrode current collector 101 by a first slurry attaching means 314a. The slurry contains at least a dispersant, a positive electrode active material, and a solid electrolyte. The rollers 313 form a pair, and the positive electrode current collector 101 can be pressed while passing between the rollers.

As the first slurry attaching means 314a, a slot die coater, a lip coater, a blade coater, a reverse coater, a gravure coater, or the like can be used, for example. The number of rollers used to reverse the positive electrode current collector 101 may be increased depending on the type of the coater. The first slurry attaching means 314a can employ a dipping method, a spraying method, or the like. Depending on a material used, the slurry is applied while the first slurry attaching means 314a is heated. The slurry is preferably applied while being heated.

In the step 320, the slurry applied to the positive electrode current collector 101 is dried in a heating chamber 321a having an inlet 322, an outlet 323, and a drying means 324. By drying the slurry, the positive electrode active material layer 102 can be formed over the positive electrode current collector 101. The inlet 322 and the outlet 323 are preferably provided on a ceiling (also referred to as a top surface) of the heating chamber 321a; however, they may be provided on a wall (also referred to as a side surface) or a floor (also referred to as a bottom surface) of the heating chamber 321a. For the drying means 324, one method or a combination of two or more methods selected from hot-air heating, lamp heating, induction heating, air blowing, and the like can be employed.

The step 320 is an example in which natural cooling is performed after the slurry is dried and no cooling means is provided; however, a cooling means may be provided in or in the vicinity of the heating chamber 321a to forcibly perform cooling.

In the step 330, the first electrolyte layer 103a and the second electrolyte layer 103b are formed over the positive electrode active material layer 102 by using a second slurry attaching means 314b. The first electrolyte layer 103a and the second electrolyte layer 103b are preferably prepared as a stack and then formed over the positive electrode active material layer 102. Alternatively, a plurality of attaching means each corresponding to the second slurry attaching means 314b may be provided to form the first electrolyte layer 103a and the second electrolyte layer 103b in this order over the positive electrode active material layer 102.

The negative electrode current collector 105 is processed in parallel with the processing of the positive electrode current collector 101. A delivering mechanism 315 is provided with a second bobbin 405 around which the negative electrode current collector 105 is wound, and a slurry is applied to one surface of the negative electrode current collector 105 by a third slurry attaching means 314c and by using rotation of rollers 316. The slurry contains at least a disperse medium, a negative electrode active material, and a solid electrolyte. The rollers 316 form a pair, and the negative electrode current collector 105 can be pressed while passing between the rollers.

As the third slurry attaching means 314c, a slot die coater, a lip coater, a blade coater, a reverse coater, a gravure coater, or the like can be used, for example. The number of rollers used to reverse the negative electrode current collector 105 may be increased depending on the type of the coater. The third slurry attaching means 314c can employ a dipping method, a spraying method, or the like. Depending on a material used, the slurry is applied while the third slurry attaching means 314c is heated. The slurry is preferably applied while being heated.

Next, the slurry applied to the negative electrode current collector 105 is dried in a heating chamber 321b. The heating chamber 321b has a structure similar to that of the heating chamber 321a. By drying the slurry, the negative electrode active material layer 104 can be formed over the negative electrode current collector 105. Natural cooling may be performed after the slurry is dried, or cooling may be performed forcibly by providing a cooling means in or in the vicinity of the heating chamber 321b.

Next, a slurry is applied to the negative electrode active material layer 104 by a fourth slurry attaching means 314d and the negative electrode current collector 105 passes through a heating chamber 321c, whereby the third electrolyte layer 103c is formed. After the negative electrode current collector 105 passes through a roller 406, the process goes to the step 340. The heating chamber 321c has a structure similar to that of the heating chamber 321a.

As the fourth slurry attaching means 314d, a slot die coater, a lip coater, a blade coater, a reverse coater, a gravure coater, or the like can be used, for example. The number of rollers used to reverse the negative electrode current collector 105 may be increased depending on the type of the coater. The fourth slurry attaching means 314d can employ a dipping method, a spraying method, or the like. Depending on a material used, the slurry is applied while the fourth slurry attaching means 314d is heated. The slurry is preferably applied while being heated.

In the step 340, the positive electrode current collector 101 and the negative electrode current collector 105 are stacked by using rotation of the pair of pressure rollers (the first pressure roller 325 and the second pressure roller 326), and pressing is performed. Heating may be performed at the time of the pressing. Through this step, an ionic liquid or the like contained in the electrolyte layer is melted (solated) temporarily in some cases. The melted ionic liquid or the like can penetrate into the adjacent positive electrode layer or negative electrode layer.

Lastly, the stack is wound around a second bobbin 328 provided for a winding-up mechanism 327 (also referred to as a winder). Then, cutting into a desired shape is performed by non-illustrated laser cutting or a non-illustrated cutting means such as a cutter.

Although FIG. 10 illustrates an example in which the stack is wound, the stack may be cut into a desired shape by non-illustrated laser cutting or a non-illustrated cutting means such as a cutter without being wound.

Through the above steps, a secondary battery can be fabricated.

This embodiment can be implemented in appropriate combination with the other embodiments.

### Embodiment 3

In this embodiment, steps of processing the electrolyte layer of one embodiment of the present invention into a sheet-like shape are described. An electrolyte layer processed into a sheet-like shape is preferable because of its handling ease, leading to an improvement in productivity.

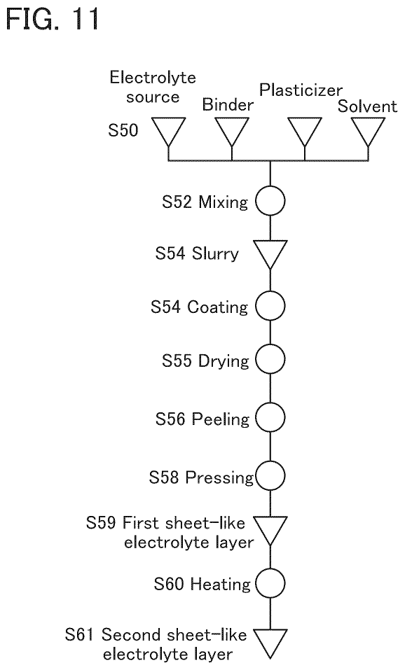

As shown in Step S50 in FIG. 11, an electrolyte source, a binder, a plasticizer, and a solvent are prepared. As the electrolyte source, LLZAO powder is prepared. As the binder, polyvinyl butyral (PVB) is prepared. As the plasticizer, dioctyl phthalate (DOP) is prepared. As the solvent, N-methyl-2-pyrrolidone (NMP) is prepared.

Other than PVB, the above-described material such as polyvinyl alcohol (PVA), or an acrylic resin may be used as the binder. Other than DOP, phthalate ester can be used as the plasticizer, and one or more selected from dimethyl phthalate (DMP), diethyl phthalate (DEP), dibutyl phthalate (DBP), and the like is preferably used, for example. Other than NMP, one or more selected from water, dimethylformamide (DMF), and the like may be used as the solvent.

The above materials are mixed as shown in Step S52 in FIG. 11, and a slurry is obtained as shown in Step S54. The materials shown in Step S50 may be independently mixed before the mixing in Step S52. The mixing in Step S52 can be performed by a planetary centrifugal mixer, for example. The rotational speed can be greater than or equal to 1000 rpm and less than or equal to 3000 rpm. The rotation time can be longer than or equal to one minute and shorter than or equal to ten minutes. The mixing using the mixer may be performed not once but more than twice.

As shown in Step S54 in FIG. 11, a base for coating is coated with the slurry. For the base for coating, a material from which a sheet-like electrolyte layer is easily peeled, for example, a silicone base is preferably used. A mold release agent or the like may be applied to the surface of the base for coating for easy peeling.

As shown in Step S55 in FIG. 11, the slurry is dried using a drying furnace or the like. The drying is performed at a temperature higher than or equal to 25° C. and lower than or equal to 200° C., preferably higher than or equal to 45° C. and lower than or equal to 85° C. A solvent or the like contained in the slurry is removed by the drying.

As shown in Step S56 in FIG. 11, the electrolyte layer sheet is peeled from the base for coating. The peeling in Step S56 may be referred to as separation of the electrolyte layer sheet from the base for coating. Note that it is preferable that the electrolyte layer not being pressed, that is, the electrolyte layer before pressing be peeled from the substrate for coating. The electrolyte layer not being pressed is referred to as a non-pressed electrolyte layer in some cases.

As shown in Step S58 in FIG. 11, pressing is performed after the drying. A roll press machine can be used for the pressing. A gap of the roll press machine is set to greater than or equal to 50% and less than or equal to 70% of the thickness of the non-pressed electrolyte layer, for example. In the case where the thickness of the non-pressed electrolyte layer is 140 μm, for example, the gap of the roll press machine is set to greater than or equal to 60 μm less than or equal to 100 μm, preferably greater than or equal to 70 μm and less than or equal to 85 μm.

As shown in Step S59 in FIG. 11, a first sheet-like electrolyte layer can be obtained. The first sheet-like electrolyte layer preferably has a thickness greater than or equal to 100 μm and less than or equal to 150 μm, further preferably greater than or equal to 120 μm and less than or equal to 140 μm. A space can be observed in the first sheet-like electrolyte layer in a SEM (scanning electron microscope) observation image or the like. Furthermore, a state in which particles of the LLZAO powder, which is a solid electrolyte, are connected to each other through the binder in the first sheet-like electrolyte layer can be observed in the SEM observation image or the like.

As shown in Step S60 in FIG. 11, the first sheet-like electrolyte layer is heated. The heating temperature is higher than or equal to 1000° C. and lower than or equal to 1300° C., preferably higher than or equal to 1100° C. and lower than or equal to 1250° C. Although the heating atmosphere is preferably an oxygen-containing atmosphere, an atmosphere containing oxygen and an inert gas or an atmosphere containing an inert gas may be used.

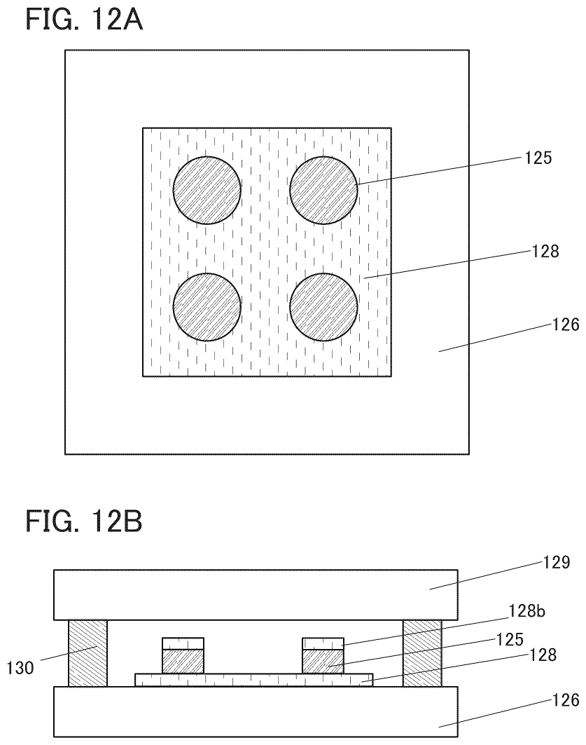

FIG. 12A and FIG. 12B illustrate the state of the first sheet-like electrolyte layer at the time of the heating. A first sheet-like electrolyte layer 125 is heated in a state of being stamped out in a circular shape. In FIG. 12A, which is a top surface schematic diagram, the first sheet-like electrolyte layer 125 is placed over an alumina substrate 126. A region 128 where the LLZAO powder is dispersed exists between the alumina substrate 126 and the first sheet-like electrolyte layer 125. The LLZAO powder is preferably dispersed to inhibit adhesion of the alumina substrate 126 to the first sheet-like electrolyte layer 125.

FIG. 12B is a schematic cross-sectional view, and the region 128 where the LLZAO powder is dispersed can be found between the alumina substrate 126 and the first sheet-like electrolyte layer 125. A substrate 129 that faces the alumina substrate 126 is placed like a lid with the use of a gap holding material 130. The substrate 129 is also preferably an alumina substrate. The LLZAO powder is preferably dispersed also over the top surface of the first sheet-like electrolyte layer 125, and the dispersion region is a region 128b.

As shown in Step S61 in FIG. 11, a second sheet-like electrolyte layer is obtained. Since the second sheet-like electrolyte layer is obtained through the heating step, its size shrinks as compared to the first sheet-like electrolyte layer in some cases. In the case where the first sheet-like electrolyte layer is stamped out into a circular shape with a diameter of 12 μmm, for example, the second sheet-like electrolyte layer shrinks to a circular shape with a diameter of 10 mm. The second sheet-like electrolyte layer preferably has a thickness greater than or equal to 80 μm and less than or equal to 120 μm, further preferably greater than or equal to 90 μm and less than or equal to 110 μm; the thickness is smaller than that of the first sheet-like electrolyte layer.

A state in which LLZAO, which is the solid electrolyte, forms a sintered body can be observed by SEM observation or the like of the second sheet-like electrolyte layer, and a space is observed in the second sheet-like electrolyte layer. Note that no binder is observed in the second sheet-like electrolyte layer in the SEM observation image or the like in some cases. The binder or the like is probably removed by the heating in Step S60, for example.

The second sheet-like electrolyte layer obtained in this manner can be used for the solid material of the electrolyte layer 103 described in the above embodiment or the like.

This embodiment can be used in combination with the other embodiments.

### Embodiment 4

In this embodiment, a positive electrode active material that can be used for the secondary battery of one embodiment of the present invention and a formation method thereof will be described.

### [Positive Electrode Active Material]

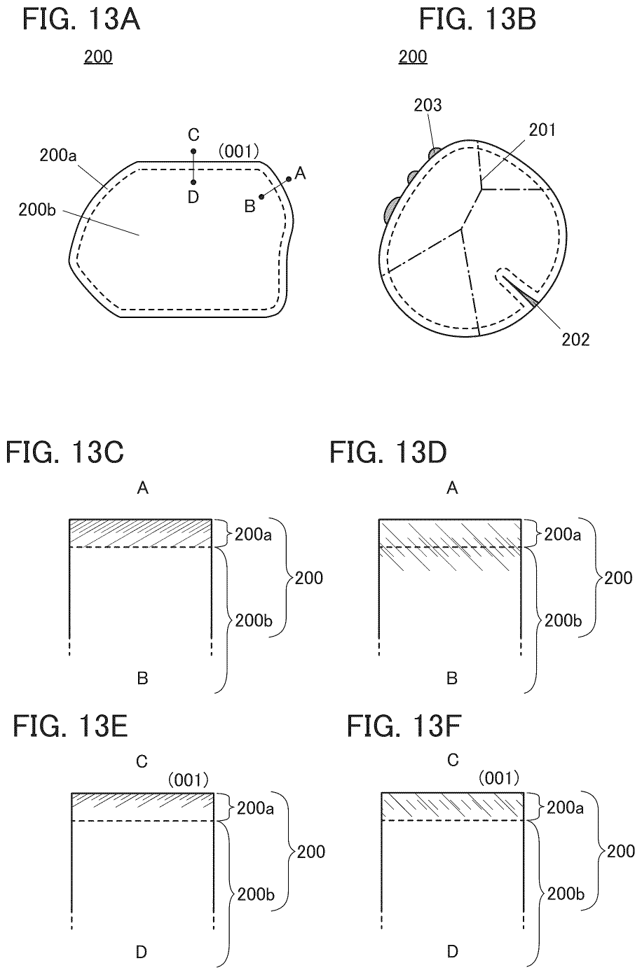

FIG. 13A and FIG. 13B are each a cross-sectional view of a positive electrode active material 200 that can be used for the secondary battery of one embodiment of the present invention. FIG. 13C and FIG. 13D show enlarged views of a portion near the line A-B in FIG. 13A. FIG. 13E and FIG. 13F show enlarged views of a portion near the line C-D in FIG. 13A.

As illustrated in FIG. 13A to FIG. 13F, the positive electrode active material 200 includes a surface portion 200a and an inner portion 200b. In each drawing, the dashed line denotes a boundary between the surface portion 200a and the inner portion 200b. In FIG. 13B, the dashed-dotted line denotes part of a crystal grain boundary 201.

In this specification and the like, the surface portion 200a of the positive electrode active material 200 refers to, for example, a region that is within 50 nm, preferably within 35 nm, further preferably within 20 nm, and most preferably within 10 nm in depth from the surface toward the inner portion. A plane generated by a split and/or a crack may also be referred to as a surface. The surface portion 200a is synonymous with the vicinity of a surface, a region in the vicinity of a surface, or a shell.

A region in a deeper position than the surface portion 200a of the positive electrode active material is referred to as the inner portion 200b. The inner portion 200b is synonymous with an inner region or a core.

The surface of the positive electrode active material 200 refers to the surface of a composite oxide including the surface portion 200a, the inner portion 200b, a projection 203, and the like. The positive electrode active material 200 does not contain a carbonic acid, a hydroxy group, or the like which is chemically adsorbed after formation of the positive electrode active material 200. Furthermore, an electrolyte, a binder, a conductive material, and a compound originating from any of these that are attached to the positive electrode active material 200 are not contained in the positive electrode active material 200 either. The surface of the positive electrode active material 200 in a cross-sectional STEM (scanning transmission electron microscopy) image or the like is a boundary between a region where a combined image of an electron beam is observed and a region where the image is not observed, and is determined as the outermost surface of a region where a bright spot derived from an atomic nucleus of a metal element that has a larger atomic number than lithium. The surface of the surface of the positive electrode active material 200 in a cross-sectional STEM image or the like may be determined by additionally using the results of an analysis with higher spatial resolution, for example, an analysis such as electron energy loss spectroscopy (EELS).

The crystal grain boundary 201 refers to, for example, a portion where the positive electrode active materials 200 adhere to each other, a portion where a crystal orientation changes inside the positive electrode active material 200, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure including another element between lattices, a cavity, or the like. The crystal grain boundary 201 can be regarded as one of plane defects. The vicinity of the crystal grain boundary 201 refers to a region positioned within 10 nm from the crystal grain boundary 201.

### <Contained Element>

The positive electrode active material 200 contains lithium, a transition metal M, oxygen, and an additive element A. Alternatively, the positive electrode active material 200 contains a composite oxide containing lithium and the transition metal M (LiMO₂) into which the additive element A is added. Note that the composition of the composite oxide is not strictly limited to Li:M:O=1:1:2. In some cases, a positive electrode active material to which the additive element A is added is referred to as a composite oxide.

In order to maintain a neutrally charged state even when lithium ions are inserted and extracted, a positive electrode active material of a lithium-ion secondary battery needs to contain a transition metal which can take part in an oxidation-reduction reaction. It is preferable that the positive electrode active material 200 of one embodiment of the present invention mainly contain cobalt as the transition metal M taking part in an oxidation-reduction reaction. In addition to cobalt, one or two or more selected from nickel and manganese may be contained. When cobalt is used as the transition metal M contained in the positive electrode active material 200 at greater than or equal to 75 atomic %, preferably greater than or equal to 90 atomic %, further preferably greater than or equal to 95 atomic %, many advantages such as relatively easy synthesis, easy handling, and excellent cycle performance are gained, which is preferable.

When cobalt is used as the transition metal M contained in the positive electrode active material 200 at greater than or equal to 75 atomic %, preferably greater than or equal to 90 atomic %, further preferably greater than or equal to 95 atomic %, LiₓCoO₂ with small x is more stable than a composite oxide in which nickel accounts for the majority of the transition metal M, such as lithium nickel oxide (LiNiO₂). This is probably because cobalt is less affected by distortion due to the Jahn-Teller effect than nickel. The Jahn-Teller effect in a transition metal compound varies in degree according to the number of electrons in the d orbital of the transition metal. The influence of the Jahn-Teller effect is large in a layered rock-salt composite oxide, such as lithium nickel oxide, in which octahedral coordinated low-spin nickel (III) accounts for the majority, and a layer having an octahedral structure formed of nickel and oxygen is likely to be distorted. Thus, a concern that the crystal structure might break in charge and discharge cycles grows. A nickel ion has a larger ion radius than a cobalt ion and has a size close to that of a lithium ion. Thus, there is a problem in that cation mixing between nickel and lithium is likely to occur in a layered rock-salt composite oxide in which nickel accounts for the majority, such as lithium nickel oxide.

Using nickel at greater than or equal to 33 at %, preferably greater than or equal to 60 at %, further preferably greater than or equal to 80 at % as the transition metal M contained in the positive electrode active material 200 is preferable because in that case, the cost of the raw materials might be lower than that in the case of using a large amount of cobalt and discharge capacity per weight might be increased.

As the additive element A contained in the positive electrode active material 200, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium are preferably used. The additive element A is preferably at less than 25 atomic %, further preferably less than 10 atomic %, still further preferably less than 5 atomic % of the transition metal (or the total when two or more transition metals are contained).

That is, the positive electrode active material 200 can contain lithium cobalt oxide to which magnesium and fluorine are added; lithium cobalt oxide to which magnesium, fluorine, and titanium are added; lithium cobalt oxide to which magnesium, fluorine, and aluminum are added; lithium cobalt oxide to which magnesium, fluorine, and nickel are added; lithium cobalt oxide to which magnesium, fluorine, nickel, and aluminum are added; or the like.

Such additive elements A further stabilize the crystal structure of the positive electrode active material 200 as described later. Although the additive element A is one of raw materials of the positive electrode active material, it is referred to as an additive element in this specification and the like because its concentration is smaller than that of the main component.

Note that as the added element A, magnesium, fluorine, nickel, aluminum, titanium, zirconium, vanadium, iron, manganese, chromium, niobium, arsenic, zinc, silicon, sulfur, phosphorus boron, bromine, or beryllium is not necessarily contained.

When the positive electrode active material 200 is substantially free from manganese, for example, the above advantages such as relatively easy synthesis, easy handling, and excellent cycle performance are enhanced. The weight of manganese contained in the positive electrode active material 200 is preferably less than or equal to 600 ppm, further preferably less than or equal to 100 ppm, for example. The weight of manganese can be analyzed by GD-MS (glow discharge mass spectrometry), for example.

### <Crystal Structure>

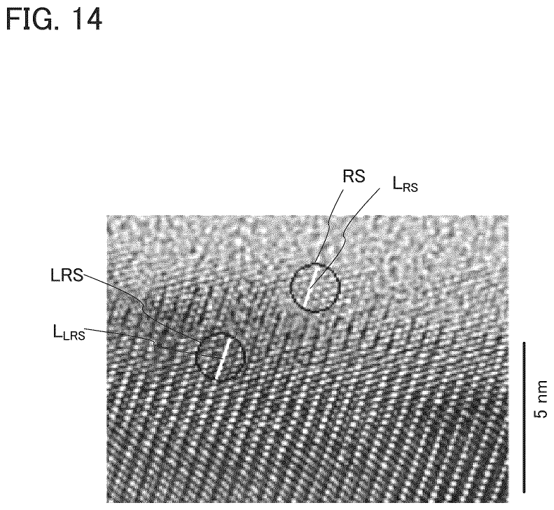

A conventional positive electrode active material and the positive electrode active material 200 of one embodiment of the present invention are compared, and changes in the crystal structures due to x in LiₓCoO₂ will be described with reference to FIG. 14 to FIG. 20. The value of x indicates the remaining amount of lithium that can be inserted and extracted in lithium cobalt oxide, and can be regarded as the lithium occupancy in LiₓCoO₂. Note that Co is an example of a transition metal, and cobalt and a cobalt site can be rephrased as the transition metal M and a transition metal M site, respectively, as needed.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal Mare regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal structure is distorted in some cases.

A rock-salt crystal structure refers to a structure in which a cubic crystal structure with the space group Fm-3m or the like is included and cations and anions are alternately arranged. Note that a cation or anion vacancy may exist.

Having features of both a layered rock-salt crystal structure and a rock-salt crystal structure can be judged by electron beam diffraction, a TEM image, a cross-sectional STEM image, and the like.

Although there is no distinction among cation sites in a rock-salt crystal structure, a layered rock-salt crystal structure has two types of cation sites: one is mostly occupied by lithium, and the other is occupied by the transition metal M. A stacked-layer structure where two-dimensional planes of cations and two-dimensional planes of anions are alternately arranged is the same in a rock-salt crystal structure and a layered rock-salt crystal structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt crystal structure, for instance, and on the (003) plane in a layered rock-salt crystal structure, for instance. For example, when electron diffraction patterns of MgO having a rock-salt crystal structure and LiCoO₂ having a layered rock-salt crystal structure are compared with each other, the bright spots on the (003) plane of LiCoO₂ are observed at a distance approximately half the distance between the bright spots on the (111) plane of MgO. Thus, when two phases of MgO having a rock-salt crystal structure and LiCoO₂ having a layered rock-salt crystal structure are included in a region to be analyzed, for example, a crystal plane in which bright spots with high luminance and bright spots with low luminance are alternately arranged exists in an electron diffraction pattern. A bright spot common between the rock-salt crystal structure and the layered rock-salt crystal structure has high luminance, whereas a bright spot caused only in the layered rock-salt crystal structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like; the layers observed with low luminance correspond to lithium layers and a metal that has a lager atomic number than lithium exists in part of the lithium layers.

Anions of a layered rock-salt crystal structure and anions of a rock-salt crystal structure form a cubic close-packed structure (face-centered cubic lattice structure). Anions of an O3′ type crystal structure described later are presumed to form a cubic close-packed structure. Thus, when a layered rock-salt crystal structure and a rock-salt crystal structure are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that the space groups of the layered rock-salt crystal structure and the O3′ type crystal structure described later are R-3m, which is different from the space groups Fm-3m (the space group Fm-3m is a space group of a general rock-salt crystal structure) of rock-salt crystal structures; thus, the Miller index of the crystal plane satisfying the above conditions in the layered rock-salt crystal structure and the O3′ type crystal structure is different from that in the rock-salt crystal structure. In this specification, a state where the orientations of the cubic close-packed structures composed of anions in the layered rock-salt crystal structure, the O3′ type crystal structure, and the rock-salt crystal structure are aligned is sometimes referred to as a state where crystal orientations are substantially aligned.

Note that the orientations of crystals in two regions being substantially aligned with each other can be judged, for example, from a TEM image, a STEM (scanning transmission electron microscope) image, a HAADF-STEM (high-angle annular dark-field scanning TEM) image, an ABF-STEM (annular bright-field scanning transmission electron microscope) image, an electron diffraction pattern, or an FFT pattern of a TEM image, a STEM image, or the like. XRD, electron diffraction, neutron diffraction, and the like can also be used for judging.

FIG. 14 shows an example of a TEM image in which orientations of a layered rock-salt crystal structure LRS denoted by a circle and a rock-salt crystal structure RS denoted by a circle are substantially aligned with each other. In such a TEM image and a STEM image, a HAADF-STEM image, an ABF-STEM image, and the like, an image reflecting a crystal structure is obtained.

For example, in a high-resolution TEM image, a contrast derived from a crystal plane is obtained. When an electron beam is incident in the direction perpendicular to the c-axis of a composite hexagonal lattice of a layered rock-salt crystal structure, for example, a contrast derived from the (0003) plane is obtained as repetition of bright bands (bright strips or bright lines) and dark bands (dark strips or dark lines) because of diffraction and interference of the electron beam. Thus, when repetition of bright lines and dark lines is observed and the angle between the bright lines (e.g., L_{RS} and L_{LRS} shown in FIG. 14) is less than or equal to 5° or less than or equal to 2.5° in the TEM image, it can be judged that the crystal planes are substantially aligned with each other, that is, the crystal orientations of are substantially aligned with each other. Similarly, when the angle between the dark lines is less than or equal to 5° or less than or equal to 2.5°, it can be judged that the crystal orientations are substantially aligned with each other.

In a HAADF-STEM image, a contrast proportional to the atomic number is obtained, and an element having a larger atomic number is observed to be brighter. For example, in the case of lithium cobalt oxide that has a layered rock-salt structure belonging to the space group R-3m, cobalt (atomic number: 27) has the largest atomic number; hence, an electron beam is strongly scattered at the position of a cobalt atom, and arrangement of the cobalt atoms is observed as bright lines or arrangement of high-luminance dots. Thus, when the lithium cobalt oxide having a layered rock-salt crystal structure is observed perpendicularly to the c-axis, arrangement of the cobalt atoms is observed as bright lines or arrangement of high-luminance dots, and arrangement of lithium atoms and oxygen atoms is observed as dark lines or a low-luminance region in the direction perpendicular to the c-axis. The same applies to the case where fluorine (atomic number: 9) and magnesium (atomic number: 12) are contained as the additive elements of the lithium cobalt oxide.

Consequently, in the case where repetition of bright lines and dark lines is observed in two regions having different crystal structures and the angle between the bright lines is less than or equal to 5° or less than or equal to 2.5° in a HAADF-STEM image, it can be judged that arrangements of the atoms are substantially aligned with each other, that is, the crystal orientations are substantially aligned with each other. Similarly, when the angle between the dark lines is less than or equal to 5° or less than or equal to 2.5°, it can be judged that orientations of the crystals are substantially aligned with each other.

With an ABF-STEM, an element having a smaller atomic number is observed to be brighter, but a contrast corresponding to the atomic number is obtained as with a HAADF-STEM; hence, in an ABF-STEM image, crystal orientations can be judged as in a HAADF-STEM image.

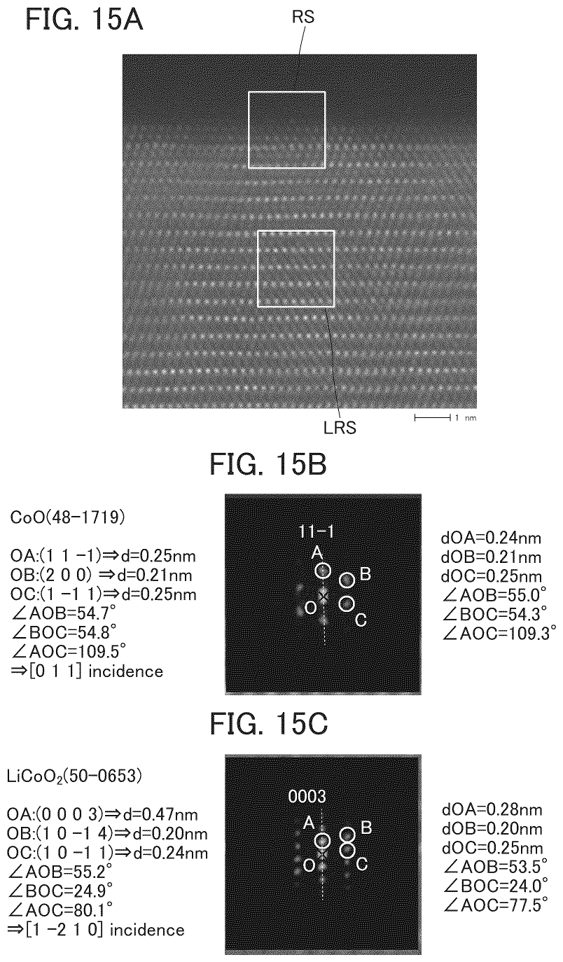

FIG. 15A shows an example of a STEM image in which orientations of the layered rock-salt crystal structure LRS denoted by a square and the rock-salt crystal structure RS denoted by a square are substantially aligned with each other. FIG. 15B shows FFT of a region of the rock-salt crystal structure RS, and FIG. 15C shows FFT of a region of the layered rock-salt crystal structure LRS. The compositions are shown on the left of FIG. 15B and FIG. 15C, the JCPDS card numbers are shown on the right of the compositions, and d values and angles to be calculated are also shown. The measured values are shown on the right. A spot denoted by O is zero-order diffraction.

A spot denoted by A in FIG. 15B is derived from 11-1 reflection of a cubic structure. A spot denoted by A in FIG. 15C is derived from 0003 reflection of a layered rock-salt crystal structure. It is found from FIG. 15B and FIG. 15C that the direction of the 11-1 reflection of the cubic structure and the direction of the 0003 reflection of the layered rock-salt crystal structure are substantially aligned with each other. That is, a straight line passing through AO in FIG. 15B is substantially parallel to a straight line passing through AO in FIG. 15C. Here, the terms “substantially aligned” and “substantially parallel” mean that the angle between the straight lines is 5° or less or 2.5° or less.

When the orientations of the layered rock-salt crystal structure and the rock-salt crystal structure are substantially aligned with each other in the above manner in FFT and electron diffraction, the <0003> orientation of the layered rock-salt crystal structure and the <11-1> orientation of the rock-salt crystal structure may be substantially aligned with each other. In that case, it is preferable that these reciprocal lattice points be spot-shaped, that is, they be not connected to other reciprocal lattice points. The state where reciprocal lattice points are spot-shaped and not connected to other reciprocal lattice points means high crystallinity.

When the direction of the 11-1 reflection of the cubic structure and the direction of the 0003 reflection of the layered rock-salt crystal structure are substantially aligned with each other as described above, a spot that is not derived from the 0003 reflection of the layered rock-salt crystal structure may be observed, depending on the incident direction of the electron beam, on a reciprocal lattice space different from the direction of the 0003 reflection of the layered rock-salt crystal structure. For example, a spot denoted by B in FIG. 15C is derived from 1014 reflection of the layered rock-salt crystal structure. This is sometimes observed at a position where the difference in orientation from the reciprocal lattice point derived from the 0003 reflection of the layered rock-salt crystal structure (A in FIG. 15C) is greater than or equal to 52° and less than or equal to 56° (i.e., ∠AOB is greater than or equal to 52° and less than or equal to 56°) and d is greater than or equal to 0.19 nm and less than or equal to 0.21 nm. Note that these indices are just examples, and the spot does not necessarily correspond with them. For example, the spot may be a reciprocal lattice point equivalent to the indices.

Similarly, a spot that is not derived from the 11-1 reflection of the cubic structure may be observed on a reciprocal lattice space different from the direction where the 11-1 reflection of the cubic structure is observed. For example, a spot denoted by B in FIG. 15B is derived from 200 reflection of the cubic structure. The spot derived from 200 reflection of the cubic structure is sometimes observed at a position where the difference in orientation from the reciprocal lattice point derived from the 11-1 reflection of the cubic structure (A in FIG. 15B) is greater than or equal to 54° and less than or equal to 56° (i.e., ∠AOB is greater than or equal to 54° and less than or equal to 56°). Note that these indices are just examples, and the spot does not necessarily correspond with them. For example, the spot may be a reciprocal lattice point equivalent to the indices.

It is known that in a positive electrode active material with a layered rock-salt crystal structure, such as lithium cobalt oxide, the (0003) plane and a plane equivalent thereto and the (10-14) plane and a plane equivalent thereto are likely to be crystal planes. Thus, a sample to be observed can be processed to be thin by FIB or the like such that an electron beam of a TEM, for example, enters in [12-10], in order to easily observe the (0003) plane in careful observation of the shape of the positive electrode active material with a SEM or the like. To judge alignment of crystal orientations, a sample is preferably processed to be thin so that the (0003) plane of the layered rock-salt crystal structure is easily observed.

<<x in LiₓCoO₂ being 1>>

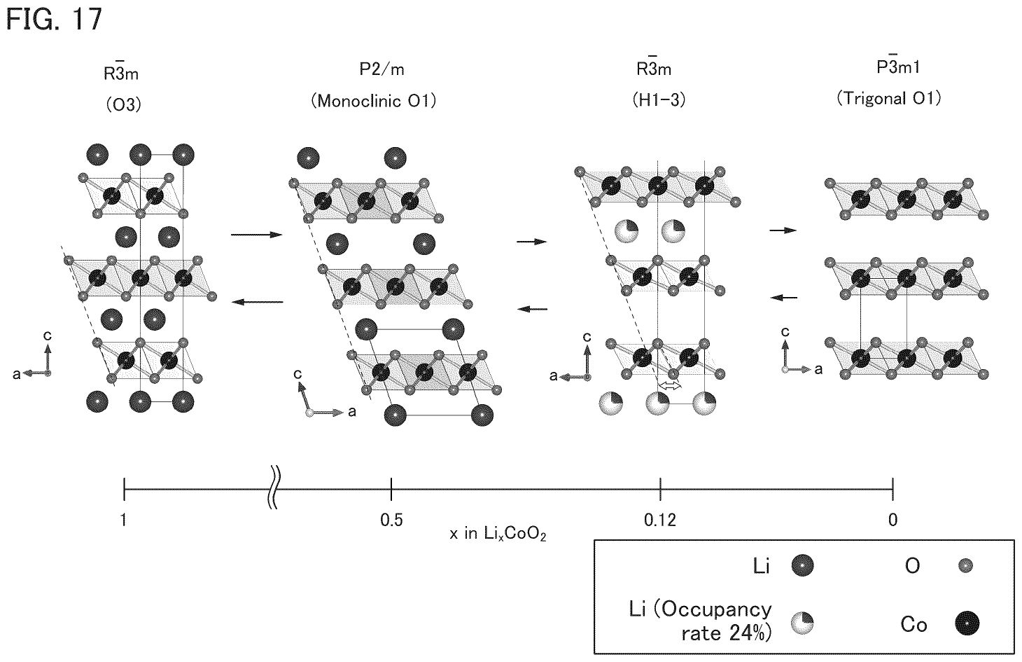

FIG. 17 illustrates the crystal structure of conventional lithium cobalt oxide in a discharged state, i.e., with x in LiₓCoO₂ of 1 (x=1). The crystal structure includes a layered rock-salt crystal structure belonging to the space group R-3m. The conventional positive electrode active material illustrated in FIG. 17 is lithium cobalt oxide (LiCoO₂) not containing the additive element A in particular. A change in the crystal structure of lithium cobalt oxide not containing the additive element A in particular is described in Non-Patent Document 1 to Non-Patent Document 3 and the like.

In this crystal structure, lithium occupies octahedral sites and a unit cell includes three CoO₂ layers. Thus, this crystal structure is referred to as an O3 type crystal structure in some cases. Note that the CoO₂ layer is a layer having a structure in which an octahedral structure with cobalt coordinated to six oxygen atoms continues on a plane in an edge-shared state. Such a layer is sometimes referred to as a layer formed of octahedrons of cobalt and oxygen. In FIG. 17, the crystal structure with x=1 is denoted with R-3m (O3).

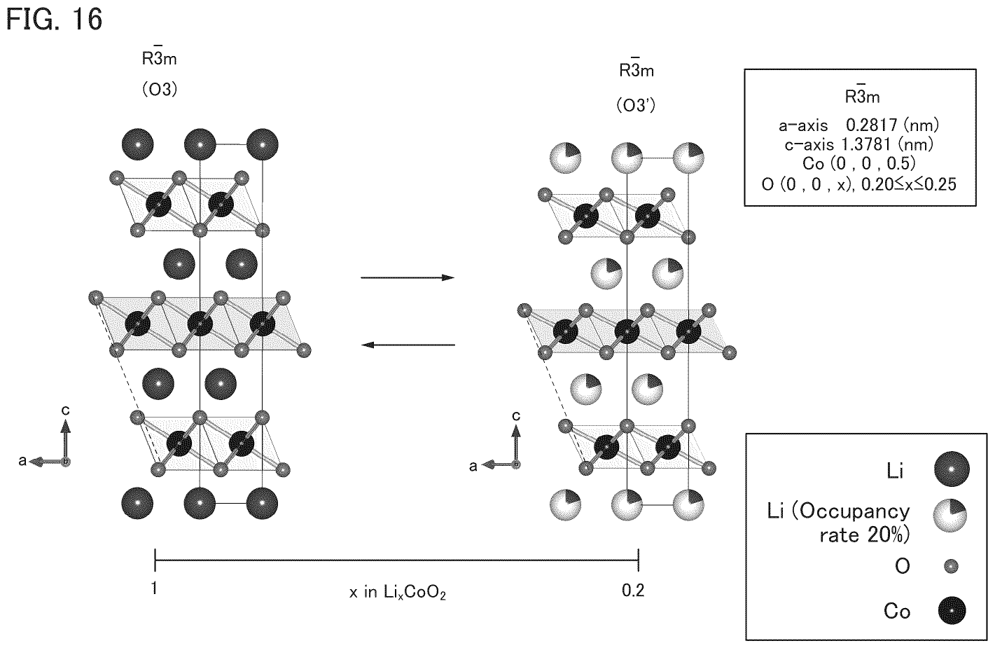

FIG. 16 illustrates the crystal structure of lithium cobalt oxide used for the positive electrode active material 200 of one embodiment of the present invention in a discharged state, i.e., with x in LiₓCoO₂ of 1 (x=1). The crystal structure includes a layered rock-salt crystal structure belonging to the space group R-3m. In this crystal structure, lithium occupies octahedral sites and a unit cell includes three CoO₂ layers. Also in FIG. 16, the crystal structure with x=1 is denoted with R-3m (O3).

Lithium cobalt oxide having a layered rock-salt crystal structure excels as a positive electrode active material of a secondary battery because it has high discharge capacity and a two-dimensional diffusion path for lithium ions and is thus suitable for an insertion/extraction reaction of lithium ions. For this reason, it is preferable that the inner portion 200b, which accounts for the majority of the volume of the positive electrode active material 200 of one embodiment of the present invention, be lithium cobalt oxide having a layered rock-salt crystal structure.

The surface portion 200a of lithium cobalt oxide used for the positive electrode active material 200 of one embodiment of the present invention preferably has a function of reinforcing the layered structure of a layer, which is formed of octahedrons of cobalt and oxygen (e.g., a CoO₂ layer), in the inner portion 200b so that the layered structure does not break even when lithium is extracted from the positive electrode active material 200 by charging. That is, the surface portion 200a preferably functions as a barrier film of the positive electrode active material 200. Alternatively, the surface portion 200a preferably reinforces the positive electrode active material 200. Reinforcing includes inhibition of a change in the structures of the surface portion 200a and the inner portion 200b of the surface of the positive electrode active material 200 and/or inhibition of oxidative decomposition of an electrolyte on the surface of the positive electrode active material 200.

Thus, in lithium cobalt oxide used for the positive electrode active material 200 of one embodiment of the present invention, the surface portion 200a preferably has a crystal structure different from that of the inner portion 200b. Specifically, the surface portion 200a preferably has a more stable composition and a more stable crystal structure than those of the inner portion 200b at room temperature (25° C.). For example, the surface portion 200a preferably has at least a rock-salt crystal structure. Although it is further preferable that the surface portion 200a have a rock-salt crystal structure entirely, one embodiment of the present invention is not limited thereto. For example, the surface portion 200a may have both a rock-salt crystal structure and a layered rock-salt crystal structure.

Here, the surface portion 200a is described. The surface portion 200a is a region from which lithium ions are extracted first in charging, and is a region that tends to have a lower lithium concentration than the inner portion 200b. It can be also said that, on the surface, which is the surface portion 200a, atoms constituting lithium cobalt oxide (e.g., oxygen) exist in a state where bonds are cut because of extraction of lithium ions. This means that the surface portion 200a is regarded as a region which is likely to be unstable and in which degradation of the crystal structure is likely to begin as compared with the inner portion 200b. Thus, when at least the surface portion 200a can be made sufficiently stable, the layered structure, which is formed of octahedrons of cobalt and oxygen, of the inner portion 200b can be difficult to break even with small x in LiₓCoO₂ (e.g., with x of less than or equal to 0.24). Note that breakage of the layered structure includes a shift of the end of the layered structure formed of octahedrons of cobalt and oxygen; when the surface portion 200a is sufficiently stable, the shift can be inhibited.

To make the surface portion 200a stable, the surface portion 200a needs to have a stable composition or a stable crystal structure; accordingly, the surface portion 200a preferably contains the additive element A. It is further preferable that the additive element A include two or more elements having different concentration distributions, such as an additive element X and an additive element Y described later. When the surface portion 200a contains the additive element A, the concentration of the additive element A in the surface portion 200a can be higher than the concentration of the additive element A in the inner portion 200b. When the additive element has high and low concentrations, the additive element A can have a concentration gradient in the surface portion 200a or the additive element A can have a concentration gradient from the surface portion 200a toward the inner portion 200b. In the case where the additive element X has a concentration gradient and the additive element Y has a concentration gradient, concentration distributions indicating the concentration gradients are preferably different from each other. It is further preferable that the peak position showing the maximum value of the concentration of the additive element X and the peak position showing the maximum value of the concentration of the additive element Y be different from each other. The maximum value of concentration is referred to as a peak top in some cases and the local maximum value of concentration is referred to as a peak in some cases.

For example, the additive element X selected from the additive elements A preferably has concentration distribution illustrated by gradation in FIG. 13C, in which the concentration increases from the inner portion 200b toward the surface, and is specifically one or more elements selected from magnesium, fluorine, nickel, titanium, silicon, phosphorus, boron, calcium, and the like. The peak top of the additive element X is preferably located in the surface portion 200a. For example, the additive element X preferably has concentration distribution such that the peak top is located in a region of 0.5 nm to 10 nm in depth from the surface toward the inner portion.

The additive element Y selected from the additive elements A preferably has a concentration gradient shown by density of hatching in FIG. 13D and a peak top in a region deeper than the peak top in FIG. 13C, and is specifically one or more elements selected from aluminum, manganese, and the like. The peak top of the additive element Y may be located in the surface portion 200a or located deeper than the surface portion 200a. For example, the additive element Y preferably has concentration distribution such that the peak top is located in a region of 5 nm to 30 nm in depth from the surface toward the inner portion. The position of the peak top of the additive element Y is preferably different from the position of the peak top of the additive element X. In addition, the concentration distribution of the additive element Y is preferably different from the concentration distribution of the additive element X.

A magnesium ion, which is one of the additive elements X, for example is divalent, and the magnesium ion is more stable in lithium sites than in cobalt sites in the layered rock-salt crystal structure and thus is likely to enter the lithium sites. That is, an appropriate concentration of magnesium in the lithium sites of the surface portion 200a facilitates maintenance of the layered rock-salt crystal structure of the inner portion 200b. This is probably because magnesium in the lithium sites in the surface portion 200a serves as a column supporting the CoO₂ layers. Moreover, the presence of magnesium in lithium cobalt oxide can inhibit extraction of oxygen around magnesium in a state where x in LiₓCoO₂ is, for example, 0.24 or less. The presence of magnesium is also expected to increase the density of lithium cobalt oxide. In addition, when magnesium concentration is higher in the surface portion 200a than in the inner portion 200b, the corrosion resistance to hydrofluoric acid generated by the decomposition of the electrolyte solution is probably improved.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because, when the magnesium concentration is high, magnesium enters the cobalt sites in addition to the lithium sites. Moreover, magnesium might be substituted for neither the lithium site nor the cobalt site and unevenly distributed as a magnesium compound (e.g., an oxide or a fluoride) in the surface of the positive electrode active material or the like to serve as a resistance component of a secondary battery. As the magnesium concentration in the positive electrode active material increases, the discharge capacity decreases in some cases. This is probably because excess magnesium enters the lithium sites and the amount of lithium contributing to charging and discharging decreases.

Thus, the entire positive electrode active material 200 preferably contains an appropriate amount of magnesium. For example, the number of magnesium atoms is preferably greater than or equal to 0.001 times and less than or equal to 0.1 times, further preferably greater than 0.01 times and less than 0.04 times, still further preferably approximately 0.02 times the number of cobalt atoms. The amount of magnesium contained in the entire positive electrode active material 200 here may be a value obtained by element analysis on the entire positive electrode active material 200 using GD-MS, ICP-MS (inductively coupled plasma mass spectrometry), or the like, or may be a value based on the ratio of the raw materials mixed in the formation process of the positive electrode active material 200, for example.

Nickel, which is one of the additive elements X, can exist in both the cobalt site and the lithium site. Nickel preferably exists in the cobalt site because an oxidation-reduction potential can be is lower than the case of cobalt, leading to an increase in discharge capacity.

In addition, when nickel exists in the lithium site, a shift in the layer (e.g., a CoO₂ layer), which is formed of octahedrons of cobalt and oxygen, due to charging and discharging can be inhibited. Moreover, a change in the volume in charging and discharging is inhibited. Furthermore, an elastic modulus becomes large, i.e., hardness increases. This is probably because nickel in the lithium sites also serves as a column supporting the CoO₂ layers. Therefore, in particular, the crystal structure is expected to be more stable in a charged state in an environment at high temperatures, e.g., 45° C. or higher, which is preferable.

Meanwhile, excess nickel might increase the influence of distortion due to the Jahn-Teller effect. Moreover, excess nickel might adversely affect insertion and extraction of lithium.

Thus, the entire positive electrode active material 200 preferably contains an appropriate amount of nickel. For example, the number of nickel atoms contained in the positive electrode active material 200 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the formation process of the positive electrode active material, for example.

Aluminum, which is one of additive elements Y, can exist in the cobalt site in a layered rock-salt crystal structure. Since aluminum is a trivalent representative element and its valence does not change, lithium around aluminum is less likely to move even in charging and discharging. Thus, aluminum and lithium therearound serve as columns to inhibit a change in the crystal structure. Furthermore, aluminum has effects of inhibiting elution of the transition metal M around aluminum and improving continuous charge tolerance. Moreover, an Al—O bond is stronger than a Co—O bond; thus, extraction of oxygen around aluminum can be inhibited. These effects improve thermal stability. Hence, a secondary battery containing aluminum as the additive element Y can have improved stability. Furthermore, the positive electrode active material 200 can have a crystal structure that is less likely to be broken by repeated charging and discharging.

Meanwhile, excess aluminum might adversely affect insertion and extraction of lithium.

Thus, the entire positive electrode active material 200 preferably contains an appropriate amount of aluminum. For example, the number of aluminum atoms contained in the entire positive electrode active material 200 is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. The amount contained in the entire positive electrode active material 200 here may be a value obtained by element analysis on the entire positive electrode active material 200 using GD-MS, ICP-MS, or the like, or may be a value based on the ratio of the raw materials mixed in the formation process of the positive electrode active material 200, for example.

Fluorine, which is one of the additive elements X, is a monovalent anion; when fluorine is substituted for part of oxygen in the surface portion 200a, the lithium extraction energy is lowered. This is because the change in valence of cobalt ions associated with lithium extraction is trivalent to tetravalent in the case of not containing fluorine and divalent to trivalent in the case of containing fluorine, and the oxidation-reduction potential differs therebetween. It can thus be said that when fluorine is substituted for part of oxygen in the surface portion 200a, lithium ions near fluorine are likely to be extracted and inserted smoothly. Thus, the use of lithium cobalt oxide containing fluorine in a secondary battery can improve the charge and discharge characteristics, current characteristics, and the like. When fluorine exists in the surface portion 200a, which has a surface in contact with the electrolyte solution, the corrosion resistance to hydrofluoric acid can be effectively improved. As will be described later, when a fluoride such as lithium fluoride has a lower melting point than another additive element A source, the fluoride can serve as a fusing agent (also referred to as a flux) for lowering the melting point of the another additive element A source.

An oxide of titanium, which is one of the additive elements X, is known to have superhydrophilicity. Accordingly, the positive electrode active material 200 that contains titanium oxide in the surface portion 200a presumably has good wettability with respect to a high-polarity solvent. In a secondary battery formed using the positive electrode active material 200, the positive electrode active material 200 and a high-polarity electrolyte solution can have favorable contact at the interface therebetween, which may inhibit an internal resistance increase.

When the surface portion 200a contains phosphorus, which is one of the additive elements X, a short circuit can be inhibited while a state with small x in LiₓCoO₂ is maintained, in some cases, which is preferable. For example, a compound containing phosphorus and oxygen preferably exists in the surface portion 200a.

When the positive electrode active material 200 contains phosphorus, phosphorus may react with hydrogen fluoride generated by the decomposition of the electrolyte, which might be able to decrease the hydrogen fluoride concentration in the electrolyte and is preferable.

In the case where LiPF₆ is contained as a lithium salt, hydrogen fluoride might be generated by hydrolysis. Furthermore, hydrogen fluoride might be generated by the reaction of polyvinylidene fluoride (PVDF) used as a component of the positive electrode and alkali. The decrease in hydrogen fluoride concentration in the electrolyte can inhibit corrosion of a current collector in some cases. Furthermore, a reduction in adhesion properties due to insolubilization of PVDF can be inhibited in some cases.

The positive electrode active material 200 preferably contains magnesium and phosphorus, in which case the stability in a state with small x in LiₓCoO₂ is extremely high. In the case where the positive electrode active material 200 contains phosphorus, the number of phosphorus atoms is preferably greater than or equal to 1% and less than or equal to 20%, further preferably greater than or equal to 2% and less than or equal to 10%, still further preferably greater than or equal to 3% and less than or equal to 8% of the number of cobalt atoms. Alternatively, it is preferably greater than or equal to 1% and less than or equal to 10%. Alternatively, it is preferably greater than or equal to 1% and less than or equal to 8%. Alternatively, it is preferably greater than or equal to 2% and less than or equal to 20%. Alternatively, it is preferably greater than or equal to 2% and less than or equal to 8%. Alternatively, it is preferably greater than or equal to 3% and less than or equal to 20%. Alternatively, it is preferably greater than or equal to 3% and less than or equal to 10%. In addition, the number of magnesium atoms is preferably greater than or equal to 0.1% and less than or equal to 10%, further preferably greater than or equal to 0.5% and less than or equal to 5%, still further preferably greater than or equal to 0.7% and less than or equal to 4% of the number of cobalt atoms. Alternatively, it is preferably greater than or equal to 0.1% and less than or equal to 5%. Alternatively, it is preferably greater than or equal to 0.1% and less than or equal to 4%. Alternatively, it is preferably greater than or equal to 0.5% and less than or equal to 10%. Alternatively, it is preferably greater than or equal to 0.5% and less than or equal to 4%. Alternatively, it is preferably greater than or equal to 0.7% and less than or equal to 10%. Alternatively, it is preferably greater than or equal to 0.7% and less than or equal to 5%. The concentrations of phosphorus and magnesium described here may each be a value obtained by element analysis on the entire positive electrode active material 200 by GC-MS, ICP-MS, or the like, or may be a value based on the ratio of the raw materials mixed in the formation process of the positive electrode active material 200, for example.

In the case where the positive electrode active material 200 has a crack, crack development can be inhibited by phosphorus, more specifically, a compound containing phosphorus and oxygen, for example, being in the inner portion of the positive electrode active material having the crack on its surface, e.g., a filling portion 202 illustrated in FIG. 13B.

When the surface portion 200a contains both magnesium and nickel, divalent magnesium might be able to be present more stably in the vicinity of divalent nickel. Thus, dissolution of magnesium might be inhibited even when x in LiₓCoO₂ is small. This can contribute to stabilization of the surface portion 200a.

The use of the combination of the additive element X and the additive element Y, for example, as the additive element A is preferable because the crystal structure of a wider region can be stabilized since the concentration distribution of the additive element X and the concentration distribution of the additive element Y are different from each other. For example, in the case where the positive electrode active material 200 contains magnesium and nickel, which are examples of the additive elements X, and contains aluminum, which is one of the additive elements Y, the crystal structure of a wider region can be stabilized as compared with the case where only the additive element X or the additive element Y is contained. In the case where the positive electrode active material 200 contains both the additive element X and the additive element Y as described above, the surface can be sufficiently stabilized by the additive element X such as magnesium and nickel; thus, the additive element Y such as aluminum is not necessary for the surface. It is preferable that aluminum be widely distributed in a deep region, for example, a region that is 5 nm to 50 nm in depth from the surface, in which case the crystal structure of a wider region can be stabilized.

When a plurality of the additive elements A are contained as described above, the effects of the additive elements A contribute synergistically to further stabilization of the surface portion 200a and the inner portion 200b. In particular, magnesium, nickel, and aluminum are preferably contained because a high effect of stabilizing the crystal structure can be obtained.

Note that it is not preferable that the surface portion 200a be occupied by only a compound of the additive element A and oxygen because it becomes difficult to insert and extract lithium. For example, it is not preferable that the surface portion 200a be occupied by only MgO, a structure in which MgO and NiO(II) form a solid solution, and/or a structure in which MgO and CoO(II) form a solid solution. Thus, the surface portion 200a needs to contain at least cobalt, and also contain lithium in a discharged state to have the path through which lithium is inserted and extracted.

To ensure the path through which lithium is inserted and extracted, the concentration of cobalt is preferably higher than that of magnesium in the surface portion 200a. For example, an atomic ratio of the number of magnesium atoms A_{Mg} to the number of cobalt atoms A_{Co}, A_{Mg}/A_{Co}, is preferably greater than or equal to 0.62. The concentration of cobalt is preferably higher than that of nickel in the surface portion 200a. The concentration of cobalt is preferably higher than that of aluminum in the surface portion 200a. The concentration of cobalt is preferably higher than that of fluorine in the surface portion 200a.

Moreover, excess nickel might hinder diffusion of lithium; thus, the concentration of magnesium is preferably higher than that of nickel in the surface portion 200a. For example, the number of nickel atoms is preferably ⅙ or less that of magnesium atoms.

It is preferable that some of the additive elements A, in particular, magnesium, nickel, and aluminum have higher concentrations in the surface portion 200a than in the inner portion 200b and exist randomly also in the inner portion 200b to have low concentrations. When magnesium and aluminum exist in the lithium sites of the inner portion 200b at appropriate concentrations, an effect of facilitating maintenance of the layered rock-salt crystal structure is obtained in a manner similar to the above. When nickel is present in the inner portion 200b at an appropriate concentration, a shift in the layer formed of octahedrons of cobalt and oxygen (e.g., a CoO₂ layer) due to charging and discharging can be inhibited in a manner similar to the above. Also in the case where both magnesium and nickel are contained, a synergistic effect of inhibiting dissolution of magnesium can be expected since divalent magnesium can be present more stably in the vicinity of divalent nickel.

It is preferable that the crystal structure continuously change from the inner portion 200b toward the surface owing to the above-described concentration gradient of the additive element A. Alternatively, it is preferable that the surface portion 200a and the inner portion 200b have substantially the same crystal orientation.

For example, a crystal structure preferably changes continuously from the inner portion 200b having a layered rock-salt crystal structure toward the surface portion 200a (i.e., the surface) that has a rock-salt crystal structure or has the features of both a rock-salt crystal structure and a layered rock-salt crystal structure. Alternatively, the orientations of the surface portion 200a that has a rock-salt crystal structure or has the features of both a rock-salt crystal structure and a layered rock-salt crystal structure and the inner portion 200b having a layered rock-salt crystal structure are preferably substantially aligned with each other.

<<State where x in LiₓCoO₂ is Small>>

The crystal structure in a state where x in LiₓCoO₂ is small of the positive electrode active material 200 of one embodiment of the present invention is different from that of a conventional positive electrode active material because the positive electrode active material 200 has the above-described distribution and/or crystal structure of the additive element A in a discharged state. Here, “x is small” means 0.1<x≤0.24.

First, a change in the crystal structure of the conventional positive electrode active material is shown in FIG. 17. Conventional lithium cobalt oxide with x in LiₓCoO₂ of approximately 0.5 (x approximately =0.5) is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases. In FIG. 17, the crystal structure with x=0.5 is denoted with P2/m (monoclinic O1).

When x in LiₓCoO₂ is 0 (when x=0), conventional lithium cobalt oxide has a trigonal crystal structure belonging to the space group P-3 ml, and a unit cell includes one CoO₂ layer. Thus, this crystal structure is referred to as an O1 type structure or a trigonal O1 type structure in some cases. Moreover, in some cases, this crystal structure is referred to as a hexagonal O1 type structure when a trigonal crystal is converted into a composite hexagonal lattice. In FIG. 17, the crystal structure with x=0 is denoted with P-3 ml (Trigonal O2)).

When x in LiₓCoO₂ is approximately 0.24 (when x approximately =0.24), conventional lithium cobalt oxide has the crystal structure belonging to the space group R-3m. This structure can also be regarded as a structure in which CoO₂ structures such as trigonal O1 type structures and LiCoO₂ structures such as R-3m (O3) are alternately stacked. Thus, this crystal structure is referred to as an H1-3 type crystal structure in some cases. In FIG. 17, the crystal structure with x=0.12 is denoted with R-3m (H1-3).

Note that the number of cobalt atoms per unit cell in the actual H1-3 type crystal structure is twice as large as that of cobalt atoms per unit cell in other structures. However, in this specification including FIG. 17, the c-axis of the H1-3 type crystal structure is half that of the unit cell for easy comparison with the other crystal structures.

For the H1-3 type crystal structure, as disclosed in Non-Patent Document 3, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in lithium cobalt oxide can be judged by the Rietveld analysis of XRD patterns, for example. In this case, a unit cell is selected such that the value of GOF (goodness of fit) is small.

When charging that makes x in LiₓCoO₂ be 0.24 or less and discharging that makes x be 1 are repeated, the crystal structure of conventional lithium cobalt oxide repeatedly changes between the R-3m (O3) type crystal structure in a discharged state and the H1-3 type crystal structure (i.e., an unbalanced phase change).

However, there is a large shift in the CoO₂ layers between these two crystal structures. As denoted by the dotted lines and the arrow in FIG. 17, the CoO₂ layer in the H1-3 type crystal structure largely shifts from R-3m (O3) in a discharged state. Such a dynamic structural change can adversely affect the stability of the crystal structure.

A difference in volume between these two crystal structures is also large. The difference in volume per the same number of cobalt atoms between the R-3m (O3) type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging that makes x be 1 are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium.

Meanwhile, the positive electrode active material 200 of one embodiment of the present invention illustrated in FIG. 16 has a trigonal crystal structure belonging to the space group R-3m, when x is approximately 0.2. The symmetry of the CoO₂ layers of this structure is the same as that of O3. Thus, this crystal structure is called an O3′ type crystal structure. In FIG. 16, the crystal structure with x=0.2 is denoted with R-3m (O3′).

In lithium cobalt oxide used for the positive electrode active material 200 of one embodiment of the present invention, a change in the crystal structure between a discharged state with x in LiₓCoO₂ of 1 and a charged state with x of 0.24 or less is smaller than that in conventional lithium cobalt oxide. Specifically, as denoted by the dotted lines in FIG. 16, the CoO₂ layers hardly shift between the R-3m (O3) in the discharged state and the O3′ type crystal structure. Furthermore, a change in the volume can be small in the comparison between the states with the same number of cobalt atoms. Specifically, the R-3m (O3) in a discharged state and the O3′ type crystal structure which contain the same number of cobalt atoms have a difference in volume of 2.5% or less, specifically 2.2% or less, typically 1.8%. Thus, the positive electrode active material 200 of one embodiment of the present invention can have a crystal structure that is difficult to break even when charging that makes x be 0.24 or less and discharging that makes x be 1 are repeated, and obtain excellent cycle performance.

As described above, in the positive electrode active material 200 of one embodiment of the present invention, the crystal structure in which x in LiₓCoO₂ is 0.24 or less is different from that in the conventional positive electrode active material, and a change from the crystal structure in a discharged state in which x becomes 1 is inhibited. In addition, a change in the volume in the positive electrode active material 200 of one embodiment of the present invention of the case where the positive electrode active materials having the same number of cobalt atoms are compared is inhibited. Thus, the crystal structure of the positive electrode active material 200 is unlikely to be broken even when charging that makes x be 0.24 or less and discharging are repeated. Therefore, a decrease in discharge capacity of the positive electrode active material 200 in charge and discharge cycles is inhibited. In addition, lithium cobalt oxide used for the positive electrode active material 200 of one embodiment of the present invention can have a more stable crystal structure than conventional lithium cobalt oxide in a state where x in LiₓCoO₂ is 0.24 or less. Thus, in the case where the state with x in LiₓCoO₂ of 0.24 or less is maintained in the positive electrode active material 200 of one embodiment of the present invention, a short circuit is less likely to occur and the safety of the secondary battery is improved. Furthermore, the positive electrode active material 200 of one embodiment of the present invention can stably use a larger amount of lithium than a conventional positive electrode active material and thus has high discharge capacity per weight and per volume. Hence, with the use of the positive electrode active material 200 of one embodiment of the present invention, a secondary battery with high discharge capacity per weight and per volume can be fabricated.

In the unit cell of the O3′ type crystal structure of lithium cobalt oxide used for the positive electrode active material 200 of one embodiment of the present invention, the coordinates of cobalt and oxygen can be represented by Co (0, 0, 0.5) and O (0, 0, x) within the range of 0.20≤x≤0.25. In the unit cell, the lattice constant of the a-axis is preferably 0.2797≤a≤0.2837 (nm), further preferably 0.2807≤a≤0.2827 (nm), typically a=0.2817 (nm). The lattice constant of the c-axis is preferably 1.3681≤c≤1.3881 (nm), further preferably 1.3751≤c≤1.3811 (nm), typically, c=1.3781 (nm).

In the O3′ type crystal structure, an ion of cobalt, nickel, magnesium, or the like occupies a site coordinated to six oxygen atoms. Note that a light element such as lithium sometimes occupies a site coordinated to four oxygen atoms.

The positive electrode active material 200 of one embodiment of the present invention is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte, and the like, so that the range of x is not limited to the above.

Hence, when x in LiₓCoO₂ in the positive electrode active material 200 is greater than 0.1 and less than or equal to 0.24, not all of the inner portion 200b of the positive electrode active material 200 has to have the O3′ type crystal structure. The positive electrode active material 200 may have another crystal structure or may be partly amorphous.

In order to make x in LiₓCoO₂ small, charging with a high charge voltage is necessary in general. Therefore, the state where x in LiₓCoO₂ is small can be rephrased as a state where charging with a high charge voltage has been performed. For example, when CC/CV charging is performed in an environment at 25° C. and 4.6 V or higher using the potential of a lithium metal as a reference, the H1-3 type crystal structure appears in a conventional positive electrode active material. Therefore, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, the positive electrode active material 200 of one embodiment of the present invention is preferable because the crystal structure can be maintained even when charging with a high charge voltage of 4.6 V or higher is performed in an environment at 25° C., for example. Moreover, the positive electrode active material 200 of one embodiment of the present invention is preferable because the O3′ type crystal structure can be obtained when charging with a higher charge voltage, e.g., a voltage higher than or equal to 4.65 V and lower than or equal to 4.7 V is performed in an environment at 25° C.

In the positive electrode active material 200 of one embodiment of the present invention, the H1-3 type crystal is observed when the charge voltage is increased, in some cases. As described above, the crystal structure is influenced by the number of charge and discharge cycles, a charge current and a discharge current, an electrolyte, and the like, so that the positive electrode active material 200 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Therefore, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ type crystal structure in FIG. 16, one embodiment of the present invention is not limited thereto. Lithium may exist unevenly in only some of the lithium sites; for example, lithium may symmetrically exist as in the monoclinic O1 (Li_{0.5}CoO₂) shown in FIG. 17. Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ crystal structure in general.

The concentration gradient of the additive element A is preferably similar in a plurality of portions of the surface portion 200a of the positive electrode active material 200. In other words, it is preferable that the reinforcement derived from the additive element A uniformly occurs in the surface portion 200a. When only part of the surface portion 200a is reinforced, stress might be concentrated on parts that do not have reinforcement. The concentration of stress on part of the positive electrode active material 200 might cause defects such as cracks from that part, leading to breakage of the positive electrode active material and a decrease in charge and discharge capacity.

Note that the additive elements A do not necessarily have similar concentration gradients throughout the surface portion 200a of the positive electrode active material 200. FIG. 13E illustrates an example of distribution of the additive element X in the portion near the line C-D in FIG. 13A and FIG. 13F illustrates an example of distribution of the additive element Y in the portion near the line C-D.

Here, the portion near the line C-D has a layered rock-salt crystal structure belonging to R-3m and the surface of the portion has a (001) orientation. The distribution of the additive element A at the surface having a (001) orientation may be different from that at other surfaces. For example, the surface having a (001) orientation and the surface portion 200a thereof may have concentration distribution or a peak top of one or two or more selected from the additive elements X and the additive elements Y in a shallow portion from the surface as compared to the case of a surface having another orientation. Alternatively, the surface with a (001) orientation and the surface portion 200a thereof may have a lower concentration of one or two or more selected from the additive elements X and the additive elements Y than a surface having another orientation. Further alternatively, at the surface with a (001) orientation and the surface portion 200a thereof, the concentration of one or two or more selected from the additive elements X and the additive element Y may be below the lower detection limit.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to the (001) plane.

Since a CoO₂ layer is relatively stable, the (001) plane where the CoO₂ layer exists in a surface is relatively stable. A main diffusion path of lithium ions in charging and discharging is not exposed at the (001) plane.

By contrast, a diffusion path of lithium ions is exposed at a surface having an orientation other than a (001) orientation. Thus, the surface with an orientation other than a (001) orientation and the surface portion 200a thereof easily lose stability because they are regions where extraction of lithium ions starts as well as important regions for maintaining a diffusion path of lithium ions. It is thus important to reinforce the surface having an orientation other than a (001) orientation and the surface portion 200a thereof so that the crystal structure of the whole positive electrode active material 200 is maintained.

Accordingly, in the positive electrode active material 200 of another embodiment of the present invention, it is preferable that the plane other than (001) and the surface portion 200a thereof have distribution of the additive element A as illustrated in FIG. 13C or FIG. 13D. By contrast, in the (001) plane and the surface portion 200a thereof, the concentration of the additive element A may be low as described above or the additive element A may be absent.

With the use of a formation method described in the following embodiment, in which the additive element A is mixed after high-purity LiCoO₂ is formed and heating is performed, the additive element A spreads mainly via a diffusion path of lithium ions. Thus, distribution of the additive element A at the plane other than (001) and the surface portion 200a thereof can easily fall within a preferred range.

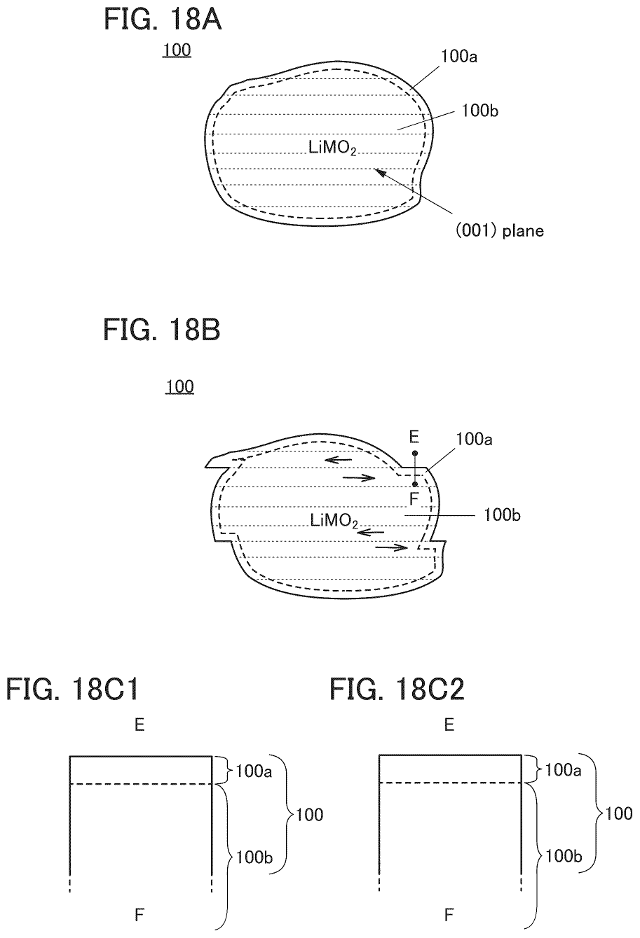

The positive electrode active material 200 preferably has a smooth surface with little unevenness; however, it is not necessary that the entire positive electrode active material 200 be in such a state. In a composite oxide having a layered rock-salt crystal structure belonging to R-3m, slipping easily occurs at a plane parallel to the (001) plane, e.g., a plane where lithium atoms are arranged. In the case where a (001) plane exists as illustrated in FIG. 18A, for example, steps such as pressing sometimes cause slipping in a direction parallel to the (001) plane as denoted by arrows in FIG. 18B, resulting in deformation.

In that case, at a surface newly formed as a result of slipping and the surface portion 200a thereof, the additive element A is not present or present at a concentration lower than or equal to the lower detection limit in some cases. The line E-F in FIG. 18B denotes examples of the surface newly formed as a result of slipping and the surface portion 200a thereof. FIG. 18C1 and FIG. 18C2 illustrate enlarged views of the vicinity of the line E-F. In FIG. 18C1 and FIG. 18C2, unlike in FIG. 13C to FIG. 13F, there is neither distribution of the additive element X nor that of the additive element Y.

However, because slipping easily occurs parallel to the (001) plane, the newly formed surface and the surface portion 200a thereof easily have a (001) orientation. In that case, since a diffusion path of lithium ions is not exposed and is relatively stable, substantially no problem is caused even when the additive element A does not exist or the concentration is below the lower detection limit.

Note that as described above, in a composite oxide whose composition is LiCoO₂ and which has a layered rock-salt crystal structure belonging to R-3m, cobalt atoms are arranged parallel to the (001) plane. In a HAADF-STEM image, the luminance of cobalt, which has the largest atom number in LiCoO₂, is the highest. Thus, in a HAADF-STEM image, arrangement of atoms with high luminance can be regarded as arrangement of cobalt atoms. Repetition of such arrangement with high luminance can be rephrased as crystal fringes or lattice fringes.

### <<Crystal Grain Boundary>>

It is further preferable that the additive element A contained in the positive electrode active material 200 of one embodiment of the present invention be distributed as described above and unevenly distributed at least partly at the crystal grain boundary 201 and the vicinity thereof.

Note that in this specification and the like, uneven distribution means that the concentration of an element in a certain region differs from that in another region. It can be rephrased as segregation, precipitation, unevenness, deviation, or a mixed area with a high concentration and a low concentration.

For example, the magnesium concentration in the crystal grain boundary 201 and its vicinity of the positive electrode active material 200 is preferably higher than that in the other regions in the inner portion 200b. In addition, the fluorine concentration at the crystal grain boundary 201 and the vicinity thereof is preferably higher than that in the other regions in the inner portion 200b. In addition, the nickel concentration at the crystal grain boundary 201 and the vicinity thereof is preferably higher than that in the other regions in the inner portion 200b. In addition, the aluminum concentration at the crystal grain boundary 201 and the vicinity thereof is preferably higher than that in the other regions in the inner portion 200b.

The crystal grain boundary 201 is a type of plane defect. Thus, the crystal grain boundary tends to be unstable and the crystal structure easily starts to change like the surface of the particle. Therefore, the higher the concentration of the additive element A in the crystal grain boundary 201 and its vicinity is, the more effectively the change in the crystal structure can be inhibited.

When the magnesium concentration and the fluorine concentration are high at the crystal grain boundary 201 and the vicinity thereof, the magnesium concentration and the fluorine concentration in the vicinity of a surface generated by a crack are also high even when the crack is generated along the crystal grain boundary 201 of the positive electrode active material 200 of one embodiment of the present invention. Thus, the positive electrode active material including a crack can also have an increased corrosion resistance to hydrofluoric acid.

### <Particle Diameter>

Too large a particle diameter of the positive electrode active material 200 of one embodiment of the present invention causes problems such as difficulty in lithium diffusion and too much surface roughness of an active material layer in coating to a current collector. By contrast, too small a particle diameter causes problems such as difficulty in loading of the active material layer in coating to the current collector and overreaction with the electrolyte solution. Therefore, the median diameter (D50) is preferably greater than or equal to 1 μm and less than or equal to 100 μm, further preferably greater than or equal to 2 μm and less than or equal to 40 μm, still further preferably greater than or equal to 5 μm and less than or equal to 30 μm. Alternatively, it is preferably greater than or equal to 1 μm and less than or equal to 40 rm. Alternatively, it is preferably greater than or equal to 1 μm and less than or equal to 30 rm. Alternatively, it is preferably greater than or equal to 2 μm and less than or equal to 100 μm. Alternatively, it is preferably greater than or equal to 2 μm and less than or equal to 30 rm. Alternatively, it is preferably greater than or equal to 5 μm and less than or equal to 100 μm. Alternatively, it is preferably greater than or equal to 5 μm and less than or equal to 40 μm.

### <Analysis Method>

Whether or not a given positive electrode active material is the positive electrode active material 200 of one embodiment of the present invention, which has the O3′ type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of the transition metal M such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example. A diffraction peak reflecting the crystal structure of the inner portion 200b of the positive electrode active material 200, which accounts for the majority of the volume of the positive electrode active material 200, is obtained through XRD, in particular, powder XRD.

As described above, the positive electrode active material 200 of one embodiment of the present invention has a feature of a small change in the crystal structure between when x in LiₓCoO₂ is 1 and when x is less than or equal to 0.24. The case where the crystal structure that largely changes occupies 50% or more is not preferable because the positive electrode active material cannot withstand high-voltage charging and discharging.

It should be noted that the O3′ type crystal structure is not obtained in some cases only by addition of the additive element A. For example, when x in LiₓCoO₂ is less than or equal to 0.24, lithium cobalt oxide containing magnesium and fluorine or lithium cobalt oxide containing magnesium and aluminum has the O3′ type crystal structure at 60% or more in some cases, and has the H1-3 type crystal structure at 50% or more in other cases, depending on the concentration and distribution of the additive element A.

In addition, in the case where x is too small, e.g., 0.1 or less, or under the condition where charge voltage is higher than 4.9 V, the positive electrode active material 200 of one embodiment of the present invention sometimes has the H1-3 type crystal structure or the trigonal O1 type crystal structure. Thus, determining whether or not a positive electrode active material is the positive electrode active material 200 of one embodiment of the present invention requires analysis of the crystal structure by XRD and other methods and data such as charge capacity or charge voltage.

A positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the additive element A contained in a given positive electrode active material is in the above-described state can be judged by, for example, analysis using XPS, energy dispersive X-ray spectroscopy (EDX), EPMA (electron probe microanalysis), or the like.

The crystal structure of the surface portion 200a, the crystal grain boundary 201, or the like can be analyzed by electron diffraction of a cross section of the positive electrode active material 200, for example.

### <<Charging Method>>

Whether or not a certain composite oxide is the positive electrode active material 200 of one embodiment of the present invention can be determined by high-voltage charging. For example, the high-voltage charging is performed on a coin cell (CR2032 type with a diameter of 20 mm and a height of 3.2 mm) formed using the composite oxide for a positive electrode and a lithium metal for a negative electrode (also referred to as a counter electrode).

More specifically, a positive electrode can be formed by application of slurry in which the positive electrode active material, a conductive material, and a binder are mixed into a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

Stainless steel (SUS) can be used for a positive electrode can and a negative electrode can.

The coin cell fabricated with the above conditions is subjected to constant current charging at a current value of 10 mA/g to a freely selected voltage (e.g., 4.5 V, 4.55 V, 4.6 V, 4.65 V, 4.7 V, 4.75 V, or 4.8 V). To observe a phase change of the positive electrode active material, charging with such a small current value is desirably performed. The coin cell was placed in an environment at a temperature of 25° C. or 45° C. After the charging is performed in this manner, the coin cell is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode active material enclosed in an airtight container with an argon atmosphere. After charging is completed, the positive electrode is preferably taken out immediately and subjected to the analysis. Specifically, the positive electrode is subjected to the analysis preferably within an hour, further preferably within 30 minutes after the completion of charging.

In the case where the crystal structure in a charged state after charging and discharging are performed multiple times is analyzed, the conditions of the charging and discharging which are performed multiple times may be different from the above-described charge conditions. For example, as the charging, constant current charging to a freely selected voltage (e.g., 4.6 V, 4.65 V, 4.7 V, 4.75 V, or 4.8 V) at a current value of 100 mA/g can be performed and then constant voltage charging can be performed until the current value becomes 10 mA/g, and as the discharging, constant current discharging can be performed at 2.5 V and 100 mA/g.

Also in the case where the crystal structure in a discharged state after charging and discharging are performed multiple times is analyzed, constant current discharging can be performed at 2.5 V and a current value of 100 mA/g, for example.

### <<XRD>>

The apparatus and conditions for the XRD measurement are not particularly limited. The measurement can be performed with the apparatus and conditions as described below, for example.
XRD apparatus: D8 ADVANCE produced by Bruker AXS
X-ray source: Cu
Output: 40 kV, 40 mA
Slit width: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material layer can be adjusted to the measurement plane required by the apparatus.

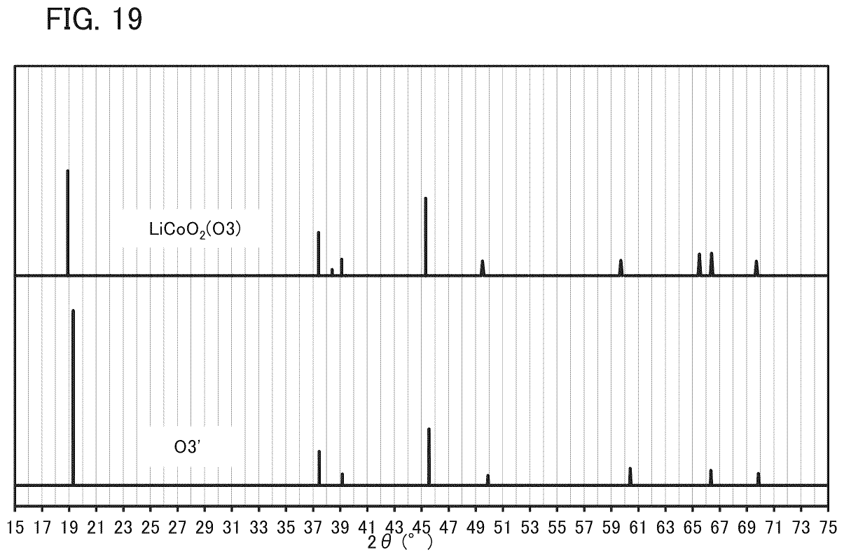

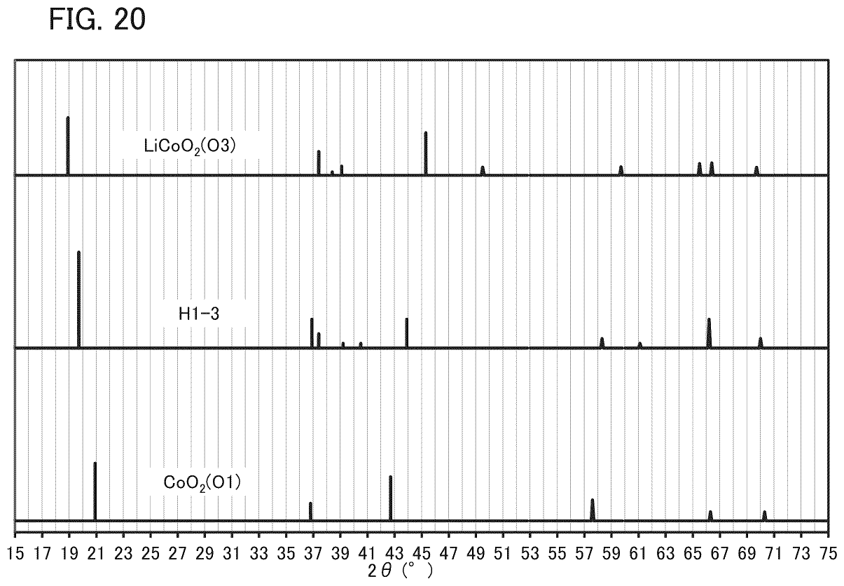

FIG. 19 and FIG. 20 show ideal powder XRD patterns with CuKα1 radiation that are calculated from models of the O3′ type crystal structure and the H1-3 type crystal structure. For comparison, ideal XRD patterns calculated from the crystal structure of LiCoO₂O3 with x in LiₓCoO₂ of 1, the crystal structure of the H1-3 type, and the crystal structure of the trigonal O1 with x of 0 are also shown. Note that the patterns of LiCoO₂ (O3) and CoO₂ (O1) are made from crystal structure data obtained from the ICSD (Inorganic Crystal Structure Database) (see Non-Patent Document 3) with Reflex Powder Diffraction, which is a module of Materials Studio (BIOVIA). The range of 2θ is from 15° to 75°, the step size is 0.01, the wavelength λ1 is 1.540562×10⁻¹⁰ m, the wavelength λ2 is not set, and a single monochromator is used. The pattern of the H1-3 type crystal structure is similarly made from the crystal structure data disclosed in Non-Patent Document 3. The O3′ type crystal structure is estimated from the XRD pattern of the positive electrode active material of one embodiment of the present invention, the crystal structure is fitted with TOPAS Ver. 3 (crystal structure analysis software produced by Bruker Corporation), and the XRD pattern of the O3′ type crystal structure is made in a manner similar to that for other structures.

As shown in FIG. 19, the O3′ type crystal structure exhibits diffraction peaks at 2θ of 19.25±0.12° (greater than or equal to 19.13° and less than 19.37°) and 2θ of 45.47±0.10° (greater than or equal to 45.37° and less than 45.57°).

However, as shown in FIG. 20, the H1-3 type crystal structure and the trigonal O1 do not exhibit peaks at these positions. Thus, the peaks at 2θ of 19.25±0.12° (greater than or equal to 19.13° and less than 19.37°) and 2θ of 45.47±0.10° (greater than or equal to 45.37° and less than 45.57°) exhibited in a state where x in LiₓCoO₂ is small can be the features of the positive electrode active material 200 of one embodiment of the present invention.

It can be said that the positions of the XRD diffraction peaks exhibited by the crystal structure with x being 1 and the crystal structure with x being 0.24 or less are close to each other. More specifically, it can be said that a difference in 2θ between the main diffraction peak exhibited by the crystal structure with x being 1 and the main diffraction peak exhibited by the crystal structure with x being 0.24 or less, which are exhibited at 2θ of greater than or equal to 42° and less than or equal to 46°, is 0.7° or less, preferably 0.5° or less.

Although the positive electrode active material 200 of one embodiment of the present invention has the O3′ type crystal structure when x in LiₓCoO₂ is small, not all the positive electrode active material 200 necessarily have the O3′ type crystal structure. The positive electrode active material 200 may have another crystal structure or may be partly amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. The positive electrode active material in which the O3′ type crystal structure accounts for greater than or equal to 50% preferably greater than or equal to 60%, further preferably greater than or equal to 66% can have sufficiently good cycle performance.

Furthermore, even after 100 or more cycles of charging and discharging after the measurement starts, the O3′ type crystal structure preferably accounts for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions or the 20 value. In the case of the above-described measurement conditions, the peak observed at 20 of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. High crystallinity contributes to stability of the crystal structure after charging.

The crystallite size of the O3′ type crystal structure included in the positive electrode active material 200 does not decrease to less than approximately 1/20 that of LiCoO₂ (O3) in a discharged state. Thus, a clear peak of the O3′ type crystal structure can be observed when x in LiₓCoO₂ is small, even under the same XRD measurement conditions as those of a positive electrode before the charging and discharging. By contrast, conventional LiCoO₂ has a small crystallite size and a broad and small peak even when it can have a structure part of which is similar to the O3′ type crystal structure. The crystallite size can be calculated from the half width of the XRD peak.

### <<XPS>>

In an inorganic oxide, a region that is approximately 2 to 8 nm (typified by less than or equal to 5 nm) in depth from a surface can be analyzed by X-ray photoelectron spectroscopy (XPS) using monochromatic aluminum Kα radiation as an X-ray source; thus, the concentrations of elements in approximately half the depth of the surface portion 200a can be quantitatively analyzed. The bonding states of the elements can be analyzed by narrow scanning. Note that the quantitative accuracy of XPS is approximately ±1 atomic % in many cases, and the lower detection limit is approximately 1 atomic % but depends on the element.

In the positive electrode active material 200 of one embodiment of the present invention, the concentration of one or two or more selected from the additive elements A is preferably higher in the surface portion 200a than in the inner portion 200b. This means that the concentration of one or two or more selected from the additive elements A in the surface portion 200a is preferably higher than the average concentration of the selected element(s) in the entire the positive electrode active material 200. For this reason, for example, it is preferable that the concentration of one or more additive elements A selected from the surface portion 200a, which is measured by XPS or the like, be higher than the average concentration of the additive element(s) A in the entire the positive electrode active material 200, which is measured by ICP-MS, GD-MS, or the like. For example, the concentration of magnesium of at least part of the surface portion 200a, which is measured by XPS or the like, is preferably higher than the average concentration of magnesium of the entire positive electrode active material 200. The concentration of nickel of at least part of the surface portion 200a is preferably higher than the average concentration of nickel of the entire the positive electrode active material 200. The concentration of aluminum of at least part of the surface portion 200a is preferably higher than the average concentration of aluminum of the entire the positive electrode active material 200. The concentration of fluorine of at least part of the surface portion 200a is preferably higher than the average concentration of fluorine of the entire the positive electrode active material 200.

Note that the surface and the surface portion 200a of the positive electrode active material 200 of one embodiment of the present invention do not contain carbonate, a hydroxy group, or the like which is chemically adsorbed after formation of the positive electrode active material 200. Furthermore, an electrolyte solution, a binder, a conductive material, and a compound originating from any of these that are attached to the surface of the positive electrode active material 200 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample such as a positive electrode active material and a positive electrode active material layer may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element A is not easily dissolved even in that case; thus, the atomic ratio of the additive element A is not affected.

The concentration of the additive element A may be compared using the ratio of the additive element A to cobalt. The use of the ratio of the additive element A to cobalt enables comparison while reducing the influence of a carbonate or the like which is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, Mg/Co is preferably greater than or equal to 0.001 and less than or equal to 0.06.

Similarly, in the surface portion 200a of the positive electrode active material 200, the concentrations of lithium and cobalt are preferably higher than that of the additive elements A so that sufficient paths through lithium is inserted and extracted are ensured. It can be said that the concentrations of lithium and cobalt in the surface portion 200a are preferably higher than the concentration of one or two or more additive elements A selected from the additive elements A contained in the surface portion 200a, which is measured by XPS or the like. For example, the concentration of cobalt in at least part of the surface portion 200a measured by XPS or the like is preferably higher than the concentration of magnesium in at least part of the surface portion 200a measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than that of aluminum. Similarly, the concentration of lithium is preferably higher than the concentration of aluminum. The concentration of cobalt is preferably higher than that of fluorine. Similarly, the concentration of lithium s preferably higher that of fluorine.

It is further preferable that the additive element Y such as aluminum be widely distributed in a deep region, e.g., a region that is 5 nm to 50 nm in depth from the surface. Therefore, the additive element Y such as aluminum is preferably detected by analysis on the entire positive electrode active material 200 by ICP-MS, GD-MS, or the like, but the concentration is preferably lower than or equal to the lower detection limit in XPS or the like.

When XPS analysis is performed on the positive electrode active material 200 of one embodiment of the present invention, the number of magnesium atoms is preferably 0.4 times or more and 1.2 times or less, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms.

In the XPS analysis, monochromatic aluminum Kα radiation can be used as an X-ray source, for example. An extraction angle is, for example, 45°. For example, the measurement can be performed using the following apparatus and conditions.
Measurement device: Quantera II produced by PHI, Inc.
X-ray source: monochromatic Al Kα (1486.6 eV)
Detection area: 100 μmϕ
Detection depth: approximately 4-5 nm (extraction angle 45°)
Measurement spectrum: wide scanning, narrow scanning of each detected element

In addition, when the positive electrode active material 200 of one embodiment of the present invention is analyzed by XPS, a peak indicating the bonding energy of fluorine with another element is preferably at greater than or equal to 682 eV and less than 685 eV, further preferably at approximately 684.3 eV. The above value is different from 685 eV, which is the bonding energy of lithium fluoride, and 686 eV, which is the bonding energy of magnesium fluoride. That is, in the case where the positive electrode active material 200 of one embodiment of the present invention contains fluorine, the fluorine is preferably in the bonding state other than lithium fluoride and magnesium fluoride.

Furthermore, when the positive electrode active material 200 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to a value of the bonding energy of magnesium oxide. That is, in the case where the positive electrode active material 200 of one embodiment of the present invention contains magnesium, the magnesium is preferably in the bonding state other than magnesium fluoride.

### <<EDX>>

The additive element A contained in the positive electrode active material 200 preferably have a concentration gradient. It is further preferable that the concentration distribution or peak top position be different depending on the additive element A. The concentration distribution includes a concentration gradient. The concentration distribution of the additive element A can be evaluated, for example, by exposing a cross section of the positive electrode active material 200 using FIB (Focused Ion Beam) or the like and analyzing the cross section using EDX, EPMA (electron probe microanalysis), or the like.

In the EDX measurement, to measure a region while scanning is performed and evaluate the region two-dimensionally is referred to as area analysis. The measurement by line scan, which is performed to evaluate the atomic concentration distribution in a positive electrode active material, is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element A in the surface portion 200a, the inner portion 200b, the vicinity of the crystal grain boundary 201, and the like of the positive electrode active material 200 can be semi-quantitatively analyzed. By EDX line analysis, the concentration distribution or peak top of the additive element A can be analyzed. An analysis method using a thinned sample, such as STEM-EDX, is preferred because the method makes it possible to analyze the concentration distribution in the depth direction from the surface toward the center in a specific region of a positive electrode active material without much effect of the distribution in the front-back direction.

EDX area analysis or EDX point analysis of the positive electrode active material 200 of one embodiment of the present invention preferably reveals that the concentration of each additive element A, in particular, the additive element X in the surface portion 200a is higher than that in the inner portion 200b.

For example, when EDX area analysis or EDX point analysis of the positive electrode active material 200 containing magnesium as the additive element X is conducted, the magnesium concentration in the surface portion 200a is preferably higher than the magnesium concentration in the inner portion 200b. Furthermore, when EDX linear analysis is conducted, a peak top of the magnesium concentration in the surface portion 200a preferably exists in a region from the surface of the positive electrode active material 200 to a depth of 3 nm toward the center, further preferably to a depth of 1 nm, and still further preferably to a depth of 0.5 nm. In addition, the magnesium concentration distribution preferably has a gradient where the concentration attenuates, at a position 1 nm away from the peak top, to less than or equal to 60% of the peak top. Furthermore, the magnesium concentration distribution preferably has a gradient where the concentration attenuates, at a position 2 nm away from the peak top, to less than or equal to 30% of the peak top. The position may be away from the peak top toward the surface or the inner portion. The above concentration gradient exists on one of the surface side and the inner portion side.

In the positive electrode active material 200 containing magnesium and fluorine as the additive elements X, the distribution of fluorine preferably overlaps with the distribution of magnesium. For example, a difference in the position between a peak top of the fluorine concentration and a peak top of the magnesium concentration is preferably within 10 nm, further preferably within 3 nm, still further preferably within 1 nm.

Thus, in the EDX line analysis, a peak top of the fluorine concentration in the surface portion 200a preferably appears in a region from the surface of the positive electrode active material 200 to a depth of 3 nm, further preferably to a depth of 1 nm, still further preferably to a depth of 0.5 nm toward the center. It is further preferable that a peak top of the fluorine concentration be exhibited slightly closer to the surface than a peak top of the magnesium concentration is, which increases resistance to hydrofluoric acid. For example, it is preferable that a peak top of the fluorine concentration be exhibited slightly closer to the surface than a peak top of the magnesium concentration is by 0.5 nm or more, further preferably 1.5 nm or more.

In the positive electrode active material 200 containing nickel as the additive element X, a peak top of the nickel concentration in the surface portion 200a preferably appears in a region from the surface of the positive electrode active material 200 to a depth of 3 nm, further preferably to a depth of 1 nm, still further preferably to a depth of 0.5 nm toward the center. When the positive electrode active material 200 contains magnesium and nickel, the distribution of nickel preferably overlaps with the distribution of magnesium. For example, a difference in the position between a peak top of the magnesium concentration and a peak top of the magnesium concentration is preferably within 10 nm, further preferably within 3 nm, still further preferably within 1 nm.

In the case where the positive electrode active material 200 contains aluminum as the additive element Y, the peak top of the magnesium concentration, the nickel concentration, or the fluorine concentration is preferably closer to the surface than the peak top of the aluminum concentration in the surface portion 200a in the EDX line analysis. For example, the peak top of the aluminum concentration preferably appears in a region from the surface of the positive electrode active material 200 to a depth of greater than or equal to 0.5 nm and less than or equal to 50 nm, further preferably to a depth of greater than or equal to 5 nm and less than or equal to 50 nm toward the center.

EDX line, area, or point analysis of the positive electrode active material 200 preferably reveals that the atomic ratio of magnesium Mg to cobalt Co (Mg/Co) at a peak top of the magnesium concentration is preferably greater than or equal to 0.05 and less than or equal to 0.6, further preferably greater than or equal to 0.1 and less than or equal to 0.4. The atomic ratio of aluminum Al to cobalt Co (Al/Co) at a peak top of the aluminum concentration is preferably greater than or equal to 0.05 and less than or equal to 0.6, further preferably greater than or equal to 0.1 and less than or equal to 0.45. The atomic ratio of nickel Ni to cobalt Co (Ni/Co) at a peak top of the nickel concentration is preferably greater than or equal to 0 and less than or equal to 0.2, further preferably greater than or equal to 0.01 and less than or equal to 0.1. The atomic ratio of fluorine F to cobalt Co (F/Co) at a peak top of the fluorine concentration is preferably greater than or equal to 0 and less than or equal to 1.6, further preferably greater than or equal to 0.1 and less than or equal to 1.4.

According to results of the EDX line analysis, where the surface of the positive electrode active material 200 is can be estimated in the following manner, for example. A point where the detected amount of an element which uniformly exists in the inner portion 200b of the positive electrode active material 200, e.g., oxygen or cobalt, is ½ of the detected amount thereof in the inner portion 200b is assumed to be the surface.

Since the positive electrode active material 200 is a composite oxide, the detected amount of oxygen can be used to estimate where the surface is. Specifically, an average value Oₐᵥₑ of the oxygen concentration in a region of the inner portion 200b where the detected amount of oxygen is stable is calculated first. At this time, in the case where oxygen O_{background} which is probably led from chemical adsorption or the background is detected in a region that is obviously outside the surface, O_{background} can be subtracted from the measurement value to obtain the average value Oₐᵥₑ of the oxygen concentration. The measurement point where the measurement value which is closest to ½ of the average value Oₐᵥₑ, i.e., ½Oₐᵥₑ, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is less likely to be affected by chemical adsorption and is thus suitable for estimating where the surface is.

When the line analysis or the area analysis is performed on the positive electrode active material 200, the atomic ratio of the additive element A to cobalt Co (A/Co) in the vicinity of the crystal grain boundary 201 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the linear analysis or area planar analysis is performed on the positive electrode active material 200 containing magnesium as the additive element X, the atomic ratio of magnesium to cobalt (Mg/Co) in the vicinity of the crystal grain boundary 201 is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

### <<EPMA>>

Quantitative analysis of elements can be conducted also by electron probe microanalysis (EPMA). In area analysis, distribution of each element can be analyzed.

EPMA area analysis of a cross section of the positive electrode active material 200 of one embodiment of the present invention preferably reveals that one or two or more selected from the additive elements A have a concentration gradient, as in the EDX analysis results. For example, it is further preferable that the additive elements A exhibit concentration peaks at different depths from a surface. The preferred ranges of the concentration peaks of the additive elements A are the same as those of the case of EDX.

Note that In EPMA, a region from a surface to a depth of approximately 1 μm is analyzed. Thus, the quantitative value of each element is sometimes different from measurement results obtained by other analysis methods. For example, when area analysis is performed by EPMA on the positive electrode active material 200, the concentrations of the additive elements A present in the surface portion 200a might be lower than the results obtained in XPS.

<<Charge Curve and dQ/dV Curve>>

The positive electrode active material 200 of one embodiment of the present invention sometimes shows a characteristic voltage change along with charging. A voltage change can be read from a dQ/dV curve, which can be obtained by differentiating capacitance (Q) in a charge curve with voltage (V) (dQ/dV). There should be an unbalanced phase change and a significant change in the crystal structure between before and after a peak in the dQ/dV curve. Note that in this specification and the like, an unbalanced phase change refers to a phenomenon that causes a nonlinear change in physical quantity.

The positive electrode active material 200 of one embodiment of the present invention sometimes shows a broad peak at around 4.55 V in a dQ/dV curve. The peak at around 4.55 V reflects a change in voltage at the time of the phase change from the O3 type structure to the O3′ type structure. This means that when this peak is broad, a change in the energy necessary for extraction of lithium is smaller or in other words, a change in the crystal structure is smaller, than when the peak is sharp. These changes are preferably small, in which case the influence of a shift in CoO₂ layers and that of a change in volume are little.

Specifically, when the maximum value appearing at greater than or equal to 4.5 V and less than or equal to 4.6 V in a dQ/dV curve of a charge curve is a first peak, the first peak preferably has a full width at half maximum of greater than or equal to 0.10 V to be sufficiently broad. In this specification and the like, the half width of the first peak refers to the difference between HWHM₁ and HWHM₂, where HWHM₁ is an average value of the first peak and a first minimum value, which is the minimum dQ/dV value appearing at greater than or equal to 4.3 V and less than or equal to 4.5 V, and HWHM₂ is an average value of the first peak and a second minimum value, which is the minimum dQ/dV value appearing at greater than or equal to 4.6 V and less than or equal to 4.8 V.

The charging at the time of obtaining a dQ/dV curve can be, for example, constant current charging to 4.9 V at 10 mA/g. In obtaining a dQ/dV value of the initial charging, the above charging is preferably started after discharging to 2.5 V at 100 mA/g before measurement.

Data acquisition at the time of charging can be performed in the following manner, for example: a voltage and a current are acquired at intervals of 1 second or at every 1-mV voltage change. The value obtained by adding the current value and time is charge capacity.

The difference between the n-th data and the n+1-th data of the above charge capacity is the n-th value of a capacity change dQ. Similarly, the difference between the n-th data and the n+1-th data of the above voltage is the n-th value of a voltage change dV.

Note that minute noise has considerable influence when the above data is used; thus, the dQ/dV value may be calculated from the moving average for a certain number of class intervals of the differences in the voltage and the moving average for a certain number of class intervals of the differences in the charge capacity. The number of class intervals can be 500, for example.

Specifically, the average value of the n-th to n+500-th dQ values is calculated and in a similar manner, the average value of the n-th to n+500-th dV values is calculated. The dQ/dV value can be dQ (the average of 500 dQ values)/dV (the average of 500 dV values). In a similar manner, the moving average value of the 500 class intervals can be used for the voltage on the horizontal axis of a dQ/dV curve. In the case where the above-described moving average value of the 500 class intervals is used, the 501^{st} data from the last to the last data are largely influenced by noise and thus are not preferably used for the dQ/dV curve.

In the case where a dQ/dV curve after charging and discharging are performed multiple times is analyzed, the conditions of the charging and discharging performed multiple times may be different from the above-described charge conditions. For example, the charging can be performed in the following manner: constant current charging is performed at 100 mA/g to a freely selected voltage (e.g., 4.6 V, 4.65 V, 4.7 V, 4.75 V, or 4.8 V) and then, constant voltage charging is performed until the current value becomes 10 mA/g. As the discharging, constant current discharging can be performed at 2.5 V and 100 mA/g.

Note that the O3 type structure at the time of the phase change to the O3′ type structure at around 4.55 V has x in LiₓCoO₂ of approximately 0.3. This O3 type structure has the same symmetry as the O3 type structure with x of 1 illustrated in FIG. 17, but is slightly different in the distance between the CoO₂ layers. In this specification and the like, when O3 type structures with different x are distinguished from each other, the O3 type structure with x of 1 is referred to as O3 (2 θ=18.85) and the O3 type structure with x of approximately 0.3 is referred to as 03 (2θ=18.57). This is because the position of the peak appearing at 2θ of approximately 19° in XRD measurement corresponds to the distance between the CoO₂ layers.

<<Discharge Curve and dQ/dV Curve>>

Moreover, when the positive electrode active material 200 of one embodiment of the present invention is discharged at a low current of, for example, 40 mA/g or lower after high-voltage charging, a characteristic change in voltage appears just before the end of discharging, in some cases. This change can be clearly observed by the fact that at least one peak appears within the range to 3.5 V at a voltage lower than that of a peak which appears around 3.9 V in dQ/dV curve calculated from a discharge curve.

### <<ESR>>

The positive electrode active material 200 of one embodiment of the present invention preferably contains cobalt, and nickel and magnesium as the additive elements A. It is preferable that Ni³⁺ be substituted for part of Co³⁺ and Mg²⁺ be substituted for part of Li⁺ accordingly. Accompanying the substitution of Mg²⁺ for Li⁺, the Ni³⁺ might be reduced to be Ni²⁺ Accompanying the substitution of Mg²⁺ for part of Li⁺, Co³⁺ in the vicinity of Mg²⁺ might be reduced to be Co²⁺. Accompanying the substitution of Mg²⁺ for part of Co³⁺, Co³⁺ in the vicinity of Mg²⁺ might be oxidized to be Co⁴⁺.

Thus, the positive electrode active material 200 of one embodiment of the present invention preferably contains one or more of Ni²⁺, Ni³⁺, Co²⁺, and Co⁴⁺. Moreover, the spin density attributed to one or more of Ni²⁺, Ni³⁺, Co²⁺, and Co⁴⁺ per weight of the positive electrode active material 200 is preferably greater than or equal to 2.0×10¹⁷ spins/g and less than or equal to 1.0×10²¹ spins/g. The positive electrode active material 200 preferably has the above spin density, in which case the crystal structure can be stable particularly in a charged state. Note that too high a magnesium concentration might reduce the spin density attributed to one or more of Ni²⁺, Ni³⁺, Co²⁺, and Co⁴⁺.

The spin density of a positive electrode active material can be analyzed by an electron spin resonance (ESR) method, for example.

### <<Surface Roughness and Specific Surface Area>>

The positive electrode active material 200 of one embodiment of the present invention preferably has a smooth surface with little unevenness. A smooth surface with little unevenness indicates that a fusing agent described later adequately functions and the surfaces of the additive element A source and the composite oxide melt. Thus, it is one indication for favorable distribution of the additive element A in the surface portion 200a. Favorable distribution means that the concentration distribution of the additive element A is uniform in the surface portion 200a, for example.

A smooth surface with little unevenness can be recognized from, for example, a cross-sectional SEM image or a cross-sectional TEM image of the positive electrode active material 200 or the specific surface area of the positive electrode active material 200.

The level of the surface smoothness of the positive electrode active material 200 can be quantified from its cross-sectional SEM image, as described below, for example.

First, the positive electrode active material 200 is processed with an FIB or the like such that its cross section is exposed. At this time, the positive electrode active material 200 is preferably covered with a protective film, a protective agent, or the like. Next, a SEM image of the interface between the positive electrode active material 200 and the protective film or the like is taken. The SEM image is subjected to noise processing using image processing software. For example, the Gaussian Blur (σ=2) is performed, followed by binarization. In addition, interface extraction is performed using image processing software. Moreover, an interface line between the positive electrode active material 200 and the protective film or the like is selected with an automatic selection tool or the like, and data is extracted to spreadsheet software or the like. With the use of the function of the spreadsheet software or the like, correction is performed using regression curves (quadratic regression), parameters for calculating roughness are obtained from data subjected to slope correction, and root-mean-square surface roughness (RMS) is obtained by calculating standard deviation. This surface roughness refers to the surface roughness of part of the particle periphery (at least 400 nm) of the positive electrode active material.

On the surface of the particle of the positive electrode active material 200 of this embodiment, root-mean-square (RMS) surface roughness, which is an index of roughness, is preferably root-mean-square surface roughness (RMS) less than 3 nm, further preferably less than 1 nm, still further preferably less than 0.5 nm.

Note that the image processing software used for the noise processing, the interface extraction, or the like is not particularly limited, and for example, “ImageJ” can be used. In addition, the spreadsheet software or the like is not particularly limited, and Microsoft Office Excel can be used, for example.

For example, the level of surface smoothness of the positive electrode active material 200 can also be quantified from the ratio of an actual specific surface area S_{R} measured by a constant-volume gas adsorption method to an ideal specific surface area Sᵢ.

The ideal specific surface area Sᵢ is calculated on the assumption that all the positive electrode active materials have the same diameter as D50, have the same weight, and have ideal spherical shapes.

The median diameter (D50) can be measured with a particle size distribution analyzer or the like using a laser diffraction and scattering method. The specific surface area can be measured with a specific surface area analyzer or the like by a constant-volume gas adsorption method, for example.

In the positive electrode active material 200 of one embodiment of the present invention, the ratio of the actual specific surface area S_{R} to the ideal specific surface area Aᵢ obtained from the median diameter (D50), S_{R}/Sᵢ, is preferably less than or equal to 2.1.

The level of the surface smoothness of the positive electrode active material 200 can be quantified from its cross-sectional SEM image by the following method, for example.

First, a surface SEM image of the positive electrode active material 200 is taken. At this time, conductive coating may be performed as pretreatment for observation. The surface to be observed is preferably vertical to an electron beam. In the case of comparing a plurality of samples, the same measurement conditions and the same observation area are adopted.

Then, the above SEM image is converted into an 8-bit image (which is referred to as a grayscale image) with the use of image processing software (e.g., “ImageJ”). The grayscale image includes luminance (brightness information). For example, in an 8-bit grayscale image, luminance can be represented by 2⁸=256 gradation levels. A dark portion has a low gradation level and a bright portion has a high gradation level. A variation in luminance can be quantified in relation to the number of gradation levels. The value is referred to as a grayscale value. By obtaining such a grayscale value, the unevenness of the positive electrode active material can be evaluated quantitatively.

In addition, a variation in luminance in a target region can also be represented with a histogram. A histogram three-dimensionally shows distribution of gradation levels in a target region and is also referred to as a luminance histogram. A luminance histogram enables visually easy-to-understand evaluation of unevenness of the positive electrode active material.

In the positive electrode active material 200 of one embodiment of the present invention, the difference between the maximum grayscale value and the minimum grayscale value is preferably less than or equal to 120, further preferably less than or equal to 115, still further preferably greater than or equal to 70 and less than or equal to 115. The standard deviation of the grayscale value is preferably less than or equal to 11, further preferably less than or equal to 8, still further preferably greater than or equal to 4 and less than or equal to 8.

### <<Current-Rest-Method>>

The distribution of the additive element A contained in the surface portion of the positive electrode active material 200 of one embodiment of the present invention, such as magnesium, sometimes slightly changes during repeated charging and discharging. For example, in some cases, the distribution of the additive element A becomes more favorable, so that the electronic conduction resistance decreases. Thus, in some cases, the electric resistance, i.e., a resistance component R (0.1 s) with a high response speed measured by a current-rest-method, decreases at the initial stage of the charge and discharge cycles.

For example, when the n-th (n is an integer greater than 1) charging and the n+1-th charging are compared, the resistance component R (0.1 s) with a high response speed measured by a current-rest-method is lower in the n+1-th charging than in the n-th charging. Accordingly, the n+1-th discharge capacity is higher than the n-th discharge capacity in some cases. Also in the case of a positive electrode active material that does not contain any additive element, the second charge capacity can be higher when the second charging and the initial charging are compared, i.e., n=1; thus, n is preferably greater than or equal to 2 and less than or equal to 10, for example. However, n is not limited to the above for the initial stage of the charge and discharge cycles. The stage where the charge and discharge capacity is substantially the same as the rated capacity or is greater than or equal to 97% of the rated capacity can be regarded as the initial stage of the charge and discharge cycles.

### <Additional Features>

The positive electrode active material 200 has a depression, a crack, a concave, a V-shaped cross section, or the like in some cases. These are examples of defects, and when charging and discharging are repeated, dissolution of the transition metal M, breakage of a crystal structure, cracking of the positive electrode active material 200, extraction of oxygen, or the like might be derived from these defects. However, when there is the filling portion 202 illustrated in FIG. 13B that fills such defects, dissolution of the transition metal Mor the like can be inhibited. Thus, the positive electrode active material 200 can have high reliability and excellent cycle performance.

The positive electrode active material 200 may include the projection 203 as illustrated in FIG. 13B, which is a region where the additive element A is unevenly distributed.

As described above, an excessive amount of the additive element A contained in the positive electrode active material 200 might adversely affect insertion and extraction of lithium. The use of such a positive electrode active material 200 for a secondary battery might cause an internal resistance increase, a charge and discharge capacity decrease, and the like. Meanwhile, when the amount of the additive element A is insufficient, the additive element A is not distributed throughout the surface portion 200a, which might diminish the effect of inhibiting degradation of a crystal structure. The additive element A is thus required to be contained in the positive electrode active material 200 at an appropriate concentration; however, the adjustment of the concentration is not easy.

For this reason, when the positive electrode active material 200 includes the region where the additive element A is unevenly distributed, part of the excess additive element A is removed from the inner portion 200b of the positive electrode active material 200, so that the concentration of the additive element A can be appropriate in the inner portion 200b. This can inhibit an internal resistance increase, a charge and discharge capacity decrease, and the like when a secondary battery is fabricated. A feature of inhibiting an internal resistance increase in a secondary battery is extremely preferable especially in charging and discharging with a large amount of current such as charging and discharging at 400 mA/g or more.

In the positive electrode active material 200 including the region where the additive element A is unevenly distributed, addition of the excess additive element A to some extent in the formation process is acceptable. This is preferable because the margin of production can be increased.

When a positive electrode active material undergoes charging and discharging under conditions, including charging at 4.5 V or more, or at a high temperature, e.g., an environment temperature of 45° C. or higher, a progressive defect that progresses deeply from the surface toward the inner portion might be generated. Progress of a defect in a positive electrode active material to form a hole can be referred to as pitting corrosion, and the hole generated by this phenomenon is also referred to as a pit in this specification.

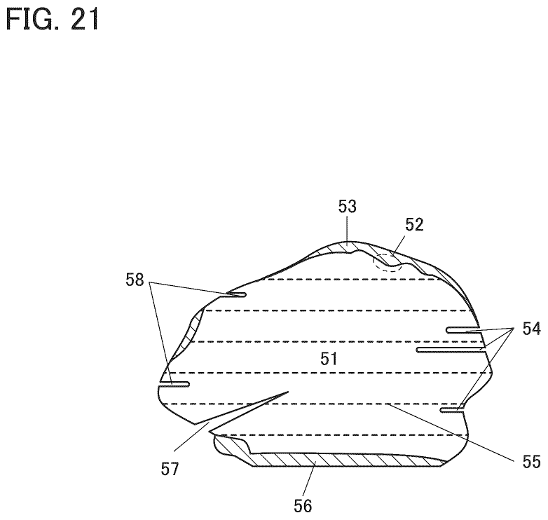

FIG. 21 is a cross-sectional schematic view of a positive electrode active material 51 including pits. A crystal plane 55 parallel to the arrangement of cations is also illustrated. Although a pit 54 and a pit 58 are illustrated as holes since FIG. 21 is a cross-sectional view, their opening shapes are not circular but a wide groove-like shape. Unlike a depression 52, the pit 54 and the pit 58 are likely to be generated parallel to the arrangement of lithium ions as illustrated in the drawing.

In the positive electrode active material 51, surface portions where the additive elements A exist are denoted by reference numerals 53 and 56. A surface portion where the pit is generated contains a smaller amount of the additive element than the surface portions 53 and 56 or contains the additive element A at a concentration lower than or equal to the lower detection limit, and thus probably has a poor function of a barrier film. Presumably, the crystal structure of a composite oxide in the vicinity of a portion where a pit is formed is broken and differs from a layered rock-salt crystal structure. The breakage of the crystal structure might inhibit diffusion and release of lithium ions that are carrier ions; thus, a pit is probably a cause of deterioration of cycle performance.

A source of a pit can be a point defect. It is considered that a pit is generated when a point defect included in a positive electrode active material changes due to repetitive charging and discharging, and the positive electrode active material undergoes chemical or electrochemical erosion or degradation due to the electrolyte or the like surrounding the positive electrode active material. This degradation does not occur uniformly in the surface of the positive electrode active material but occurs locally in a concentrated manner.

In addition, like the crack 57 illustrated in FIG. 21, a defect such as a crack (also referred to as crevice) is sometimes generated by expansion and contraction of the positive electrode active material due to charging and discharging. In this specification, a crack and a pit are different from each other. Immediately after formation of a positive electrode active material, a crack can exist but a pit does not exist. A pit can also be regarded as a hole formed by extraction of some layers of the transition metal M and oxygen due to charging and discharging under high-voltage conditions at 4.5 V or more, or at a high temperature (45° C. or higher), i.e., a portion from which the transition metal M has been eluted. A crack refers to, for example, a surface newly generated by application of physical pressure or a crevice generated because of the crystal grain boundary 201. A crack might be caused by expansion and contraction of a positive electrode active material due to charging and discharging. A pit might be generated from a void inside a positive electrode active material and/or a crack.

### [Formation Method of Positive Electrode Active Material]

A formation method of the positive electrode active material 200 having the distribution of the additive element A, the composition, and/or the crystal structure described in the above embodiment will be described.

In the fabrication process of the positive electrode active material 200, it is preferable that a composite oxide containing lithium and a transition metal be synthesized first, and then the additive element A source be mixed and heat treatment be performed.

In a method of synthesizing a composite oxide containing the additive element A, lithium, and the transition metal M by mixing the additive element A source concurrently with the transition metal M source and a lithium source, it is sometimes difficult to increase the concentration of the additive element A in the surface portion 200a. In addition, after a composite oxide containing lithium and the transition metal M is synthesized, only mixing the additive element A source without performing heating causes the additive element to be just attached to, not dissolved in, the composite oxide containing lithium and the transition metal M. It is difficult to distribute the additive element A favorably without sufficient heating. Therefore, it is preferable that lithium cobalt oxide be synthesized, and then the additive element A source be mixed and heat treatment be performed. The heat treatment after mixing of the additive element A source may be referred to as annealing.

However, annealing at an excessively high temperature may cause cation mixing, which increases the possibility of entry of the additive element A such as magnesium into the transition metal M sites. Magnesium that exists at the transition metal M sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated or sublimated.

In view of the above, a material functioning as a fusing agent is preferably mixed together with the additive element A source. The material can be regarded as functioning as a fusing agent when having a melting point lower than that of the composite oxide containing lithium and the transition metal M. For example, a fluorine compound such as lithium fluoride is preferably used. Adding the fusing agent decreases the melting points of the additive element A source and the composite oxide containing lithium and the transition metal M. The decrease in the melting point makes it easier to favorably distribute the additive element A at a temperature where the cation mixing is less likely to occur.

It is further preferable that heat treatment be performed between the synthesis of the composite oxide containing lithium and the transition metal M and the mixing of the additive element A. This heating is referred to as initial heating in some cases.

Owing to influence of lithium extraction from part of the surface portion 200a of the composite oxide containing lithium and the transition metal M by the initial heating, the distribution of the additive element A becomes more favorable.

Specifically, the distributions of the additive elements A can be easily made different from each other by the initial heating in the following mechanism. First, lithium is extracted from part of the surface portion 200a by the initial heating. Next, the additive element A sources such as a nickel source, an aluminum source, and a magnesium source and the composite oxide containing lithium and the transition metal M including the surface portion 200a that is deficient in lithium are mixed and heated. Among the additive elements A, magnesium is a divalent representative element, and nickel is a transition metal but is likely to be a divalent ion. Therefore, in part of the surface portion 200a, a rock-salt phase containing Co²⁺, which is reduced due to lithium deficiency, Mg²⁺, and Ni²⁺ is formed.

Among the additive elements A, nickel is likely to form a solid solution and is diffused to the inner portion 200b in the case where the surface portion 200a is a composite oxide containing lithium and the transition metal M and having a layered rock-salt crystal structure, but nickel is likely to remain in the surface portion 200a in the case where part of the surface portion 200a has a rock-salt crystal structure.

Furthermore, in such a rock-salt crystal structure, the bond distance between a metal Me and oxygen (Me-O distance) tends to be longer than that in a layered rock-salt crystal structure.

For example, Me-O distance is 0.209 nm and 0.211 nm in Ni_{0.5}Mg_{0.5}O having a rock-salt crystal structure and MgO having a rock-salt crystal structure, respectively. Even when a spinel phase is formed in part of the surface portion 200a, Me-O distance is 0.20125 nm and 0.202 nm in NiAl₂O₄ having a spinel structure and MgAl₂O₄ having a spinel structure, respectively. In each case, Me-O distance is longer than 0.2 nm.

Meanwhile, in a layered rock-salt crystal structure, the bond distance between oxygen and a metal other than lithium is shorter than the above distance. For example, Al—O distance is 0.1905 nm (Li—O distance is 0.211 nm) in LiAlO₂ having a layered rock-salt crystal structure. In addition, Co—O distance is 0.1.9224 nm (Li—O distance is 0.20916 nm) in LiCoO₂ having a layered rock-salt crystal structure.

According to the ionic radius of Shannon (Shannon et al., Acta A 32 (1976) 751.), the ion radius of hexacoordinated aluminum and the ion radius of hexacoordinated oxygen are 0.0535 nm and 0.14 nm, respectively, and the sum of those values is 0.1935 nm.

From the above, aluminum is considered to exist at sites other than lithium sites more stably in a layered rock-salt crystal structure than in a rock-salt crystal structure. Thus, in the surface portion 200a, aluminum is more likely to be distributed in a region having a layered rock-salt phase at a larger depth and/or the inner portion 200b than in a region having a rock-salt phase that is close to the surface.

Moreover, the initial heating is expected to increase the crystallinity of the layered rock-salt crystal structure of the inner portion 200b.

However, the initial heating is not necessarily performed. In some cases, by controlling atmosphere, temperature, time, or the like in another heating step, e.g., annealing, the positive electrode active material 200 having the O3′ type structure when x in LiₓCoO₂ is small can be fabricated.

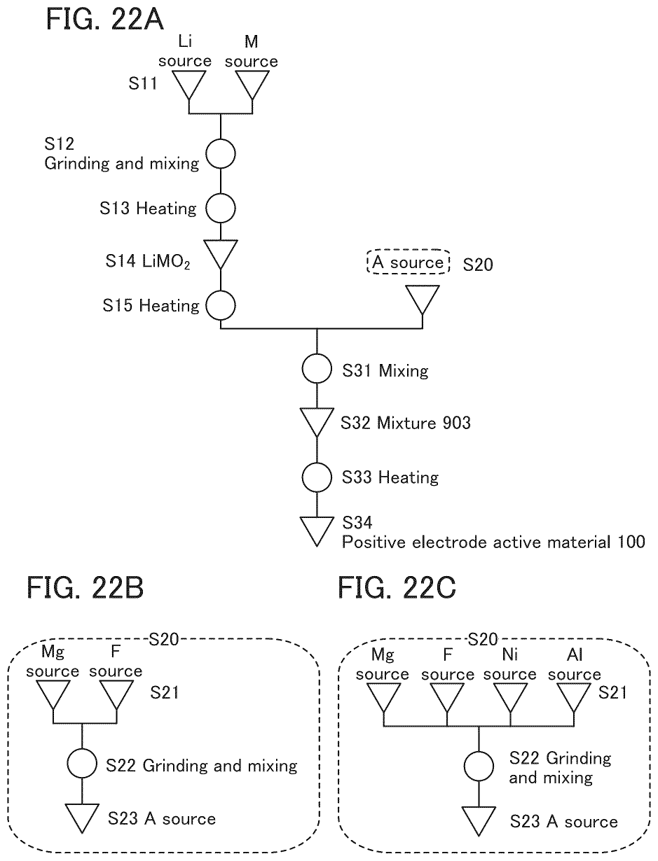

An example of a formation flow of the positive electrode active material 200, in which initial heating is performed, will be described with reference to FIG. 22A to FIG. 22C.

### Step S11

In Step S11 shown in FIG. 22A, a lithium source (Li source) and a transition metal M source (M source) are prepared as materials for lithium and the transition metal M which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

The transition metal M can be selected from the elements belonging to Group 4 to Group 13 of the periodic table and for example, at least one or more of manganese, cobalt, and nickel is used. As the transition metal M, for example, cobalt alone; nickel alone; two metals of cobalt and manganese; two metals of cobalt and nickel; or three metals of cobalt, manganese, and nickel may be used. In the case where cobalt alone is used, the positive electrode active material to be obtained contains lithium cobalt oxide (LCO); in the case where three metals of cobalt, manganese, and nickel are used, the positive electrode active material to be obtained contains lithium nickel cobalt manganese oxide (NCM).

As the transition metal M source, a compound containing the above transition metal M is preferably used and for example, an oxide, a hydroxide, or the like of any of the metals given as examples of the transition metal M can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. Although aluminum is not a transition metal, an aluminum source can be used; as the aluminum source, aluminum oxide, aluminum hydroxide, or the like can be used.

The transition metal M source preferably has a high purity and is preferably a material having a purity of higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the transition metal M source preferably has high crystallinity, and preferably includes single crystal particles, for example. To evaluate the crystallinity of the transition metal M source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal M source.

In the case of using two or more transition metal M sources, the two or more transition metal M sources are preferably prepared to have proportions (mixing ratio) such that a layered rock-salt crystal structure would be obtained.

### Step S12

Next, in Step S12 shown in FIG. 22A, the lithium source and the transition metal M source are ground and mixed to form a mixed material (mixture). The grinding and mixing can be performed by a dry method or a wet method. A wet method is preferable because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal M source be mixed into dehydrated acetone whose moisture content is less than or equal to 10 ppm and which has a purity higher than or equal to 99.5% in the crushing and mixing. With the use of dehydrated acetone with the above-described purity, impurities that might be mixed can be reduced.

A ball mill, a bead mill, or the like can be used for the mixing and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 22A, the above mixed material is heated. The heating temperature is preferably higher than or equal to 800° C. and lower than or equal to 1100° C., further preferably higher than or equal to 900° C. and lower than or equal to 1000° C., still further preferably approximately 950° C. An excessively low temperature might lead to insufficient decomposition and melting of the lithium source and the transition metal M source. An excessively high temperature might lead to a defect due to evaporation of lithium from the lithium source and/or excessive reduction of the metal used as the transition metal M source, for example. The defect is, for example, an oxygen defect which could be induced by a change of trivalent cobalt into divalent cobalt due to excessive reduction, in the case where cobalt is used as the transition metal M.

When the heating time is too short, LiMO₂ is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible or a saggar used at the time of the heating is preferably made of alumina (aluminum oxide), mullite cordierite, magnesia, or zirconia, i.e., preferably contains a highly heat resistant material. Since aluminum oxide is a material which impurities are less likely to enter, the purity of a crucible or a saggar made of alumina is higher than or equal to 99%, preferably higher than or equal to 99.5%. In this embodiment, a crucible made of aluminum oxide with a purity of 99.9% is used. The heating is preferably performed with the crucible or the saggar covered with a lid. This can prevent volatilization or sublimation of a material.

The heated material is ground as needed and may be made to pass through a sieve. Before collection of the heated material, the material may be moved from the crucible to a mortar. As the mortar, a mortar made of aluminum oxide is suitably used. A mortar made of aluminum has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### Step S14

Through the above steps, a composite oxide containing the transition metal M(LiMO₂) can be obtained in Step S14 shown in FIG. 22A. The composite oxide needs to have a crystal structure of a lithium composite oxide represented by LiMO₂, but the composition is not strictly limited to Li:M:O=1:1:2. In the case where cobalt is used as the transition metal M, the composite oxide is referred to as a composite oxide containing cobalt and is represented by LiCoO₂. The composition is not strictly limited to Li:Co:O=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### Step S15

Next, in Step S15 shown in FIG. 22A, the above composite oxide is heated. The heating in Step S15 is the heating performed on the composite oxide, and thus is sometimes referred to as the initial heating. The heating is performed before Step S20 described below, and thus is sometimes referred to as preheating or pretreatment.

By the initial heating, lithium is extracted from part of the surface portion 200a of the composite oxide as described above. In addition, an effect of increasing the crystallinity of the inner portion 200b can be expected. The lithium source and/or transition metal M source prepared in Step S11 and the like might contain impurities. The initial heating can reduce impurities in the composite oxide completed in Step 14.

Through the initial heating, an effect of smoothing the surface of the composite oxide is obtained. Having a smooth surface refers to a state where the composite oxide has little unevenness and is rounded as a whole and its corner portion is rounded. A smooth surface also refers to a surface to which few foreign matters are attached. Foreign matters are deemed to cause unevenness and are preferably not attached to a surface.

For the initial heating, there is no need to prepare a lithium compound source. Alternatively, there is no need to prepare the additive element A source. Alternatively, there is no need to prepare a material functioning as a fusing agent.

When the heating time in this step is too short, a sufficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

The effect of increasing the crystallinity of the internal portion 200b is, for example, an effect of reducing distortion, a shift, or the like derived from differential shrinkage or the like of the composite oxide formed in Step S13.

The heating in Step S13 might cause a temperature difference between the surface and an inner portion of the above composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth through Step S₁₅. This is also rephrased as modification of the surface. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a secondary battery including a composite oxide with a smooth surface as a positive electrode active material, deterioration by charging and discharging is suppressed and a crack in the positive electrode active material can be prevented.

It can be said that when surface unevenness information in one cross section of a composite oxide is quantified with measurement data, a smooth surface of the composite oxide has a surface roughness at least less than or equal to 10 nm. The one cross section is, for example, a cross section obtained in STEM observation.

Note that in Step S14, a composite oxide containing lithium, the transition metal M, and oxygen, synthesized in advance may be used. In this case, Step S11 to Step S13 can be omitted. When Step S15 is performed on the pre-synthesized composite oxide, a composite oxide with a smooth surface can be obtained.

The initial heating might reduce lithium in the composite oxide. The additive element A described for Step S20 or the like below might easily enter the composite oxide owing to the reduction in lithium.

### Step S20

The additive element A may be added to the composite oxide having a smooth surface as long as a layered rock-salt crystal structure can be obtained. When the additive element A is added to the composite oxide having a smooth surface, the additive element A can be uniformly added. It is thus preferable that the initial heating precede the addition of the additive element A. The step of adding the additive element A is described with reference to FIG. 22B and FIG. 22C.

### Step S21

In Step S21 shown in FIG. 22B, the additive element A sources (A sources) to be added to the composite oxide are prepared. A lithium source may be prepared together with the additive element A sources.

As the additive element A, one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or two or more selected from bromine and beryllium can also be used. Note that the additive elements given earlier are more suitably used since bromine and beryllium are elements having toxicity to living things.

When magnesium is selected as the additive element A, the additive element A source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element A, the additive element A source can be referred to as a fluorine source. As the fluorine source, for example, lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride (LaF₃), sodium aluminum hexafluoride, or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used as the lithium source. Another example of the lithium source that can be used in Step S21 is lithium carbonate.

The fluorine source may be a gas, and fluorine (F₂), carbon fluoride, sulfur fluoride, oxygen fluoride, or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed at LiF:MgF₂=65:35 (molar ratio) or the neighborhood thereof, the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride is preferably LiF:MgF₂=x:1 (0≤X≤1.9), further preferably LiF:MgF₂=x:1 (0.1≤x≤0.5), still further preferably LiF:MgF₂=x:1 (x=0.33 and the neighborhood thereof). Note that in this specification and the like, the neighborhood means a value greater than 0.9 times and less than 1.1 times a given value.

Meanwhile, magnesium is preferably added at greater than 0.1 at % and less than or equal to 3 at %, further preferably greater than or equal to 0.5 at % and less than or equal to 2 at %, still further preferably greater than or equal to 0.5 at % and less than or equal to 1 at %, relative to LiCoO₂. When magnesium is added at less than or equal to 0.1 at %, the initial discharge capacity is high but repeated charging and discharging with a large charge depth rapidly lowers the discharge capacity. In the case where magnesium is added at greater than 0.1 at % and less than or equal to 3 at %, both the initial discharge characteristics and charge and discharge cycle performance are excellent even when charging and discharging with a large charge depth are repeated. By contrast, in the case where magnesium is added at greater than 3 at %, both the initial discharge capacity and the charge and discharge cycle performance tend to gradually degrade.

### Step S22

Next, in Step S22 shown in FIG. 22B, the magnesium source and the fluorine source are ground and mixed. Any of the conditions for the grinding and mixing that are described for Step S12 can be selected to perform this step.

A heating step may be performed after Step S22 as needed. Any of the heating conditions described for Step S13 can be selected to perform the heating step. The heating time is preferably longer than or equal to 2 hours and the heating temperature is preferably higher than or equal to 800° C. and lower than or equal to 1100° C.

### Step S23

Next, in Step S23 shown in FIG. 22B, the materials ground and mixed in the above step are collected to give the additive element A source (A source). Note that the additive element A source shown in Step S23 contains a plurality of starting materials and can be referred to as a mixture.

As for the particle diameter of the mixture, the median diameter (D50) is preferably greater than or equal to 600 nm and less than or equal to 20 μm, further preferably greater than or equal to 1 μm and less than or equal to 10 μm. Also when one kind of material is used as the additive element A source, the median diameter (D50) is preferably greater than or equal to 600 nm and less than or equal to 20 μm, further preferably greater than or equal to 1 μm and less than or equal to 10 μm.

Such a pulverized mixture (which may contain only one kind of the additive element A) is easily attached to the surface of a composite oxide uniformly in a later step of mixing with the composite oxide. The mixture of the additive element A source and the like is preferably attached uniformly to the surface of the composite oxide, in which case fluorine and magnesium are easily distributed or dispersed uniformly in a surface portion of the composite oxide after heating. The region where fluorine and magnesium are distributed can be referred to as a surface portion. When there is a region containing neither fluorine nor magnesium in the surface portion, an O3′ type crystal structure might be unlikely to be obtained in a charged state. Note that although fluorine is used in the above description, chlorine may be used instead of fluorine, and a general term “halogen” for these elements can replace “fluorine”.

### Step S21

A process different from that in FIG. 22B is described with reference to FIG. 22C. In Step S21 shown in FIG. 22C, four kinds of additive element A sources to be added to the composite oxide are prepared. In other words, FIG. 22C is different from FIG. 22B in the kinds of the additive element A sources. A lithium source may be prepared together with the additive element A sources.

As the four kinds of additive element A sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 22B. As a nickel source, nickel oxide, nickel hydroxide, or the like can be used. As an aluminum source, aluminum oxide, aluminum hydroxide, or the like can be used.

### Step S22 and Step S23

Next, Step S22 and Step S23 shown in FIG. 22C are similar to the steps described with reference to FIG. 22B.

### Step S31

Next, in Step S31 shown in FIG. 22A, the composite oxide and the additive element A source (A source) are mixed. The ratio of the number M of the transition metal atoms in the composite oxide containing lithium, the transition metal M, and oxygen to the number Mg of magnesium atoms contained in the additive element A is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the composite oxide. For example, conditions with a lower rotation frequency or shorter time than those for the mixing in Step S12 are preferable. In addition, it can be said that a dry method has a milder condition than a wet method. For example, a ball mill or a bead mill can be used for the mixing. When the ball mill is used, a ball made of zirconium oxide is preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C. and lower than or equal to −10° C.

### Step S32

Next, in Step S32 in FIG. 22A, the materials mixed in the above step are collected, whereby a mixture 903 is obtained. At the time of the collection, the materials may be crushed as needed and made to pass through a sieve.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal M source in Step S11, i.e., at the stage of the starting materials of the composite oxide. Then, the heating in Step S13 is performed, so that LiMO₂ to which magnesium and fluorine are added can be obtained. In this case, there is no need to separately perform Step S11 to Step S14 and Step S21 to Step S23. This method can be regarded as being simple and highly productive.

Alternatively, a composite oxide to which magnesium and fluorine are added in advance may be used. When a composite oxide to which magnesium and fluorine are added is used, Step S11 to Step S32 and Step S20 can be skipped. This method can be regarded as being simple and highly productive.

Alternatively, to the composite oxide to which magnesium and fluorine are added in advance, a magnesium source and a fluorine source, or a magnesium source, a fluorine source, a nickel source, and an aluminum source may be further added as in Step S20.

### Step S33

Then, in Step S33 shown in FIG. 22A, the mixture 903 is heated. Any of the heating conditions described for Step S13 can be selected to perform this step. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element A source proceeds. The temperature at which the reaction proceeds is the temperature at which interdiffusion of the elements contained in LiMO₂ and the additive element A source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC) measurement. Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LIMO₂ (the decomposition temperature of LiCoO₂ is 1130° C.). At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S33 is preferably lower than that in Step 13.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a flux in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element A such as magnesium in the surface portion and fabrication of the positive electrode active material having favorable characteristics.

However, since LiF in a gas phase has a specific gravity less than that of oxygen, heating might volatilize or sublimate LiF and in that case, LiF in the mixture 903 decreases. As a result, the function of a fusing agent deteriorates. Therefore, heating needs to be performed while volatilization or sublimation of LiF is inhibited. Note that even when LiF is not used as the fluorine source or the like, Li at the surface of LiMO₂ and F of the fluorine source might react to produce LiF, which might be volatilized or sublimated. Therefore, such inhibition of volatilization or sublimation is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization or sublimation of LiF in the mixture 903.

The heating in this step is preferably performed such that the mixtures 903 are not adhered to each other. Adhesion of the particles of the mixture 903 during the heating might decrease the area of contact with oxygen in the atmosphere and inhibit a path of diffusion of the additive element A (e.g., fluorine), thereby hindering distribution of the additive element A (e.g., magnesium and fluorine) in the surface portion.

It is considered that uniform distribution of the additive element A (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause volatilization or sublimation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions such as the heating temperature and the size and composition of LiMO₂ in Step S14. In the case where LiMO₂ is small, the heating is preferably performed at a lower temperature or for a shorter time than annealing in the case where LIMO₂ is large, in some cases.

When the median diameter (D50) of the composite oxide (LIMO₂) in Step S14 in FIG. 22A is approximately 12 μm, the heating temperature is preferably higher than or equal to 600° C. and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than tor equal to 10 hours and shorter than or equal to 50 hours.

When the median diameter (D50) of the composite oxide (LiMO₂) in Step S14 is approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than tor equal to 10 hours and shorter than or equal to 50 hours.

### Step S34

Next, the heated material is collected in Step S34 shown in FIG. 22A, in which crushing is performed as needed; thus, the positive electrode active material 200 is obtained. Here, the collected positive electrode active material 200 is preferably made to pass through a sieve. Through the above steps, the positive electrode active material 200 of one embodiment of the present invention can be fabricated. The positive electrode active material of one embodiment of the present invention has a smooth surface.

This embodiment can be used in combination with the other embodiments.

### Embodiment 5

In this embodiment, examples of embodiments of the secondary battery described in the above embodiment will be described.

### <Laminated Secondary Battery>

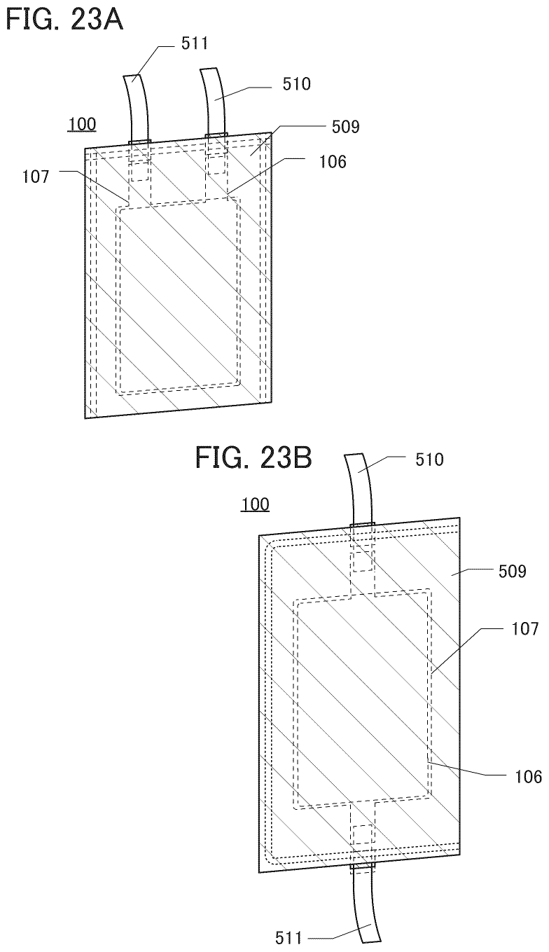

FIG. 23A and FIG. 23B illustrate examples of external views of a laminated secondary battery 100. In FIG. 23A and FIG. 23B, the positive electrode layer 106, the negative electrode layer 107, the electrolyte layer 103, an exterior body 509, a positive electrode lead electrode 510, and a negative electrode lead electrode 511 are included.

### <Method of Fabricating Laminated Secondary Battery>

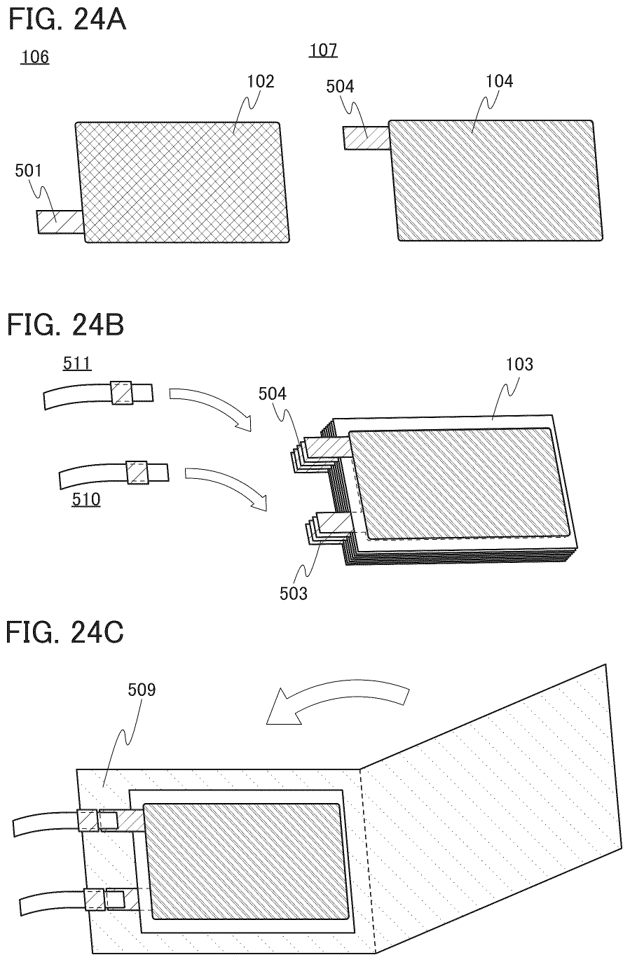

An example of a method for fabricating the laminated secondary battery whose external view is illustrated in FIG. 23A will be described with reference to FIG. 24B and FIG. 24C.

As illustrated in FIG. 24A, the positive electrode layer 106 and the negative electrode layer 107 are prepared. In the positive electrode layer 106, the positive electrode active material layer 102 is formed on a surface of a positive electrode current collector. The positive electrode active material layer 102 may be formed on the other surface of the positive electrode current collector. The positive electrode layer 106 includes a region where the positive electrode current collector is partly exposed (hereinafter, referred to as a tab region), and the tab region is referred to as a positive electrode tab 501. In the negative electrode layer 107, the negative electrode active material layer 104 is formed on a surface of a negative electrode current collector. The negative electrode active material layer 104 may be formed on the other surface of the negative electrode current collector. The negative electrode layer 107 includes a region where the negative electrode current collector is partly exposed, i.e., a tab region, and the tab region is referred to as a negative electrode tab 504. The areas and the shapes of the tab regions are not limited to the examples illustrated in FIG. 24A.

Next, the negative electrode layer 107, the electrolyte layer 103, and the positive electrode layer 106 are stacked. FIG. 24B illustrates the negative electrode layer 107, the electrolyte layer 103, and the positive electrode layer 106 that are stacked. The area of the electrolyte layer 103 is preferably larger than the area of the negative electrode layer 107 and the area of the positive electrode layer 106. FIG. 24B illustrates a structure example in which five negative electrodes and four positive electrodes are stacked. Then, the positive electrode tabs 501 are bonded to each other, and the positive electrode lead electrode 510 is bonded to the tab region on the outermost surface. The bonding is performed by ultrasonic welding, for example. In a similar manner, the negative electrode tabs 504 are bonded to each other, and the negative electrode lead electrode 511 is bonded to the tab region on the outermost surface.

Next, as illustrated in FIG. 24C, the negative electrode layers 107, the electrolyte layers 103, and the positive electrode layers 106 are positioned over the exterior body 509, and the exterior body 509 is folded along a portion shown by a dashed line. After that, the outer edges of the exterior body 509 are bonded to each other. The region used for the bonding is referred to as a bonding region. The bonding is performed by thermocompression bonding, for example.

Next, an ionic liquid can be injected into the exterior body 509 from the inlet of the exterior body 509. A liquid material such as the ionic liquid is preferably introduced in a reduced pressure atmosphere or in an inert atmosphere. Lastly, the inlet is sealed by bonding. In this manner, the laminated secondary battery 100 can be fabricated.

As described in the above embodiment, in the secondary battery of one embodiment of the present invention, a solid electrolyte holds the ionic liquid in the electrolyte layer 103. In other words, the solid electrolyte is impregnated with the ionic liquid at least in the electrolyte layer 103. Such an electrolyte layer 103 is preferable because the ionic liquid does not leak.

This embodiment can be used in combination with the other embodiments.

### Embodiment 6

In this embodiment, an example of an embodiment of the secondary battery described in the above embodiment will be described.

The above-described laminated secondary battery 100 can be bent, for example. That is, the secondary battery 100 has flexibility.

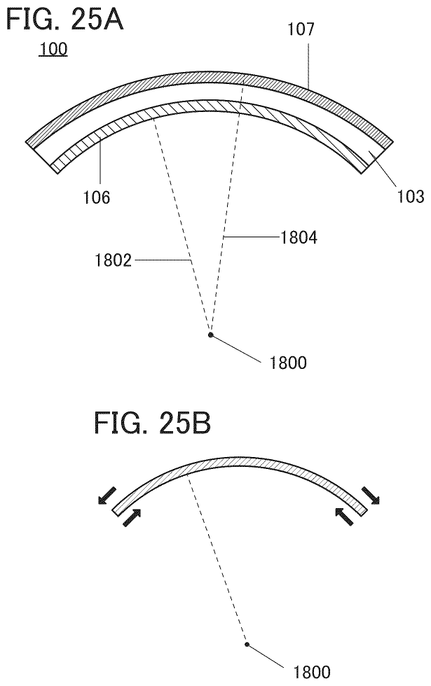

FIG. 25A illustrates the secondary battery 100 in a state of being bent. FIG. 25A illustrates a state where the secondary battery 100 including the positive electrode layer 106, the electrolyte layer 103, and the negative electrode layer 107 is bent to the positive electrode layer 106 side. It is needless to say that the secondary battery 100 can be in a state of being bent to the negative electrode layer 107 side. Since an electrolyte solution such as an ionic liquid does not leak from the electrolyte layer 103 of one embodiment of the present invention, the electrolyte layer 103 is suitably used for the secondary battery 100 in a state of being bent. Note that the state of being bent includes a state where a cross section of the secondary battery 100 has a shape including an arc-like portion.

The minimum unit to form a secondary battery is referred to as a battery unit, and the battery unit includes the positive electrode layer 106, the electrolyte layer 103, and the negative electrode layer 107. The secondary battery 100 of one embodiment of the present invention may include a plurality of the battery units. That is, the secondary battery 100 may have a structure in which the plurality of battery units are stacked. Since an electrolyte solution such as an ionic liquid does not leak from the electrolyte layer 103 of one embodiment of the present invention, the electrolyte layer 103 is suitable for the case where the units are stacked.

Although FIG. 25A illustrates one battery unit, a structure in which a plurality of battery units are stacked may be employed.

Note that the secondary battery 100 includes an exterior body or the like; the exterior body described in the above embodiment can follow a bent battery unit. Thus, the exterior body is not illustrated in FIG. 25A.

Next, the state of being bent is described in detail. As illustrated in FIG. 25A, in the secondary battery 100, a radius 1802 of curvature of a layer closer to a center 1800 of curvature, e.g., the positive electrode layer 106, is smaller than a radius 1804 of curvature of a layer farther from the center 1800 of curvature, e.g., the negative electrode layer 107. For easy bending, a layer whose radius of curvature is small, e.g., the positive electrode layer 106, preferably has a smaller thickness than the negative electrode layer 107.

When the secondary battery 100 is bent as illustrated in FIG. 25A, compressive stress is applied to the surface of the positive electrode layer 106 and tensile stress is applied to the surface of the negative electrode layer 107 as indicated by arrows in FIG. 25B. To reduce the compressive stress, a layer whose radius of curvature is small, e.g., the positive electrode layer 106, may have a larger thickness than the negative electrode layer 107.

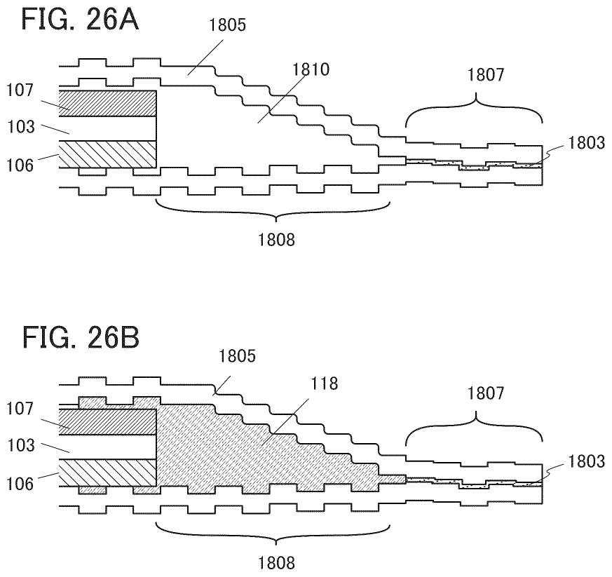

A structure in which an exterior body is provided with depressions and projections will be described as an embodiment for reducing the compressive stress and the tensile stress with reference to FIG. 26A and FIG. 26B.

Depressions and projections are formed on the surface of an exterior body 1805 and look like a pattern. As is observed in a cross section of the exterior body 1805, when the exterior body is provided with projections, depressions are formed at the same time, and when the exterior body is provided with depressions, projections are formed at the same time. That is, it is not necessary to form both depressions and projections on the exterior body because when either of them is formed, the other is formed at the same time.

The exterior body 1805 can reduce the compressive stress and the tensile stress. That is, the secondary battery 100 can change its shape within a range in which the radius of curvature of the exterior body on a side closer to the center of curvature is greater than or equal to 30 mm, preferably greater than or equal to 10 mm.

An end portion of the exterior body 1805 illustrated in FIG. 26A and FIG. 26B has a bonding region 1807. The bonding region 1807 is a region where the exterior bodies 1805 are bonded by thermocompression bonding or the like. In the bonding region 1807, an adhesive layer 1803 is preferably positioned between the exterior bodies 1805.

In the bonding region 1807, depressions or projections provided above and below the exterior bodies 1805 preferably overlap with each other. Since the depressions or the projections overlap with each other, depressions or projections may be additionally formed on the exterior bodies 1805 when the exterior bodies are bonded. Such a structure can increase the bonding strength.

FIG. 26A illustrates the secondary battery 100 in which a space 1810 is in a region 1808, which is in the end portion of the exterior body 1805 and is not the bonding region 1807.

FIG. 26B illustrates the secondary battery 100 in which the ionic liquid 118 is in the region 1808, which is in the end portion of the exterior body 1805 and is not the bonding region 1807. Although the ionic liquid 118 is held in the electrolyte layer 103, the ionic liquid 118 might leak in the case of a bent secondary battery. In the case where the region 1808 is not filled with the ionic liquid 118, a structure in which the ionic liquid 118 and a space are in the region 1808 in FIG. 26B may be employed. Since the adhesion of the exterior body 1805 is high, the ionic liquid 118 does not leak from the exterior body 1805.

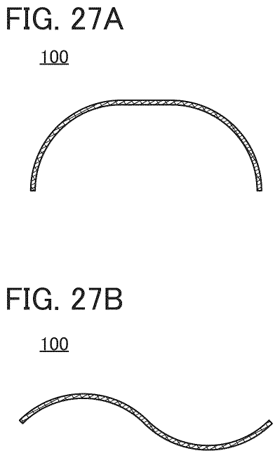

The shape of the secondary battery 100 in a state of being bent in a cross-sectional view is not limited to a simple arc shape and may be a shape partly including an arc. For example, a shape illustrated in FIG. 27A, a wavy shape illustrated in FIG. 27B, an S shape, or the like can be used. The above-described exterior body provided with depressions or projections, and the plurality of battery units that are stacked can be used for the secondary battery 100 illustrated in FIG. 27A or FIG. 27B.

In the case where the curved surface of the secondary battery 100 has a shape with a plurality of centers of curvature as illustrated in FIG. 27A or FIG. 27B, the secondary battery can be bent within a range in which the radius of curvature of the exterior body closest to the corresponding center of curvature is greater than or equal to 10 mm, preferably greater than or equal to 30 mm.

In the secondary battery of one embodiment of the present invention, a solid electrolyte holds the ionic liquid in the electrolyte layer 103. In other words, the solid electrolyte is impregnated with the ionic liquid at least in the electrolyte layer 103. Such an electrolyte layer 103 is preferable because the ionic liquid does not leak.

This embodiment can be used in combination with the other embodiments.

### Embodiment 7

In this embodiment, an electronic device including a secondary battery will be described.

As described above, the secondary battery of one embodiment of the present invention is foldable (or has flexibility). That is, the secondary battery of one embodiment of the present invention can have flexibility. The secondary battery of one embodiment of the present invention can be fixed in a state of being bent. The secondary battery of one embodiment of the present invention can change its shape from a state of being bent.

### Structure Example 1

As one embodiment of the present invention, the case where the secondary battery is incorporated in a watch-type electronic device will be described.

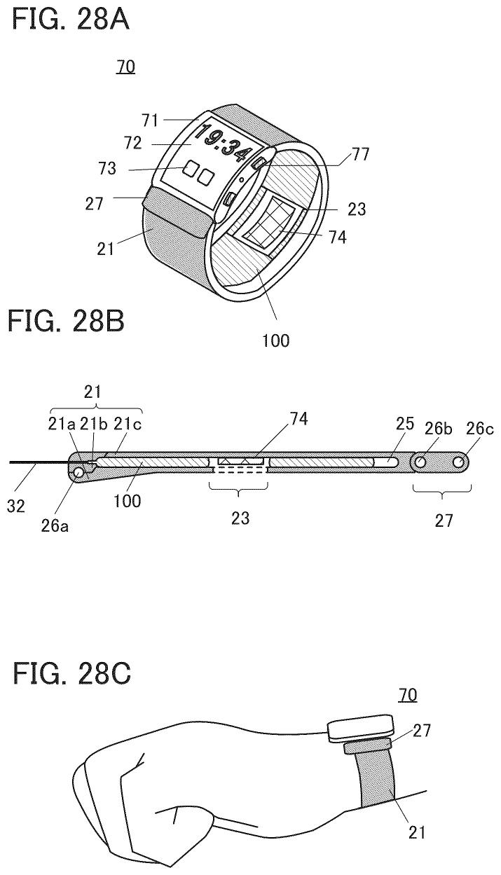

FIG. 28A illustrates a watch-type electronic device 70. The watch-type electronic device 70 includes a frame 71 (the frame is also referred to as a case), a display portion 72, a belt 21, a buckle 27, a sensor 74, an operation button 77, and the like. The watch-type electronic device 70 is capable of executing a variety of applications such as mobile phone calls, e-mailing, viewing and creating texts, music reproduction, Internet communication, and a computer game.

The belt 21 is a component which enables the watch to be worn on an arm, and is also referred to as a band, a strap, or a brace.

The display surface of the display portion 72 may be curved. An image can be displayed on the curved display surface. The display portion 72 includes a touch sensor, and the touch sensor can be provided along the curved display surface. The application operation can be performed by touching the touch sensor with a finger, a stylus, or the like. For example, by touching an icon 73 displayed on the display portion 72, an application associated with the icon can be started.

With the operation button 77, a variety of functions such as power on/off, on/off of wireless communication, setting and cancellation of a silent mode, and setting and cancellation of a power saving mode can be performed. The functions of the operation button 77 can be set freely by setting an operating system incorporated in the watch-type electronic device 70.

The watch-type electronic device 70 is capable of executing near field communication conformable to a communication standard. For example, mutual communication with a headset capable of wireless communication enables hands-free calling. The watch-type electronic device 70 includes an antenna for mutual communication. The display portion 72 or the belt 21 can be provided with the antenna.

The watch-type electronic device 70 preferably include the sensor 74. As the sensor 74, a human body sensor such as a fingerprint sensor, a pulse sensor, or a temperature sensor, a touch sensor, a pressure sensitive sensor, or an acceleration sensor is preferably mounted, for example.

The sensor 74 can be mounted on a position overlapping with the display portion 72. The sensor 74 can be mounted on the belt 21. FIG. 28A illustrates a structure in which the sensor 74 is mounted on the belt 21 as an example.

The sensor 74 preferably includes an LED and a photodiode, in which case a capillary vessel can be irradiated with light from the LED and sensed by the photodiode for recognition of heartbeat. Thus, the belt 21 includes an opening portion 23 in a region overlapping with the sensor 74.

The watch-type electronic device 70 includes the secondary battery 100 of one embodiment of the present invention. Owing to the secondary battery 100 of one embodiment of the present invention, the secondary battery can be mounted on a position overlapping with the display portion 72. The secondary battery can be positioned along the curvature of the display portion 72.

Owing to the secondary battery 100 of one embodiment of the present invention, the secondary battery can be mounted on the belt 21. The secondary battery 100 can be positioned along the curvature of the belt 21. The secondary battery 100 is preferably provided in the belt 21 because the placement area in the belt 21 is larger than that in the display portion 72 and the area of the secondary battery 100 can be increased.

In the case where the sensor 74 is mounted on the belt 21, the secondary battery 100 may be divided into at least two regions with the sensor 74 therebetween.

The charging operation of the secondary battery 100 can be performed by wireless power feeding or wired power feeding.

FIG. 28B illustrates a schematic cross-sectional view of the belt 21 incorporating the secondary battery 100.

The belt 21 includes a cavity portion 25, and the secondary battery 100 is positioned in the cavity. In addition, the sensor 74 can be positioned in the cavity. The belt 21 includes the opening portion 23 at a position overlapping with the sensor 74. The opening portion 23 is also referred to as a window.

The belt 21 contains a stainless steel material, a leather material, a resin material, or the like, and the belt 21 at least includes a lower part 21a, a middle part 21b, and an upper part 21c to include the cavity portion 25. The lower part 21a can be bonded to the upper part 21c with the middle part 21b therebetween.

Part of a lead electrode 32 included in the secondary battery 100 can project from the middle part 21b and can be exposed to the outside. This means that the lead electrode 32 of the secondary battery 100 is preferably fixed to the middle part 21b and then the lower part 21a and the upper part 21c are preferably fixed to the middle part 21b.

The lead electrode 32 is electrically connected to a terminal of the electronic device, another circuit board, or the like.

Here, an example in which the belt 21 has holes 26a, 26b, and 26c that penetrate in the width direction. The hole 26a provided on the lead electrode 32 side is provided for connection to a housing (case) of the electronic device using a spring bar or the like, for example. The hole 26b is provided for connecting the belt 21 and the buckle 27. The hole 26c is provided for connecting the buckle 27 and the housing (case) of the electronic device.

The watch-type electronic device 70 can be worn by bending the belt 21 along an arm as illustrated in FIG. 28C.

### Modification Example 1

A mode in which the belt 21 can be bent along an arm or stretched is described. When the belt 21 is bent along an arm, the thickness of a portion including the cavity portion 25 in the belt 21 is smaller than the thicknesses of other portions in some cases. In that case, the secondary battery 100 might be deformed or damaged when great force is locally applied in a direction perpendicular to the surface of the belt 21 from the outside. Thus, a protective member for protecting the surface of the secondary battery 100 is preferably provided inside the belt 21.

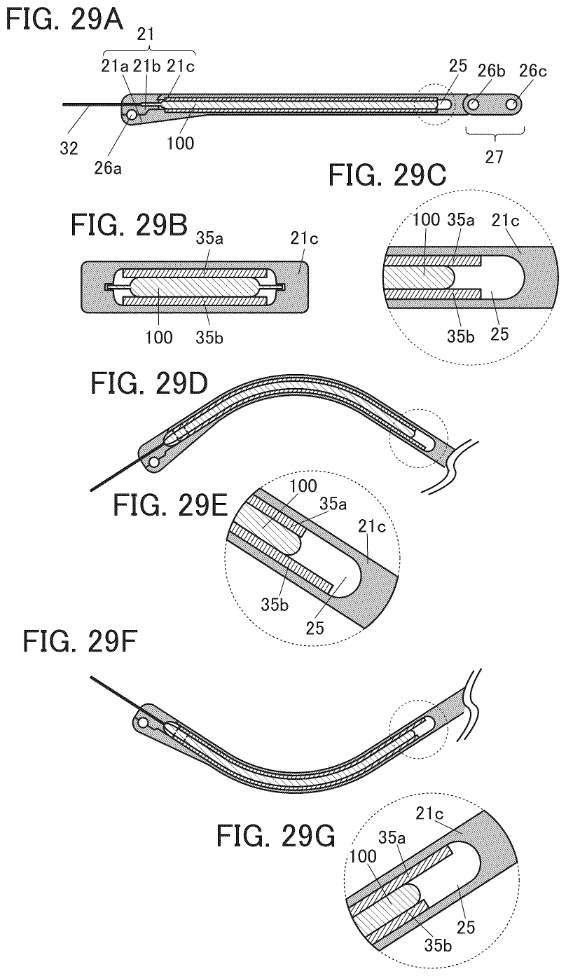

FIG. 29A is a schematic cross-sectional view of the belt 21 including a protective member. FIG. 29B is a schematic cross-sectional view of the belt 21 in the width direction. FIG. 29A and FIG. 29B illustrate a plate portion 35a and a plate portion 35b each of which is a protective member. As illustrated in FIG. 29A and FIG. 29B, the secondary battery 100 is provided in the belt 21 in a state of being sandwiched between the plate portion 35a and the plate portion 35b.

FIG. 29C is an enlarged view of a region surrounded by a dashed line in FIG. 29A. As illustrated in FIG. 29C, the plate portion 35a and the plate portion 35b are preferably large in the length direction so that their end portions are positioned outward from the secondary battery 100. As illustrated in FIG. 29B, the plate portion 35a and the plate portion 35b are preferably larger than the width of the secondary battery 100.

In the case where the belt 21 is bent and used here, it is preferable that the secondary battery 100 be not fixed to the plate portion 35a nor the plate portion 35b. That is, the secondary battery 100, the plate portion 35a, and the plate portion 35b preferably change their shapes independently by being shifted from each other when the belt 21 is bent.

FIG. 29D is a schematic cross-sectional view of the belt 21 bent so that the plate portion 35b lies on the inward side, and FIG. 29E is an enlarged view of a region surrounded by a dashed line in FIG. 29D.

At this time, the secondary battery 100 is provided so that the neutral plane of the upper part 21c of the belt 21 is positioned in a substantially central portion of the secondary battery 100. Therefore, the relative positions of the end portion of the secondary battery 100 and the upper part 21c of the belt 21 hardly change when the belt 21 is bent. By contrast, the plate portion 35a which lies on the outward side in the bending changes its shape so that the end portion is apart from an inner wall of the upper part 21c of the belt 21. The plate portion 35b which lies on the inward side in the bending changes its shape so that the end portion is closer to the inner wall of the upper part 21c of the belt 21.

FIG. 29F and FIG. 29G illustrate the case where bending is performed so that the plate portion 35b lies on the outward side. At this time, the end portion of the plate portion 35a slides closer to the inner wall of the upper part 21c of the belt 21, and the end portion of the plate portion 35b slides apart from the inner wall of the upper part 21c of the belt 21.

When a space is provided between the upper part 21c of the belt 21 and the end portion of the plate portion 35a and the end portion of the plate portion 35b in a state where the belt 21 is not bent as described above, the belt 21 can be bent by weak force without the end portion of the plate portion 35a or the plate portion 35b and the upper part 21c of the belt 21 being in contact with each other.

Here, when the lengths of the plate portion 35a and the plate portion 35b are made different from each other, a function of preventing the belt 21 from being bent too much can be achieved.

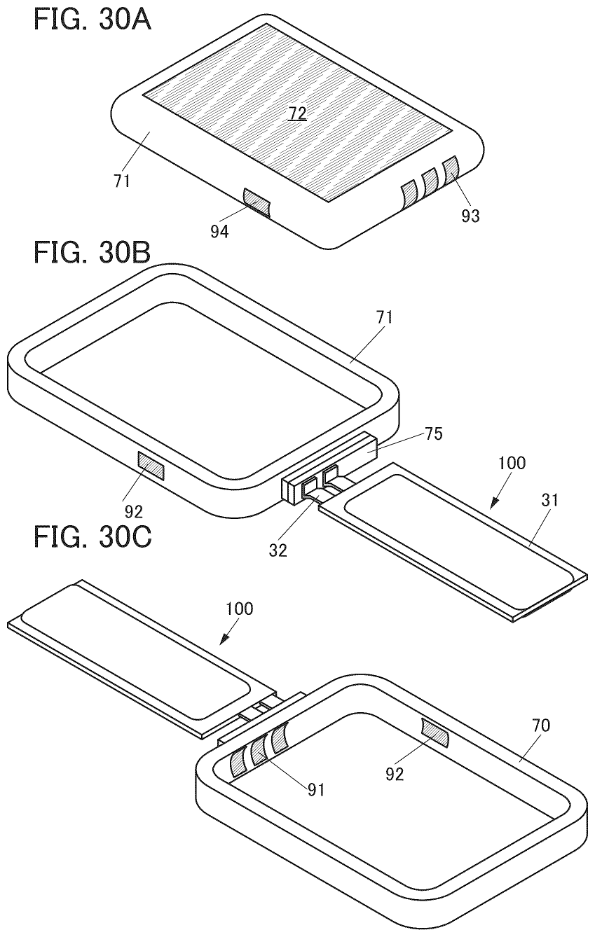

A connection structure between the display portion 72 and the secondary battery 100 in the watch-type electronic device 70 will be described with reference to FIG. 30.

FIG. 30A illustrates the watch-type electronic device 70 when seen from the side of terminals 93 and a terminal 94. The watch-type electronic device 70 includes the display portion 72. FIG. 30B illustrates the frame 71 to which the secondary battery 100 provided in the belt 21 is connected. FIG. 30C is a diagram obtained by rotating FIG. 30B 180 degrees.

The frame 71 has a frame-like shape in which the watch-type electronic device 70 is engaged. An inner surface of the frame 71 is provided with three terminals 91 and a terminal 92.

The watch-type electronic device 70 is provided with the three terminals 93 and the terminal 94 on the frame 71. The three terminals 91 provided on the inner surface of the frame 71 are provided at positions where they are in contact with the terminals 93 when the electronic device is attached. Similarly, the terminal 92 is provided at a position where it is in contact with the terminal 94.

A case 75 is attached to an outer surface of the frame 71. The lead electrodes 32 of the secondary battery 100 are bonded to a pair of terminal portions included in the case 75. A circuit board (not illustrated) is provided in the case 75. The three terminals 91 provided on the frame 71 are electrically connected to a terminal for a positive electrode, a terminal for a negative electrode, and a terminal for outputting temperature data of the circuit board (not illustrated).

The terminal 92 is a portion where the operation button is connected to the terminal 94 included in the watch-type electronic device 70. The terminal 94 may be a physical button or an electrode. In the case where the terminal 94 is a physical button, the terminal 92 is formed using a movable member so that the terminal 94 is pushed with the terminal 92 interposed therebetween when the operation button is pushed, for example. When the terminal 94 is an electrode, an electrical switch is used as the terminal 92 so that the electrical switch has a function of transmitting an electric signal showing conduction or non-conduction to the terminal 94 when the operation button is pushed, for example.

For the frame 71, a material which can withstand molding of an exterior body can be used. For example, a variety of materials such as plastic, metal, an alloy, glass, and wood can be used.

Such a secondary battery 100 can be used as a main power supply or an auxiliary power supply when being attached to the watch-type electronic device 70.

Note that although not illustrated, the secondary battery 100 preferably includes a power receiving mechanism such as a terminal for power receiving or an antenna capable of receiving power wirelessly. In the case where the watch-type electronic device 70 has a function of receiving power, the secondary battery 100 may be charged by transmission of power received by the watch-type electronic device 70 to the secondary battery 100 through the terminals 91.

The watch-type electronic device 70 preferably has a communication function with a smartphone or the like. In the case of communicating wirelessly or in the case of a wireless communication function, the watch-type electronic device 70 can perform communication via an antenna. A chip antenna, a coil antenna, or the like is used as the antenna. The coil antenna is preferably provided in the belt 21. It is needless to say that the chip antenna or the coil antenna can be provided in the display portion 72.

It is possible to use, as a communication protocol or a communication technology of the watch-type electronic device 70, a communications standard such as LTE (Long Term Evolution), GSM (Global System for Mobile Communication: registered trademark), EDGE (Enhanced Data Rates for GSM Evolution), CDMA 2000 (Code Division Multiple Access 2000), or W-CDMA (registered trademark), or a communications standard developed by IEEE such as Wi-Fi (registered trademark), Bluetooth (registered trademark), or ZigBee (registered trademark). The third-generation mobile communication system (3G), the fourth-generation mobile communication system (4G), or the fifth-generation mobile communication system (5G) defined by the International Telecommunication Union (ITU) or the like can be used.

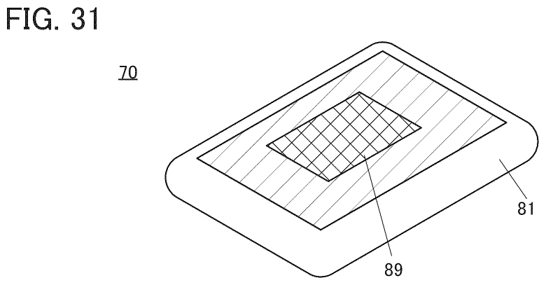

FIG. 31C is a diagram obtained by rotating FIG. 30A 180 degrees. The watch-type electronic device 70 may include a plurality of sensors. For example, a sensor 89 may be provided on the rear side, that is, the arm side, of the watch-type electronic device 70. In that case, the sensor 74 provided on the belt 21 can be omitted.

The sensor 89 allows measurement for health care such as measurement of heart rate. The sensor 89 preferably includes an LED and a photodiode, for example, in which case a capillary vessel can be irradiated with light from the LED and sensed by the photodiode for recognition of heartbeat.

Data obtained by the sensor can be stored in the watch-type electronic device 70. The data can be transmitted to a smartphone via a communication mechanism included in the watch-type electronic device 70.

The contents of this embodiment can be freely combined with the contents in the other embodiments.

### Embodiment 8

In this embodiment, application examples of a secondary battery will be described.

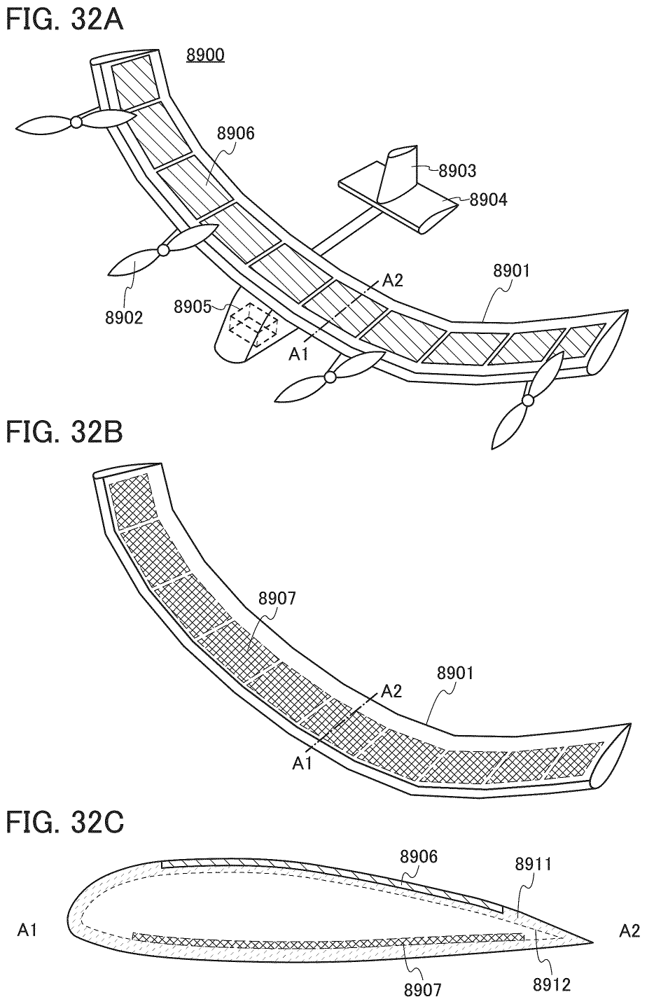

FIG. 32A is a perspective view illustrating an example of a flying object. FIG. 32B is a perspective view for describing the inside of a main wing in FIG. 32A.

A flying object 8900 illustrated in FIG. 32A includes a main wing 8901, a propeller 8902, a vertical tail 8903, a horizontal tail 8904, a control device 8905, and a solar panel 8906. The solar panel is sometimes referred to as a solar cell module.

The flying object 8900 may include a skid. The skid is mounted on the bottom surface of the main wing 8901, for example. A wheel may be provided under the skid.

Furthermore, the flying object 8900 includes a secondary battery 8907 inside the main wing 8901 as illustrated in FIG. 32B. FIG. 32B illustrates an example in which a plurality of the secondary batteries 8907 each having a rough quadrangular top surface are provided inside the main wing 8901. Although FIG. 32B illustrates a state in which the plurality of secondary batteries 8907 are arranged in one column in the inside of the main wing 8901, the plurality of secondary batteries 8907 may be arranged in a plurality of columns. The shape of the top surface of the secondary battery 8907 is not limited to a quadrangle and can be any of a variety of shapes such as a polygon other than a quadrangle, a polygon with rounded corners, a circle, an ellipse, and an L shape.

FIG. 32C is a cross-sectional view taken along dashed-dotted line A1-A2 in FIG. 32A and FIG. 32B.

In FIG. 32C, the solar panel 8906 is provided to be embedded in the surface of a housing 8911 of the main wing 8901. The solar panel 8906 has a region in contact with the housing 8911, for example. In the case where the solar panel 8906 is provided to be embedded in the housing 8911, a light-receiving portion of the solar panel 8906 has a region exposed to the outside. Although FIG. 32C illustrates an example in which the solar panel 8906 is provided to be embedded in the housing 8911, the solar panel 8906 may be provided on the outer surface of the housing 8911.

In FIG. 32C, the secondary battery 8907 is provided along an inner wall 8912 of the housing 8911 of the main wing 8901. The secondary battery 8907 has a region in contact with the inner wall 8912, for example.

The secondary battery of one embodiment of the present invention can be used as the secondary battery 8907, which is preferable because the ionic liquid 118 does not leak from the electrolyte layer 103.

A bendable secondary battery (or may be referred to as a flexible secondary battery) is preferably used as the secondary battery 8907. The main wing 8901 may change its shape in response to an external force while the flying object 8900 flies. A flexible secondary battery is preferably used as the secondary battery 8907 because the secondary battery 8907 can change its shape according to the change in shape of the main wing 8901. As for a flexible secondary battery, the use of a thin film for an exterior body of the secondary battery enables an increase in weight of the secondary battery and a reduction in size of the secondary battery. Since the weight of the flying object 8900 can be reduced, electric power needed for the flight of the flying object 8900 can be reduced. Moreover, since the size of the secondary battery can be reduced, the energy density per volume of the secondary battery can be increased and the flight distance of the flying object 8900 per volume of the secondary battery can be increased.

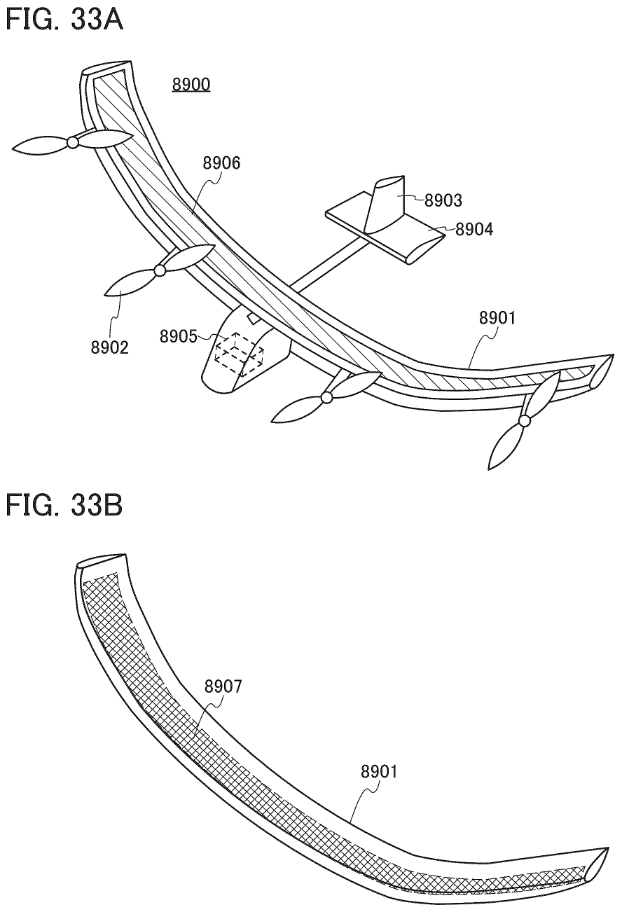

Since a flexible secondary battery is bendable, the top surface and the bottom surface of the main wing 8901 can be smooth curved surfaces as illustrated in FIG. 33A and FIG. 33B. FIG. 33A is a perspective view illustrating an example of a flying object, and FIG. 33B is a perspective view for describing the inside of a main wing in FIG. 33A.

In FIG. 33A, the solar panel 8906 is provided along the smooth top surface of the main wing 8901. As the solar panel 8906, a solar cell module provided over a flexible substrate may be used.

In FIG. 33B, the secondary battery 8907 is provided along an inner wall of a housing of the main wing 8901. As the secondary battery 8907 illustrated in FIG. 33B, a flexible secondary battery is preferably used.

When a flexible secondary battery is used as the secondary battery 8907, the main wing 8901 can have a variety of shapes, leading to an improvement in flight performance of the flying object 8900 in some cases.

The control device 8905 is preferably positioned on the opposite side of the main wing 8901 from the solar panel 8906. For example, in the case where the solar panel 8906 is positioned on the top surface side of the main wing 8901, the control device 8905 is positioned on the bottom surface side of the main wing 8901. The temperature of the solar panel 8906 rises during a period in which the sunlight is received and electric power is generated in some cases. When the control device 8905 is positioned on the opposite side of the main wing 8901, the temperature rise of the control device 8905 can be inhibited and the operations of devices and circuits included in the control device can be performed stably in some cases.

The main wing 8901 of the flying object 8900 may include a heat insulator. The heat insulator is provided along the inner wall 8912 of the housing 8911 or provided to be embedded in the housing 8911, for example. Providing the heat insulator can reduce an influence of external temperature on the inside of the housing 8911.

When the heat insulator is positioned between the solar panel 8906 and the secondary battery 8907, an influence of heat from the solar panel 8906 on the secondary battery 8907 can be reduced in some cases.

In the case of operating the secondary battery 8907 at high temperatures, deterioration of the secondary battery 8907, e.g., a decrease in discharge capacity, occurs in some cases. Furthermore, low temperatures might cause a reduction in output characteristics of the secondary battery 8907. A reduction in temperature fluctuations of the inside of the housing 8911 can extend the lifetime of the secondary battery. Furthermore, the secondary battery can operate stably.

The electric power generated by the solar panel 8906 in the flying object 8900 is preferably stored in the secondary battery 8907. The flying object 8900 includes a power control circuit. The power control circuit has a function of controlling charging and discharging of the secondary battery 8907. Furthermore, the power control circuit preferably has a function of measuring at least one of the amount of light received and the amount of power generated by the solar panel 8906. The electric power generated by the solar panel 8906 is charged into the secondary battery 8907 through the power control circuit. The power control circuit preferably has a function of measuring the remaining power of the secondary battery 8907.

The control device 8905 has a function of controlling the flight of the flying object 8900. The control device 8905 can control the flight of the flying object 8900 by controlling the rotation of the propeller 8902, for example.

The power control circuit has a function of supplying electric power stored in the secondary battery 8907 to the propeller 8902. The power control circuit preferably has a function of converting direct current into alternate current.

At least part of the power control circuit is preferably positioned in the control device 8905. A part of the power control circuit may be provided inside the housing 8911 of the main wing 8901. For example, protection circuits for respective secondary batteries 8907 may be provided as parts of the power control circuit. The protection circuits each have a function of inhibiting one or more of overcharge, overdischarge, charge overcurrent, discharge overcurrent, and a short circuit of the secondary battery, for example. In the case of including a plurality of the secondary batteries 8907 connected in series, the power control circuit preferably includes a cell balancing circuit for making states of charge of the plurality of secondary batteries 8907 uniform.

In the flying object 8900, charging of electric power generated by the solar panel 8906 into the secondary battery 8907 and supply of electric power from the secondary battery 8907 to the propeller 8902 are performed at the same time in some cases.

The flying object 8900 also includes an antenna. The flying object 8900 has a function of performing wireless communication using the antenna. The flying object 8900 may include a plurality of antennas. As the antenna, for example, a multibeam antenna can be used.

The flying object 8900 can function as a wireless base station, for example.

The flying object 8900 can fly in the stratosphere, for example, to provide a stratospheric platform. The flying object 8900 can communicate with a ground-based base station. A plurality of the flying objects 8900 may each form abase station. In that case, communication is preferably performed between the plurality of flying objects. The flying object 8900 may have a function of transmitting and receiving signals to/from an artificial satellite. The flying object 8900 can provide a wireless communication service from the stratospheric platform to a user terminal on the ground. Here, a user terminal is a smartphone, for example. The flying object 8900 circles above the service area of wireless communication in some cases. It is possible to use, as a communication protocol or a communication technology, a communications standard such as LTE (Long Term Evolution), GSM (Global System for Mobile Communication: registered trademark), EDGE (Enhanced Data Rates for GSM Evolution), CDMA 2000 (Code Division Multiple Access 2000), or W-CDMA (registered trademark). The third-generation mobile communication system (3G), the fourth-generation mobile communication system (4G), or the fifth-generation mobile communication system (5G) defined by the International Telecommunication Union (ITU) or the like can be used.

The control device 8905 may include an imaging device. The flying object 8900 can take an image of the air where the flying object 8900 flies, the ground, or the sky using the imaging device.

The control device 8905 may include a sensor (a sensor having a function of measuring force, displacement, position, speed, acceleration, angular velocity, rotational frequency, distance, light, liquid, magnetism, temperature, a chemical substance, sound, time, hardness, electric field, current, voltage, electric power, radiation, flow rate, humidity, gradient, oscillation, a smell, or infrared rays).

The contents of this embodiment can be freely combined with the contents in the other embodiments.

### Embodiment 9

This embodiment describes examples of shapes of several types of secondary batteries described in the foregoing embodiment.

### [Coin-Type Secondary Battery]

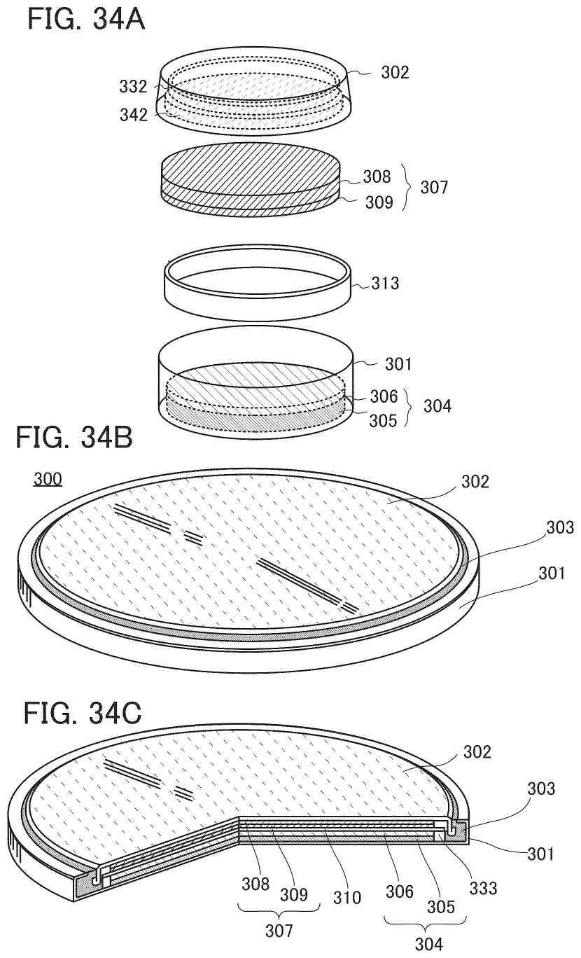

An example of a coin-type secondary battery is described. FIG. 34A is an exploded perspective view of a coin-type (single-layer flat type) secondary battery, FIG. 34B is an external view thereof, and FIG. 34C is a cross-sectional view thereof. Coin-type secondary batteries are mainly used in small electronic devices. In this specification and the like, coin-type batteries include button-type batteries.

For easy understanding, FIG. 34A is a schematic view illustrating overlap (a vertical relation and a positional relation) between components. Thus, FIG. 34A and FIG. 34B do not completely correspond with each other.

In FIG. 34A, a positive electrode 304, a negative electrode 307, a spacer 342, and a washer 332 are overlaid. They are sealed with a negative electrode can 302 and a positive electrode can 301. Note that a gasket for sealing is not illustrated in FIG. 34A. The spacer 342 and the washer 332 are used to protect the inside or fix the position inside the cans at the time when the positive electrode can 301 and the negative electrode can 302 are bonded with pressure. For the spacer 342 and the washer 332, stainless steel or an insulating material is used.

The positive electrode 304 has a stacked-layer structure in which a positive electrode active material layer 306 is formed over a positive electrode current collector 305.

FIG. 34B is a perspective view of a completed coin-type secondary battery.

In a coin-type secondary battery 100, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of each of the positive electrode 304 and the negative electrode 307 used for the coin-type secondary battery 100 is provided with an active material layer.

For the positive electrode can 301 and the negative electrode can 302, a metal having corrosion resistance to an electrolyte solution, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, and the like in order to prevent corrosion due to the electrolyte solution, for example. The positive electrode can 301 and the negative electrode can 302 are electrically connected to the positive electrode 304 and the negative electrode 307, respectively.

As illustrated in FIG. 34C, the positive electrode 304, the negative electrode 307, and the negative electrode can 302 are stacked in this order with the positive electrode can 301 positioned at the bottom, and then the positive electrode can 301 and the negative electrode can 302 are subjected to pressure bonding with the gasket 303 therebetween; as a result, the coin-type secondary battery 100 is fabricated.

With the above structure, the coin-type secondary battery 100 can have high capacity, high charge and discharge capacity, and excellent cycle performance.

### [Cylindrical Secondary Battery]

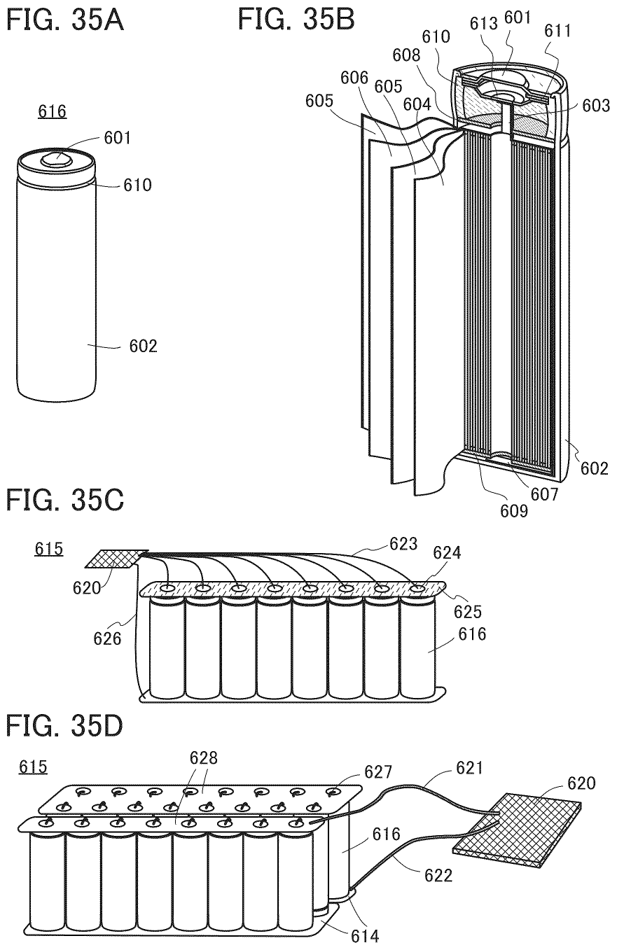

An example of a cylindrical secondary battery is described with reference to FIG. 35A. As illustrated in FIG. 35A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 35B schematically illustrates a cross section of a cylindrical secondary battery. The cylindrical secondary battery illustrated in FIG. 35B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like electrolyte layer 605 located therebetween is provided. Although not illustrated, the battery element is wound around a central axis. One end of the battery can 602 is closed and the other end thereof is opened. For the battery can 602, a metal having corrosion resistance to an electrolyte solution, such as nickel, aluminum, or titanium, an alloy of such a metal, and an alloy of such a metal and another metal (e.g., stainless steel) can be used. The battery can 602 is preferably covered with nickel, aluminum, and the like in order to prevent corrosion due to the electrolyte solution. Inside the battery can 602, the battery element in which the positive electrode, the negative electrode, and the electrolyte layer are wound is provided between a pair of an insulating plate 608 and an insulating plate 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical storage battery are wound, active materials are preferably formed on both surfaces of a current collector. Note that although FIG. 35A to FIG. 35D each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 200 is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC element (Positive Temperature Coefficient) 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. Barium titanate (BaTiO₃)-based semiconductor ceramic or the like can be used for the PTC element.

FIG. 35C illustrates an example of a power storage system 615. The power storage system 615 includes a plurality of the secondary batteries 616. The positive electrodes of the secondary batteries are in contact with and electrically connected to conductors 624 isolated by an insulator 625. The conductor 624 is electrically connected to a control circuit 620 through a wiring 623. The negative electrodes of the secondary batteries are electrically connected to the control circuit 620 through a wiring 626. As the control circuit 620, a protection circuit for preventing overcharge or overdischarge can be used, for example.

FIG. 35D illustrates an example of the power storage system 615. The power storage system 615 includes the plurality of secondary batteries 616, and the plurality of secondary batteries 616 are sandwiched between a conductive plate 628 and a conductive plate 614. The plurality of secondary batteries 616 are electrically connected to the conductive plate 628 and the conductive plate 614 through a wiring 627. The plurality of secondary batteries 616 may be connected in parallel, connected in series, or connected in series after being connected in parallel. With the power storage system 615 including the plurality of secondary batteries 616, large electric power can be extracted.

The plurality of secondary batteries 616 may be connected in series after being connected in parallel.

A temperature control device may be provided between the plurality of secondary batteries 616. The secondary batteries 616 can be cooled with the temperature control device when overheated, whereas the secondary batteries 616 can be heated with the temperature control device when cooled too much. Thus, the performance of the power storage system 615 is less likely to be influenced by the outside temperature.

In FIG. 35D, the power storage system 615 is electrically connected to the control circuit 620 through a wiring 621 and a wiring 622. The wiring 621 is electrically connected to the positive electrodes of the plurality of secondary batteries 616 through the conductive plate 628, and the wiring 622 is electrically connected to the negative electrodes of the plurality of secondary batteries 616 through the conductive plate 614.

### Other Structure Examples of Secondary Battery

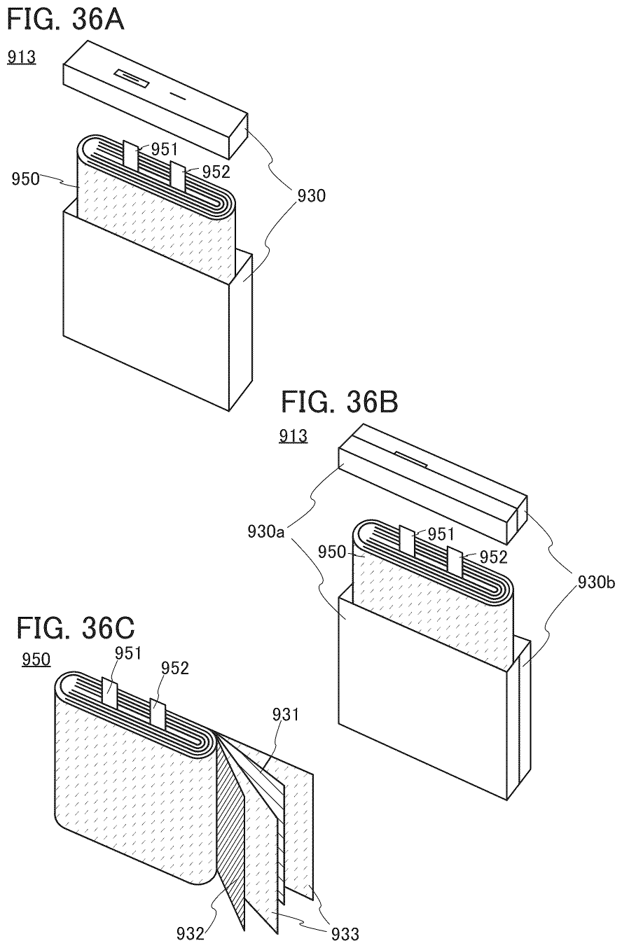

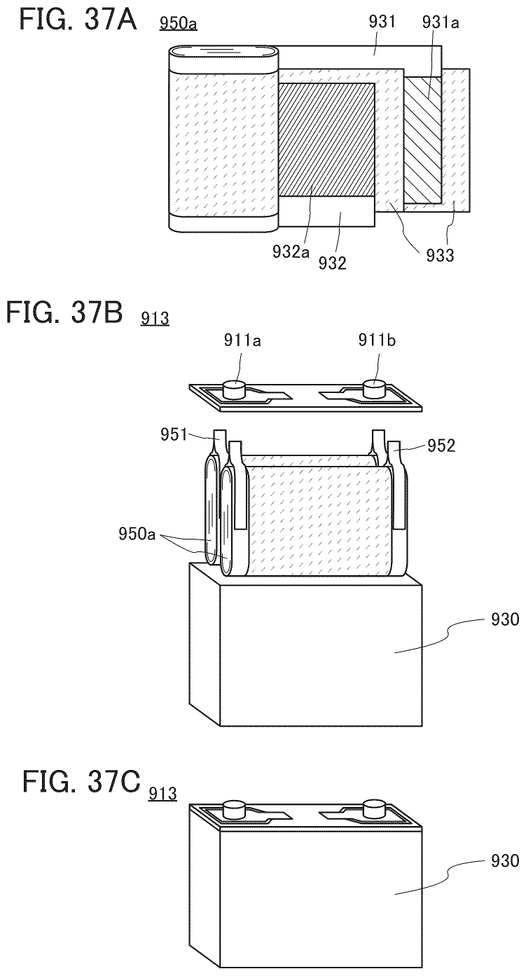

Structure examples of secondary batteries are described with reference to FIG. 36 and FIG. 37.

A secondary battery 913 illustrated in FIG. 36A includes a wound body 950 provided with a terminal 951 and a terminal 952 inside a housing 930. The wound body 950 is immersed in an electrolyte solution inside the housing 930. The terminal 952 is in contact with the housing 930. The use of an insulator or the like inhibits contact between the terminal 951 and the housing 930. Note that in FIG. 36A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 36B, the housing 930 illustrated in FIG. 36A may be formed using a plurality of materials. For example, in the secondary battery 913 illustrated in FIG. 36B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

Furthermore, FIG. 36C illustrates the structure of the wound body 950. The wound body 950 includes a negative electrode 931, a positive electrode 932, and electrolyte layers 933. The wound body 950 is obtained by rolling a sheet of a stack in which the negative electrode 931 and the positive electrode 932 overlap with each other with the electrolyte layer 933 therebetween. Note that a plurality of stacks each including the negative electrode 931, the positive electrode 932, and the electrolyte layers 933 may be further stacked.

As illustrated in FIG. 37A to FIG. 37C, the secondary battery 913 may include a wound body 950a. The wound body 950a illustrated in FIG. 37A includes the negative electrode 931, the positive electrode 932, and the electrolyte layers 933. The negative electrode 931 includes a negative electrode active material layer 931a. The positive electrode 932 includes a positive electrode active material layer 932a.

When the positive electrode active material 200 obtained in Embodiment 1 is used for the positive electrode 932, the secondary battery 913 can have high capacity, high charge and discharge capacity, and excellent cycle performance.

The electrolyte layer 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 37B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 37C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 37B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 36A to FIG. 36C can be referred to for the other components of the secondary battery 913 illustrated in FIG. 37A and FIG. 37B.

### Embodiment 10

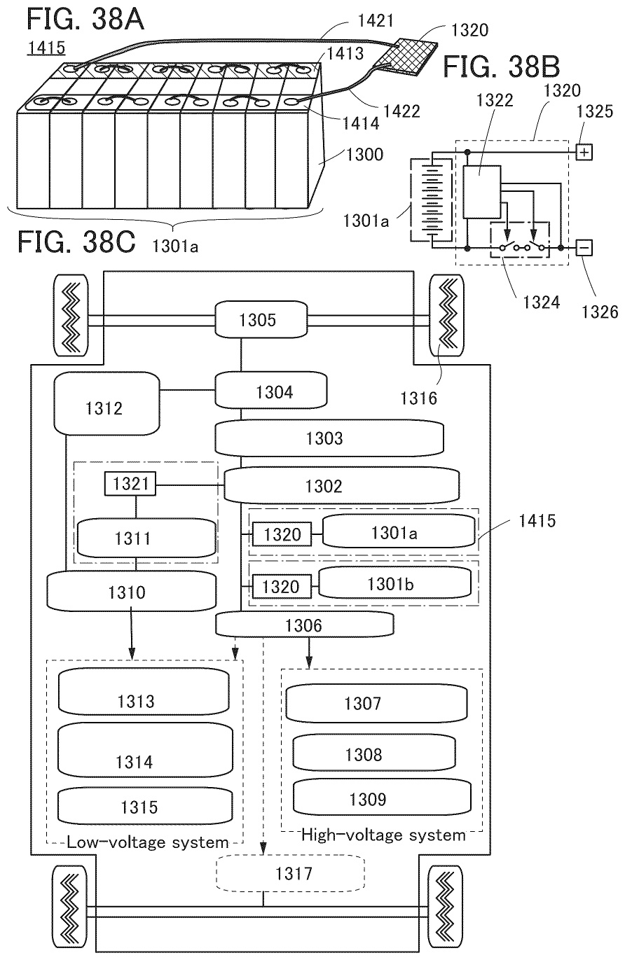

In this embodiment, an example of application to an electric vehicle (EV) is described with reference to FIG. 38.

As illustrated in FIG. 38C, the electric vehicle is provided with first batteries 1301a and 1301b as main secondary batteries for driving and a second battery 1311 that supplies electric power to an inverter 1312 for starting a motor 1304. The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be a wound structure or a stacked-layer structure. Alternatively, the first battery 1301a may be the all-solid-state battery in Embodiment 5. The use of the all-solid-state battery in Embodiment 5 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of secondary batteries, large electric power can be extracted. The plurality of secondary batteries may be connected in parallel, connected in series, or connected in series after being connected in parallel. The plurality of secondary batteries are also referred to as an assembled battery.

In order to cut off electric power from the plurality of secondary batteries, the secondary batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 38A.

FIG. 38A illustrates an example in which nine rectangular secondary batteries 1300 form one battery pack 1415. The nine rectangular secondary batteries 1300 are connected in series; one electrode of each battery is fixed by a fixing portion 1413 made of an insulator, and the other electrode thereof is fixed by a fixing portion 1414 made of an insulator. Although this embodiment describes an example in which the secondary batteries are fixed by the fixing portions 1413 and 1414, they may be stored in a battery container box (also referred to as a housing). Since a vibration or a jolt is assumed to be given to the vehicle from the outside (e.g., a road surface), the plurality of secondary batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) or the like is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In—Ga oxide or an In—Zn oxide may be used as the oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the orientation of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 Nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 Nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic ratios of In, Ga, and Zn to the metal elements contained in the CAC-OS in an In—Ga—Zn oxide are denoted by [In], [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. Alternatively, for example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, energy dispersive X-ray spectroscopy (EDX) is used to obtain EDX mapping, and according to the EDX mapping, the CAC-OS in the In—Ga—Zn oxide can be found to have a structure in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material; as a whole, the CAC-OS has a function of a semiconductor. Separation of the conducting function and the insulating function can maximize each function. Accordingly, when the CAC-OS is used for a transistor, high on-state current (Iₒₙ), high field-effect mobility (μ), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the secondary battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety. When the control circuit portion 1320 is used in combination with a secondary battery including a positive electrode using the positive electrode active material 200 obtained in Embodiment 1, the synergy on safety can be obtained.

The control circuit portion 1320 that includes a memory circuit including a transistor using an oxide semiconductor can also function as an automatic control device for the secondary battery to resolve ten items of causes of instability, such as a micro-short circuit. Examples of functions of resolving the ten items of causes of instability include prevention of overcharge, prevention of overcurrent, control of overheating during charging, cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers not to a state where the positive electrode and the negative electrode of a secondary battery are short-circuited so that charging and discharging are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect estimation to be performed subsequently.

One of the causes of a micro-short circuit is as follows: a plurality of charging and discharging cause an uneven distribution of positive electrode active materials, which leads to local concentration of current in part of the positive electrode and part of the negative electrode or generation of a by-product by a side reaction, which is thought to generate a micro short-circuit.

It can be said that the control circuit portion 1320 not only detects a micro-short circuit but also senses terminal voltage of the secondary battery and controls the charge and discharge state of the secondary battery. For example, to prevent overcharge, an output transistor of a charge circuit and an interruption switch can be turned off substantially at the same time.

FIG. 38B illustrates an example of a block diagram of the battery pack 1415 illustrated in FIG. 38A.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery to be used, and imposes the upper limit of current from the outside, the upper limit of output current to the outside, and the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. Lead storage batteries have disadvantages compared with lithium-ion secondary batteries in that they have a larger amount of self-discharge and are more likely to deteriorate due to a phenomenon called sulfation. There is an advantage that the second battery 1311 can be maintenance-free when a lithium-ion secondary battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

In this embodiment, an example in which a lithium-ion secondary battery is used as both the first battery 1301a and the second battery 1311 is described. As the second battery 1311, a lead storage battery, an all-solid-state battery, or an electric double layer capacitor may be used. For example, the all-solid-state battery in Embodiment 5 may be used. The use of the all-solid-state battery in Embodiment 5 as the second battery 1311 can achieve high capacity and reduction in size and weight.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery to be used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, and a three-phase 200 V outlet with 50 kW, for example. Furthermore, charging can be performed with electric power supplied from external charge equipment by a contactless power feeding method or the like.

For fast charging, secondary batteries that can withstand high-voltage charging have been desired to perform charging in a short time.

The above-described secondary battery in this embodiment uses the positive electrode active material 200 obtained in Embodiment 1. Moreover, it is possible to achieve a secondary battery in which graphene is used as a conductive additive, an electrode layer is formed thick to increase the loading amount while suppressing a reduction in capacity, and the electrical characteristics are significantly improved in synergy with maintenance of high capacity. This secondary battery is particularly effectively used in a vehicle; it is possible to provide a vehicle that has a long cruising range, specifically one charge mileage of 500 km or greater, without increasing the proportion of the weight of the secondary battery to the weight of the entire vehicle.

Specifically, in the above-described secondary battery in this embodiment, the use of the positive electrode active material 200 described in Embodiment 1 can increase the operating voltage of the secondary battery, and the increase in charge voltage can increase the available capacity. Moreover, using the positive electrode active material 200 described in Embodiment 1 in the positive electrode can provide an automotive secondary battery having excellent cycle performance.

Next, examples in which the secondary battery of one embodiment of the present invention is mounted on a vehicle, typically a transport vehicle, will be described.

Mounting the secondary battery on vehicles can achieve next-generation clean energy vehicles such as hybrid vehicles (HVs), electric vehicles (EVs), and plug-in hybrid vehicles (PHVs). The secondary battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft. The secondary battery of one embodiment of the present invention can be a secondary battery with high capacity. Thus, the secondary battery of one embodiment of the present invention is suitable for reduction in size and reduction in weight and is preferably used in transport vehicles.

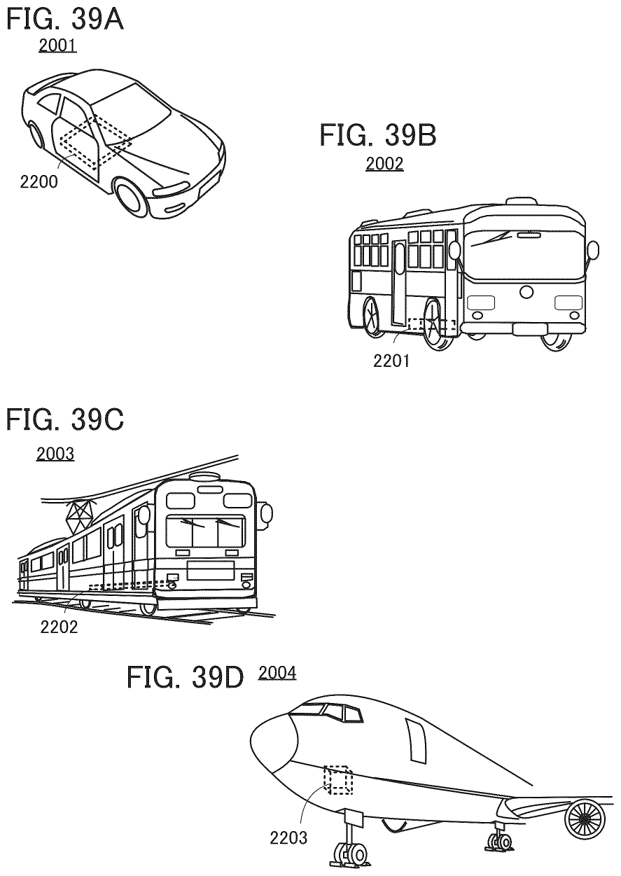

FIG. 39A to FIG. 39D illustrate examples of transport vehicles using one embodiment of the present invention. A motor vehicle 2001 illustrated in FIG. 39A is an electric vehicle that runs using an electric motor as a driving power source. Alternatively, the motor vehicle 2001 is a hybrid vehicle that can appropriately select an electric motor or an engine as a driving power source. In the case where the secondary battery is mounted on the vehicle, an example of the secondary battery described in Embodiment 4 is provided at one position or several positions. The motor vehicle 2001 illustrated in FIG. 39A includes a battery pack 2200, and the battery pack includes a secondary battery module in which a plurality of secondary batteries are connected to each other. Moreover, the battery pack preferably includes a charge control device that is electrically connected to the secondary battery module.

The motor vehicle 2001 can be charged when the secondary battery included in the motor vehicle 2001 is supplied with electric power from external charge equipment by a plug-in system, a contactless charge system, or the like. In charging, a given method such as CHAdeMO (registered trademark) or Combined Charging System may be employed as a charge method, the standard of a connector, and the like as appropriate. The secondary battery may be a charge station provided in a commerce facility or a household power supply. For example, with the use of the plug-in system, the power storage device mounted on the motor vehicle 2001 can be charged by being supplied with electric power from the outside. Charging can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charging can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops and moves. To supply electric power in such a contactless manner, an electromagnetic induction method or a magnetic resonance method can be used.

FIG. 39B illustrates a large transporter 2002 having a motor controlled by electricity, as an example of a transport vehicle. The secondary battery module of the transporter 2002 has a cell unit of four secondary batteries with a nominal voltage of 3.0 V or higher and 5.0 V or lower, and 48 cells are connected in series to have 170 V as the maximum voltage. A battery pack 2201 has the same function as that in FIG. 39A except, for example, the number of secondary batteries configuring the secondary battery module; thus, the description is omitted.

FIG. 39C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series, and the maximum voltage is 600 V, for example. With the use of a secondary battery including a positive electrode using the positive electrode active material 200 described in Embodiment 1, a secondary battery having excellent rate performance and charge and discharge cycle performance can be manufactured, which can contribute to higher performance and a longer lifetime of the transport vehicle 2003. A battery pack 2202 has the same function as that in FIG. 39A except, for example, the number of secondary batteries configuring the secondary battery module; thus, the description is omitted.

FIG. 39D illustrates an aircraft 2004 having a combustion engine as an example. The aircraft 2004 illustrated in FIG. 39D can be regarded as a kind of transport vehicles since it is provided with wheels for takeoff and landing, and has a battery pack 2203 including a secondary battery module and a charge control device; the secondary battery module includes a plurality of connected secondary batteries.

The secondary battery module of the aircraft 2004 has eight 4 V secondary batteries connected in series, which has the maximum voltage of 32 V, for example. The battery pack 2203 has the same function as that in FIG. 39A except, for example, the number of secondary batteries configuring the secondary battery module; thus, the description is omitted.

The contents of this embodiment can be combined with the contents in the other embodiments as appropriate.

### Embodiment 11

In this embodiment, examples in which a vehicle such as a motorcycle or a bicycle is provided with the power storage device of one embodiment of the present invention will be described.

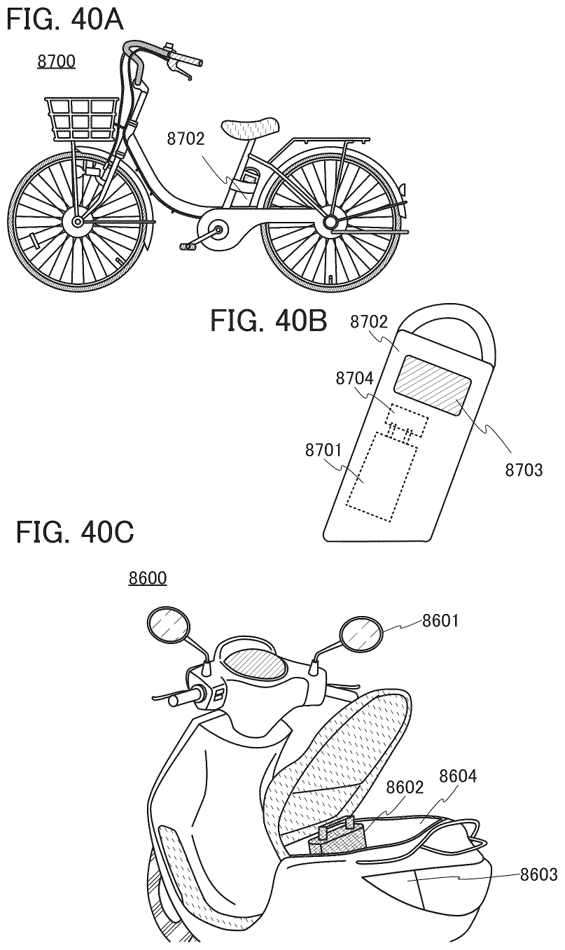

FIG. 40A illustrates an example of an electric bicycle using the power storage device of one embodiment of the present invention. The power storage device of one embodiment of the present invention can be used for an electric bicycle 8700 illustrated in FIG. 40A. The power storage device of one embodiment of the present invention includes a plurality of storage batteries and a protection circuit, for example.

The electric bicycle 8700 includes a power storage device 8702. The power storage device 8702 can supply electricity to a motor that assists a rider. The power storage device 8702 is portable, and FIG. 40B illustrates the state where the power storage device 8702 is detached from the bicycle. A plurality of storage batteries 8701 included in the power storage device of one embodiment of the present invention are incorporated in the power storage device 8702, and the remaining battery capacity and the like can be displayed on a display portion 8703. The power storage device 8702 includes a control circuit 8704 capable of charge control or anomaly detection for the secondary battery, which is exemplified in Embodiment 6. The control circuit 8704 is electrically connected to a positive electrode and a negative electrode of the storage battery 8701. The control circuit 8704 may be provided with a small solid-state secondary battery. When the small solid-state secondary battery is provided in the control circuit 8704, electric power can be supplied to store data in a memory circuit included in the control circuit 8704 for a long time. When the control circuit 8704 is used in combination with a secondary battery including a positive electrode using the positive electrode active material 200 obtained in Embodiment 1, the synergy on safety can be obtained. The secondary battery using the positive electrode active material 200 obtained in Embodiment 1 in the positive electrode and the control circuit 8704 can greatly contribute to elimination of accidents due to secondary batteries, such as fires.

FIG. 40C illustrates an example of a motorcycle using the power storage device of one embodiment of the present invention. A motor scooter 8600 illustrated in FIG. 40C includes a power storage device 8602, side mirrors 8601, and indicator lights 8603. The power storage device 8602 can supply electricity to the indicator lights 8603. The power storage device 8602 including a plurality of secondary batteries including a positive electrode using the positive electrode active material 200 obtained in Embodiment 1 can have high capacity and contribute to a reduction in size.

In the motor scooter 8600 illustrated in FIG. 40C, the power storage device 8602 can be stored in an under-seat storage unit 8604. The power storage device 8602 can be stored in the under-seat storage unit 8604 even when the under-seat storage unit 8604 is small.

The contents of this embodiment can be combined with the contents in the other embodiments as appropriate.

### Embodiment 12

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

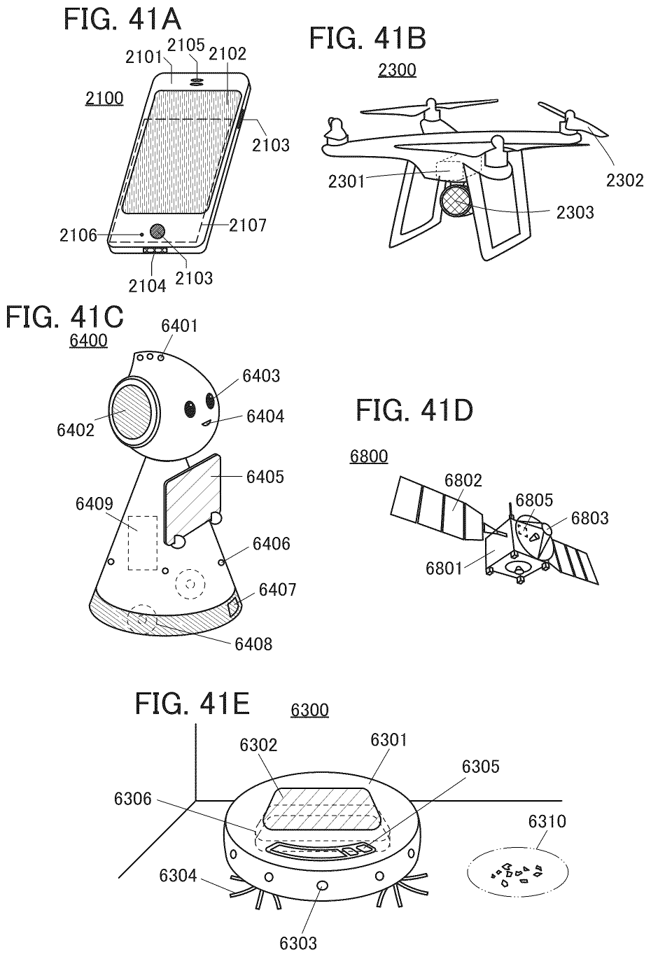

FIG. 41A shows an example of a mobile phone. A mobile phone 2100 includes a housing 2101 in which a display portion 2102 is incorporated, operation buttons 2103, an external connection port 2104, a speaker 2105, a microphone 2106, and the like. The mobile phone 2100 includes a secondary battery 2107. The use of the secondary battery 2107 including a positive electrode using the positive electrode active material 200 described in Embodiment 1 achieves high capacity and a structure that accommodates space saving due to a reduction in size of the housing.

The mobile phone 2100 is capable of executing a variety of applications such as mobile phone calls, e-mailing, viewing and editing texts, music reproduction, Internet communication, and a computer game.

With the operation button 2103, a variety of functions such as time setting, power on/off, on/off of wireless communication, setting and cancellation of a silent mode, and setting and cancellation of a power saving mode can be performed. For example, the functions of the operation button 2103 can be set freely by the operating system incorporated in the mobile phone 2100.

The mobile phone 2100 can employ near field communication conformable to a communication standard. For example, mutual communication with a headset capable of wireless communication enables hands-free calling.

Moreover, the mobile phone 2100 includes the external connection port 2104, and data can be directly transmitted to and received from another information terminal via a connector. In addition, charging can be performed via the external connection port 2104. Note that the charge operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 41B illustrates an unmanned aircraft 2300 including a plurality of rotors 2302. The unmanned aircraft 2300 is sometimes also referred to as a drone. The unmanned aircraft 2300 includes a secondary battery 2301 of one embodiment of the present invention, a camera 2303, and an antenna (not illustrated). The unmanned aircraft 2300 can be remotely controlled through the antenna. A secondary battery including a positive electrode using the positive electrode active material 200 obtained in Embodiment 1 has high energy density and a high level of safety, and thus can be used safely for a long time over a long period of time and is preferable as the secondary battery included in the unmanned aircraft 2300.

FIG. 41C illustrates an example of a robot. A robot 6400 illustrated in FIG. 41C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the secondary battery 6409 of one embodiment of the present invention and a semiconductor device or an electronic component. A secondary battery including a positive electrode using the positive electrode active material 200 obtained in Embodiment 1 has high energy density and a high level of safety, and thus can be used safely for a long time over a long period of time and is preferable as the secondary battery 6409 included in the robot 6400.

FIG. 41D illustrates an example of an artificial satellite 6800. The artificial satellite 6800 includes a body 6801, a solar panel 6802, an antenna 6803, and a secondary battery 6805. The solar panel is sometimes referred to as a solar cell module.

When the solar panel 6802 is irradiated with sunlight, electric power required for operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for operation of the artificial satellite 6800 might not be generated. In order to drive the artificial satellite 6800 even with a small amount of generated electric power, the artificial satellite 6800 is preferably provided with the secondary battery 6805.

The artificial satellite 6800 can generate a signal. The signal is transmitted through the antenna 6803, and can be received by a ground-based receiver or another artificial satellite, for example. When the signal transmitted from the artificial satellite 6800 is received, the position of a receiver that receives the signal can be measured, for example. Thus, the artificial satellite 6800 can constitute a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can have a function of an earth observing satellite, for example.

FIG. 41E illustrates an example of a cleaning robot. A cleaning robot 6300 includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the secondary battery 6306 of one embodiment of the present invention and a semiconductor device or an electronic component. A secondary battery including a positive electrode using the positive electrode active material 200 obtained in Embodiment 1 has high energy density and a high level of safety, and thus can be used safely for a long time over a long period of time and is preferable as the secondary battery 6306 included in the cleaning robot 6300.

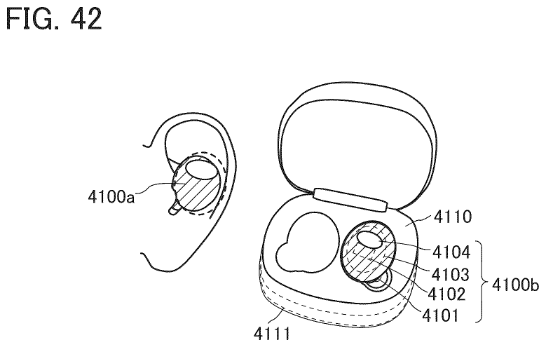

FIG. 42 illustrates an example of wireless earphones. The wireless earphones illustrated here as an example consist of, but not limited to, a pair of main bodies 4100a and 4100b.

The main bodies 4100a and 4100b each include a driver unit 4101, an antenna 4102, and a secondary battery 4103. A display portion 4104 may also be included. Moreover, a substrate where a circuit such as a wireless IC is provided, a terminal for charging, and the like are preferably included. Furthermore, a microphone may be included.

A case 4110 includes a secondary battery 4111. Moreover, a substrate where a circuit such as a wireless IC or a charge control IC is provided, and a terminal for charging are preferably included. Furthermore, a display portion, a button, and the like may be included.

The main bodies 4100a and 4100b can communicate wirelessly with another electronic device such as a smartphone. Thus, sound data and the like transmitted from another electronic device can be played through the main bodies 4100a and 4100b. When the main bodies 4100a and 4100b include a microphone, sound captured by the microphone is transmitted to another electronic device, and sound data obtained by processing with the electronic device can be transmitted to and played through the main bodies 4100a and 4100b. Hence, the wireless earphones can be used as a translator, for example.

The secondary battery 4103 included in the main body 4100a can be charged by the secondary battery 4111 included in the case 4110. As the secondary battery 4111 and the secondary battery 4103, the coin-type secondary battery or the cylindrical secondary battery of the foregoing embodiment, for example, can be used. A secondary battery including a positive electrode using the positive electrode active material 200 obtained in Embodiment 1 has a high energy density; thus, with use of the secondary battery as the secondary battery 4103 and the secondary battery 4111, a structure that accommodates space saving due to a reduction in size of the wireless earphones can be achieved.

This embodiment can be implemented in appropriate combination with the other embodiments.

### Example 1

In this example, the electrolyte layer 103 of one embodiment of the present invention was formed by the method described in Embodiment 3 or the like.

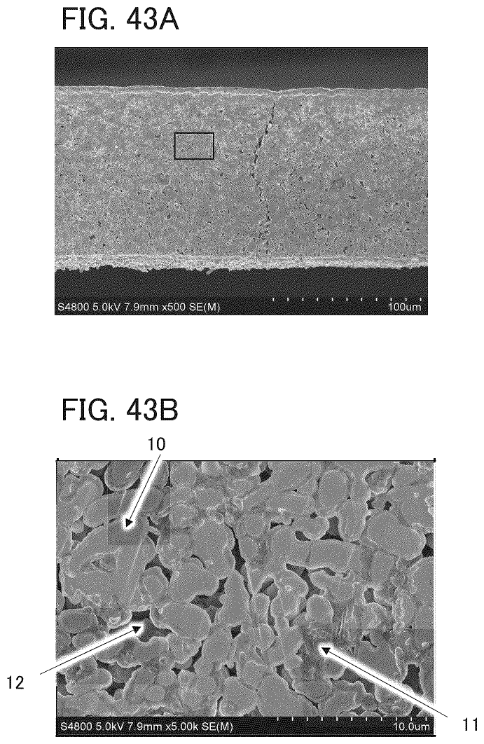

First, a first sheet-like electrolyte layer was obtained through Step S50 to Step S58 in FIG. 11. FIG. 43A and FIG. 43B show plane SEM images of the first sheet-like electrolyte layer. In the SEM observation in this example, an S4800 scanning electron microscope produced by Hitachi High-Tech Corporation was used under the measurement conditions where the acceleration voltage was 5 kV; FIG. 43A shows an image taken at a magnification of 500 times, and FIG. 43B shows an image of a region denoted by a rectangle in FIG. 43A taken at a magnification of 5000 times.

FIG. 43A shows that the thickness of the first sheet-like electrolyte layer is approximately 130 m. In FIG. 43B, a region where particles of LLZAO 10 are connected to each other through a binder 11 and a space 12 are observed.

Next, the first sheet-like electrolyte layer was heated through Step S60 in FIG. 11 to obtain a second sheet-like electrolyte as in Step S61. The heating temperature was 1200° C., and the heating atmosphere was air. For the heating, four parts obtained by stamping out the first sheet-like electrolyte layer each having a size of 12 mmϕ were prepared and placed over an alumina plate as described in Embodiment 3 above. In order to prevent adhesion of the alumina plate to the first sheet-like electrolyte layer, LLZAO powder was dispersed over the alumina plate and the four first sheet-like electrolyte layers. Since another alumina plate was placed above the first sheet-like electrolyte layers, a gap holding material was prepared.

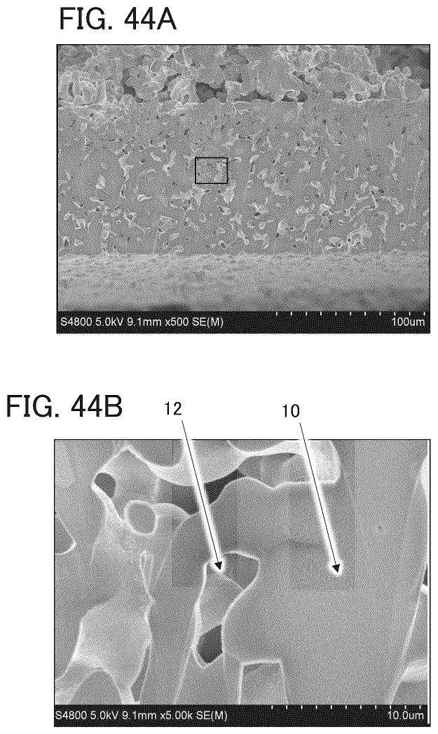

FIG. 44A and FIG. 44B show plane SEM images of the second sheet-like electrolyte layer. FIG. 44A shows an image taken at a magnification of 500 times, and FIG. 44B shows an image of a region denoted by a rectangle in FIG. 44A taken at a magnification of 5000 times. FIG. 44A shows that the thickness of the second sheet-like electrolyte layer is approximately 100 μm. It was found from FIG. 44B that the binder was removed and particles of the LLZAO 10 were bonded to each other to form a sintered body. Note that the space 12 was observed in the sintered body.

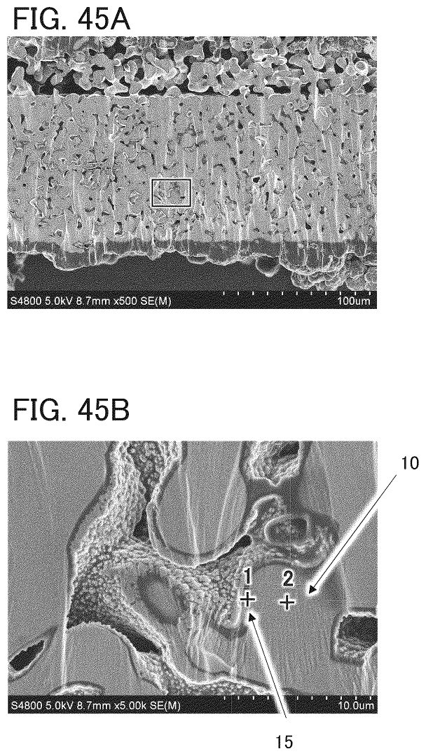

Next, for one hour, the second sheet-like electrolyte layer was impregnated with an ionic liquid containing a lithium salt, specifically, a solution obtained by dissolving LiFSI in EMI-FSI to have a molar concentration of 2.15 mol/L, in a vacuum atmosphere where a differential pressure gauge of a vacuum apparatus indicated −100 kPa. After the impregnation of such an ionic liquid, washing with an organic solvent was performed and plan-view SEM observation was performed. FIG. 45A shows an image taken at a magnification of 500 times, and FIG. 45B shows an image of a region denoted by a rectangle in FIG. 45A taken at a magnification of 5000 times. FIG. 45A shows that the thickness of the second sheet-like electrolyte layer is approximately 100 μm. In FIG. 45B, the LLZAO 10 and the above ionic liquid 15 are observed. Next, results of SEM-EDX analysis on measurement points 1 and 2 shown in FIG. 45B are shown in the table below; the concentration of each element is shown in atomic % (at %).

TABLE 1

| Measurement | Detected element (concentration [at %]) | | | | | | | | |
|---|---|---|---|---|---|---|---|---|---|
| point | La | Zr | Al | N | F | S | C | O | Total |
| 1 | 3.99 | 1.8 | 0.21 | 14.98 | 17.8 | 7.26 | 34.24 | 19.72 | 100 |
| 2 | 16.38 | 11.38 | 1.84 | — | — | — | 12.02 | 58.38 | 100 |

In FIG. 45B, a first layer is observed in the space of the second sheet-like electrolyte layer. According to the EDX analysis results of the measurement point 1 corresponding to the first layer, elements such as nitrogen, fluorine, and sulfur, which were specific to the ionic liquid used in this example, were detected. The results revealed that when the LLZAO was impregnated with the ionic liquid, the ionic liquid entered the space in the sintered body, and the ionic liquid in the space remained even after washing with an organic solvent. Note that lanthanum, zirconium, and aluminum detected at both the measurement points 1 and 2 are elements specific to the LLZAO. Carbon, which is not mentioned above, is an element contained in the ionic liquid. Oxygen is an element derived from both the ionic liquid and the LLZAO.

It was found as described above that when LLZAO, which was a solid electrolyte, formed a sintered body, a space was generated and the space was impregnated with an ionic liquid.

### REFERENCE NUMERALS

100: secondary battery, 101: positive electrode current collector, 102: positive electrode active material layer, 103a: first electrolyte layer, 103b: second electrolyte layer, 103c: third electrolyte layer, 103: electrolyte layer, 104: negative electrode active material layer, 105: negative electrode current collector, 106: positive electrode layer, 107: negative electrode layer, 111: positive electrode active material, 113: solid electrolyte, 117: negative electrode active material, 118: ionic liquid

1. A secondary battery comprising a positive electrode layer; a negative electrode layer; and an electrolyte layer positioned between the positive electrode layer and the negative electrode layer,
wherein the positive electrode layer comprises a positive electrode active material and a first solid electrolyte,
wherein the negative electrode layer comprises a negative electrode active material and a second solid electrolyte,
wherein the electrolyte layer comprises a third solid electrolyte and an ionic liquid, and
wherein a space in the third solid electrolyte is impregnated with the ionic liquid.

2. A secondary battery comprising a positive electrode layer; a negative electrode layer; and an electrolyte layer positioned between the positive electrode layer and the negative electrode layer,
wherein the positive electrode layer comprises a positive electrode active material and a first solid electrolyte,
wherein the negative electrode layer comprises a negative electrode active material and a second solid electrolyte,
wherein the electrolyte layer comprises a third solid electrolyte,
wherein the positive electrode layer, the negative electrode layer, and the electrolyte layer comprise an ionic liquid, and
wherein a space in the third solid electrolyte is impregnated with the ionic liquid.

3. A secondary battery comprising a positive electrode layer; a negative electrode layer; and an electrolyte layer positioned between the positive electrode layer and the negative electrode layer,
wherein the positive electrode layer comprises a positive electrode active material and a first solid electrolyte,
wherein the negative electrode layer comprises a negative electrode active material and a second solid electrolyte,
wherein the electrolyte layer comprises a first electrolyte layer, a second electrolyte layer, and a third electrolyte layer,
wherein the first electrolyte layer to the third electrolyte layer comprise an ionic liquid,
wherein the second electrolyte layer comprises a third solid electrolyte, and
wherein a space in the third solid electrolyte is impregnated with the ionic liquid.

4. A secondary battery comprising a positive electrode layer; a negative electrode layer; and an electrolyte layer positioned between the positive electrode layer and the negative electrode layer,
wherein the positive electrode layer comprises a positive electrode active material and a first solid electrolyte,
wherein the negative electrode layer comprises a negative electrode active material and a second solid electrolyte,
wherein the electrolyte layer comprises a first electrolyte layer and a second electrolyte layer,
wherein the first electrolyte layer and the second electrolyte layer comprise an ionic liquid,
wherein the second electrolyte layer comprises a third solid electrolyte, and
wherein a space in the third solid electrolyte is impregnated with the ionic liquid.

5. The secondary battery according to claim 1,
wherein the positive electrode active material comprises a composite oxide having a layered rock-salt crystal structure, a spinel crystal structure, or an olivine crystal structure.

6. The secondary battery according to claim 5,
wherein the positive electrode active material having a layered rock-salt crystal structure comprises lithium cobalt oxide or lithium nickel-manganese-cobalt oxide.

7. The secondary battery according to claim 1,
wherein the negative electrode active material comprises silicon, tin, gallium, aluminum, germanium, lead, antimony, bismuth, silver, zinc, cadmium, or indium.

8. The secondary battery according to claim 1,
wherein the negative electrode active material comprises a carbon material.

9. An electronic device comprising the secondary battery according to claim 1.

10. A watch-type electronic device comprising the secondary battery according to claim 1 in a belt.

11. A flying object comprising the secondary battery according to claim 1.

12. The secondary battery according to claim 2,
wherein the positive electrode active material comprises a composite oxide having a layered rock-salt crystal structure, a spinel crystal structure, or an olivine crystal structure.

13. The secondary battery according to claim 3,
wherein the positive electrode active material comprises a composite oxide having a layered rock-salt crystal structure, a spinel crystal structure, or an olivine crystal structure.

14. The secondary battery according to claim 4,
wherein the positive electrode active material comprises a composite oxide having a layered rock-salt crystal structure, a spinel crystal structure, or an olivine crystal structure.

15. The secondary battery according to claim 12,
wherein the positive electrode active material having a layered rock-salt crystal structure comprises lithium cobalt oxide or lithium nickel-manganese-cobalt oxide.

16. The secondary battery according to claim 13,
wherein the positive electrode active material having a layered rock-salt crystal structure comprises lithium cobalt oxide or lithium nickel-manganese-cobalt oxide.

17. The secondary battery according to claim 14,
wherein the positive electrode active material having a layered rock-salt crystal structure comprises lithium cobalt oxide or lithium nickel-manganese-cobalt oxide.

18. The secondary battery according to claim 1,
wherein the negative electrode active material comprises silicon, tin, gallium, aluminum, germanium, lead, antimony, bismuth, silver, zinc, cadmium, or indium.

19. The secondary battery according to claim 2,
wherein the negative electrode active material comprises silicon, tin, gallium, aluminum, germanium, lead, antimony, bismuth, silver, zinc, cadmium, or indium.

20. The secondary battery according to claim 3,
wherein the negative electrode active material comprises silicon, tin, gallium, aluminum, germanium, lead, antimony, bismuth, silver, zinc, cadmium, or indium.

21. The secondary battery according to claim 4,
wherein the negative electrode active material comprises silicon, tin, gallium, aluminum, germanium, lead, antimony, bismuth, silver, zinc, cadmium, or indium.
